(19) United States
(12) Patent Application Publication
(10) Pub. No.: US 2026/0181130 A1
(43) Pub. Date: Jun. 25, 2026

(54) Template Matching Region Searching Enhancements

(71) Applicant: Comcast Cable Communications, LLC, Philadelphia, PA (US)

(72) Inventors: Damian Ruiz Coll, Reston, VA (US); Jung Kyung Lee, Reston, VA (US)

(21) Appl. No.: 19/431,363

(22) Filed: Dec. 23, 2025

Related U.S. Application Data
(60) Provisional application No. 63/738,679, filed on Dec. 24, 2024.

(51) Int. Cl. H04N 19/105; H04N 19/176

(52) U.S. Cl. CPC H04N 19/105; H04N 19/176

(57) ABSTRACT

Search areas may be validated for coding a current block of a picture. A sample in a top-left corner and another sample in a bottom-right corner of a search area may be sequentially tested, for example, by using a reference block that overlaps with the respective corner. The search area may be skipped, adopted, or adjusted based on the testing results. Advantages such as reducing overhead incurred for validating search areas may be achieved.

### CROSS-REFERENCE TO RELATED APPLICATIONS

This application claims the benefit of U.S. Provisional Application No. 63/738,679 filed on Dec. 24, 2024. The above referenced application is hereby incorporated by reference in its entirety.

### BACKGROUND

A computing device processes video for storage, transmission, reception, and/or display. Processing a video comprises encoding and decoding, for example, to reduce a data size associated with the video.

### SUMMARY

The following summary presents a simplified summary of certain features. The summary is not an extensive overview and is not intended to identify key or critical elements.

A video may comprise a sequence of frames or pictures displayed consecutively. Blocks of samples within a picture may be encoded and/or decoded. A current block may be coded using a reference block pointed to by a displacement from the current block. The reference block may be selected from an area with samples that are already reconstructed in the same picture as the current block. The area (e.g., search region) may be one of a plurality of areas. Any of the areas may not qualify as an area for the reference block if it contains unreconstructed (or unencoded) samples. A sample in a top-left corner of an area and another sample in a bottom-right corner of the area may be tested, for example, using a reference block that overlaps with the respective corner. A sample in a bottom-right corner of each reference block may be determined to be a reconstructed (or encoded) sample or not. The area may be skipped, for example, if the reference block overlapping its top-left corner does not have a reconstructed bottom-right corner sample. The area may be deemed as qualified, for example, if both reference blocks have a reconstructed bottom-right corner sample. The area may be adjusted, for example, if only the reference block overlapping its top-left corner has a reconstructed bottom-right corner sample. The adjustment may be based on iterative testing of the reference block overlapping the bottom-right corner of the area. In this way, advantages such as reducing overhead incurred for validating search regions may be achieved, for example, because the number of samples to be tested is reduced and earlier skipping is possible.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system.

FIG. 2 shows an example encoder.

FIG. 3 shows an example decoder.

FIG. 4 shows an example quadtree partitioning of a coding tree block (CTB).

FIG. 5 shows an example quadtree corresponding to the example quadtree partitioning of the CTB in FIG. 4.

FIG. 6 shows example binary tree and ternary tree partitions.

FIG. 7A shows an example of combined quadtree and multi-type tree partitioning of a CTB.

FIG. 7B shows an example tree corresponding to the combined quadtree and multi-type tree partitioning of the CTB shown in FIG. 7A.

FIG. 8 shows example partitioning modes.

FIG. 9 shows an example set of reference samples determined for intra prediction of a current block.

FIG. 10A, FIG. 10B, and FIG. 10C show example intra prediction modes.

FIG. 11 shows an example current block and corresponding reference samples.

FIG. 12 shows an example application of an intra prediction mode for prediction of a current block.

FIG. 13A shows an example of inter prediction.

FIG. 13B shows an example motion vector.

FIG. 14 shows an example of bi-prediction.

FIG. 15A shows example spatial candidate neighboring blocks for a current block.

FIG. 15B shows example temporal, co-located blocks for a current block.

FIG. 16 shows an example of intra block copy (IBC).

FIG. 17 shows an example of intra-template matching prediction (IntraTMP).

FIG. 18 shows an example of a current block and a reference region.

FIG. 19A shows an example of a sparse search.

FIG. 19B shows an example block vector.

FIG. 20 shows an example of a top-template type.

FIG. 21 shows an example of a left-template type.

FIG. 22 shows an example of an L-shaped template type.

FIG. 23A and FIG. 23B show examples of adjacent blocks and non-adjacent blocks for determining block vector candidates.

FIG. 24 shows an example method of IntraTMP with merge candidates.

FIG. 25 shows example refinement windows.

FIG. 26A shows an example coding tree unit (CTU) partitioning.

FIG. 26B shows an example CTU partitioning.

FIG. 26C shows an example CTU partitioning.

FIG. 26D shows an example of a current block and neighboring CTUs.

FIG. 27 shows an example of a current block and neighboring CTUs.

FIG. 28 shows an example of a first validation process.

FIG. 29 shows an example of a second validation process.

FIG. 30 shows an example of a current block in a CTU partition and the associated search regions.

FIG. 31 shows an example of a first validation process.

FIG. 32 shows an example of a second validation process.

FIG. 33 shows an example of a current block in a CTU partition and the associated search regions.

FIG. 34 shows an example of testing a search region using the validation process.

FIG. 35 shows an example of a search region dimension adjustment.

FIG. 36A, FIG. 36B, and FIG. 36C show an example method for encoding a bitstream.

FIG. 37A, FIG. 37B, and FIG. 37C show an example method for decoding a bitstream.

FIG. 38 shows an example computer system in which examples of the present disclosure may be implemented.

FIG. 39 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of video encoding and decoding systems, which may be used in the technical field of video data storage and/or transmission/reception. More particularly, the technology disclosed herein may relate to video compression as used in encoding and/or decoding devices and/or systems.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

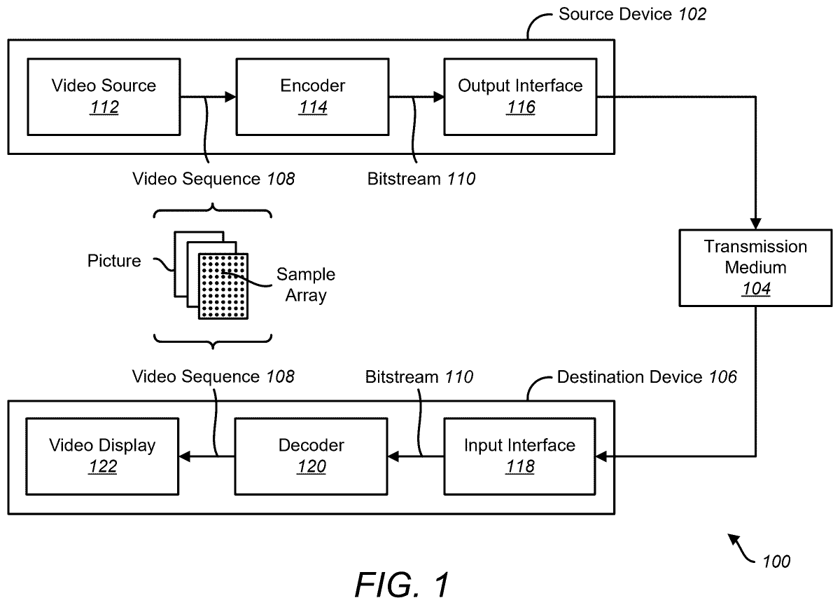

FIG. 1 shows an example video coding/decoding system. Video coding/decoding system 100 may comprise a source device 102, a transmission medium 104, and a destination device 106. The source device 102 may encode a video sequence 108 into a bitstream 110 for more efficient storage and/or transmission. The source device 102 may store and/or send/transmit the bitstream 110 to the destination device 106 via the transmission medium 104. The destination device 106 may decode the bitstream 110 to display the video sequence 108. The destination device 106 may receive the bitstream 110 from the source device 102 via the transmission medium 104. The source device 102 and/or the destination device 106 may be any of a plurality of different devices (e.g., a desktop computer, laptop computer, tablet computer, smart phone, wearable device, television, camera, video gaming console, set-top box, video streaming device, etc.).

The source device 102 may comprise (e.g., for encoding the video sequence 108 into the bitstream 110) one or more of a video source 112, an encoder 114, and/or an output interface 116. The video source 112 may provide and/or generate the video sequence 108 based on a capture of a natural scene and/or a synthetically generated scene. A synthetically generated scene may be a scene comprising computer generated graphics and/or screen content. The video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays used to represent color pictures. For example, three sample arrays may be used for one luma component and two chroma components, respectively. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

The encoder 114 may encode the video sequence 108 into the bitstream 110. The encoder 114 may apply/use (e.g., to encode the video sequence 108) one or more prediction techniques to reduce redundant information in the video sequence 108. Redundant information may comprise information that may be predicted at a decoder and need not be transmitted to the decoder for accurate decoding of the video sequence 108. For example, the encoder 114 may apply spatial prediction (e.g., intra-frame or intra prediction), temporal prediction (e.g., inter-frame prediction or inter prediction), inter-layer prediction, and/or other prediction techniques to reduce redundant information in the video sequence 108. The encoder 114 may partition pictures comprising the video sequence 108 into rectangular regions referred to as blocks, for example, prior to applying one or more prediction techniques. The encoder 114 may then encode a block using the one or more of the prediction techniques.

The encoder 114 may search for a block similar to the block being encoded in another picture (e.g., a reference picture) of the video sequence 108, for example, for temporal prediction. The block determined during the search (e.g., a prediction block) may then be used to predict the block being encoded. The encoder 114 may form a prediction block based on data from reconstructed neighboring samples of the block to be encoded within the same picture of the video sequence 108, for example, for spatial prediction. A reconstructed sample may be a sample that was encoded and then decoded. The encoder 114 may determine a prediction error (e.g., a residual) based on the difference between a block being encoded and a prediction block. The prediction error may represent non-redundant information that may be sent/transmitted to a decoder for accurate decoding of the video sequence 108.

The encoder 114 may apply a transform to the prediction error (e.g. using a discrete cosine transform (DCT), or any other transform) to generate transform coefficients. The encoder 114 may form the bitstream 110 based on the transform coefficients and other information used to determine prediction blocks using/based on prediction types, motion vectors, and/or prediction modes. The encoder 114 may perform one or more of quantization and entropy coding of the transform coefficients and/or the other information used to determine the prediction blocks, for example, prior to or before forming the bitstream 110. The quantization and/or the entropy coding may further reduce the quantity of bits needed to store and/or transmit the video sequence 108.

The output interface 116 may be configured to write and/or store the bitstream 110 onto the transmission medium 104 for transmission to the destination device 106. Also or alternatively, the output interface 116 may be configured to send/transmit, upload, and/or stream the bitstream 110 to the destination device 106 via the transmission medium 104. The output interface 116 may comprise a wired and/or a wireless transmitter configured to send/transmit, upload, and/or stream the bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

The transmission medium 104 may comprise wireless, wired, and/or computer readable medium. For example, the transmission medium 104 may comprise one or more wires, cables, air interfaces, optical discs, flash memory, and/or magnetic memory. Also or alternatively, the transmission medium 104 may comprise one or more networks (e.g., the internet) or file servers configured to store and/or send/transmit encoded video data.

The destination device 106 may decode the bitstream 110 into the video sequence 108 for display. The destination device 106 may comprise one or more of an input interface 118, a decoder 120, and/or a video display 122. The input interface 118 may be configured to read the bitstream 110 stored on the transmission medium 104 by the source device 102. Also or alternatively, the input interface 118 may be configured to receive, download, and/or stream the bitstream 110 from the source device 102 via the transmission medium 104. The input interface 118 may comprise a wired and/or a wireless receiver configured to receive, download, and/or stream the bitstream 110 in accordance with one or more proprietary, open-source, standardized communication protocols, and/or any other communication protocol (e.g., such as referenced herein).

The decoder 120 may decode the video sequence 108 from the encoded bitstream 110. The decoder 120 may generate prediction blocks for pictures of the video sequence 108 in a similar manner as the encoder 114 and determine the prediction errors for the blocks, for example, to decode the video sequence 108. The decoder 120 may generate the prediction blocks using/based on prediction types, prediction modes, and/or motion vectors received in the bitstream 110. The decoder 120 may determine the prediction errors using the transform coefficients received in the bitstream 110. The decoder 120 may determine the prediction errors by weighting transform basis functions using the transform coefficients.

The decoder 120 may combine the prediction blocks and the prediction errors to decode the video sequence 108. The video sequence 108 at the destination device 106 may be, or may not necessarily be, the same video sequence sent, such as the video sequence 108 as sent by the source device 102. The decoder 120 may decode a video sequence that approximates the video sequence 108, for example, because of lossy compression of the video sequence 108 by the encoder 114 and/or errors introduced into the encoded bitstream 110 during transmission to the destination device 106.

The video display 122 may display the video sequence 108 to a user. The video display 122 may comprise a cathode rate tube (CRT) display, a liquid crystal display (LCD), a plasma display, a light emitting diode (LED) display, and/or any other display device suitable for displaying the video sequence 108.

The video encoding/decoding system 100 is merely an example and video encoding/decoding systems different from the video encoding/decoding system 100 and/or modified versions of the video encoding/decoding system 100 may perform the methods and processes as described herein. For example, the video encoding/decoding system 100 may comprise other components and/or arrangements. The video source 112 may be external to the source device 102. The video display device 122 may be external to the destination device 106 or omitted altogether (e.g., if the video sequence 108 is intended for consumption by a machine and/or storage device). The source device 102 may further comprise a video decoder and the destination device 104 may further comprise a video encoder. For example, the source device 102 may be configured to further receive an encoded bit stream from the destination device 106 to support two-way video transmission between the devices.

The encoder 114 and/or the decoder 120 may operate according to one or more proprietary or industry video coding standards. For example, the encoder 114 and/or the decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC)), ITU-T H.265 and MPEG-I Part 3 (also known as Versatile Video Coding (VVC)), the WebM VP8 and VP9 codecs, and/or AOMedia Video 1 (AV1), and/or any other video coding protocol).

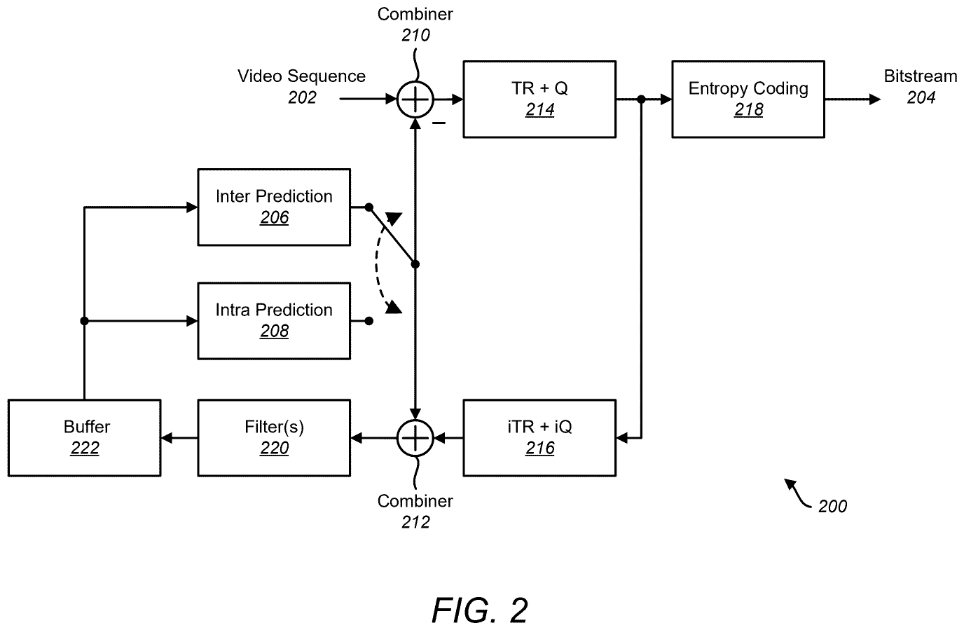

FIG. 2 shows an example encoder. The encoder 200 as shown in FIG. 2 may implement one or more processes described herein. The encoder 200 may encode a video sequence 202 into a bitstream 204 for more efficient storage and/or transmission. The encoder 200 may be implemented in the video coding/decoding system 100 as shown in FIG. 1 (e.g., as the encoder 114) or in any computing, communication, or electronic device (e.g., desktop computer, laptop computer, tablet computer, smart phone, wearable device, television, camera, video gaming console, set-top box, video streaming device, etc.). The encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

The encoder 200 may partition pictures (e.g., frames) of (e.g., comprising) the video sequence 202 into blocks and encode the video sequence 202 on a block-by-block basis. The encoder 200 may perform/apply a prediction technique on a block being encoded using either the inter prediction unit 206 or the intra prediction unit 208. The inter prediction unit 206 may perform inter prediction by searching for a block similar to the block being encoded in another, reconstructed picture (e.g., a reference picture) of the video sequence 202. The reconstructed picture may be or refer to a picture that was encoded and then decoded. The block determined during the search (e.g., a prediction block) may then be used to predict the block being encoded to remove redundant information. The inter prediction unit 206 may exploit temporal redundancy or similarities in scene content from picture to picture in the video sequence 202 to determine the prediction block. For example, scene content between pictures of the video sequence 202 may be similar except for differences due to motion and/or affine transformation of the screen content over time.

The intra prediction unit 208 may perform intra prediction by forming a prediction block based on data from reconstructed neighboring samples of the block to be encoded within the same picture of the video sequence 202. The reconstructed sample may be or refer to a sample that was encoded and then decoded. The intra prediction unit 208 may exploit spatial redundancy or similarities in scene content within a picture of the video sequence 202 to determine the prediction block. For example, the texture of a region of scene content in a picture may be similar to the texture in the immediate surrounding area of the region of the scene content in the same picture.

The combiner 210 may determine a prediction error (e.g., a residual) based on the difference between the block being encoded and the prediction block. The prediction error may represent non-redundant information that may be sent/transmitted to a decoder for accurate decoding of the video sequence 202.

The transform and quantization unit (TR+Q) 214 may transform and quantize the prediction error. The transform and quantization unit 214 may transform the prediction error into transform coefficients by applying, for example, a DCT to reduce correlated information in the prediction error. The transform and quantization unit 214 may quantize the coefficients by mapping data of the transform coefficients to a predefined set of representative values. The transform and quantization unit 214 may quantize the coefficients to reduce irrelevant information in the bitstream 204. The Irrelevant information may be information that may be removed from the coefficients without producing visible and/or perceptible distortion in the video sequence 202 after decoding (e.g., at a receiving device).

The entropy coding unit 218 may apply one or more entropy coding methods to the quantized transform coefficients to further reduce the bit rate. For example, the entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form the bitstream 204.

The inverse transform and quantization unit (iTR+iQ) 216 may inverse quantize and inverse transform the quantized transform coefficients to determine a reconstructed prediction error. The combiner 212 may combine the reconstructed prediction error with the prediction block to form a reconstructed block. The filter(s) 220 may filter the reconstructed block, for example, using a deblocking filter, a sample-adaptive offset (SAO) filter, constrained directional enhancement filters (CDEFs), and/or loop restoration (LR) filters. The buffer 222 may store the reconstructed block for prediction of one or more other blocks in the same and/or different picture of the video sequence 202.

The encoder 200 may further comprise an encoder control unit. The encoder control unit may be configured to control one or more units of the encoder 200 as shown in FIG. 2. The encoder control unit may control the one or more units of the encoder 200 such that the bitstream 204 may be generated in conformance with the requirements of one or more proprietary coding protocols, industry video coding standards, and/or any other video cording protocol. For example, the encoder control unit may control the one or more units of the encoder 200 such that bitstream 204 may be generated in conformance with one or more of ITU-T H.263, AVC, HEVC, VVC, VP8, VP9, AV1, and/or any other video coding standard/format.

The encoder control unit may be configured to attempt to minimize (or reduce) the bitrate of bitstream 204 and/or maximize (or increase) the reconstructed video quality (e.g., within the constraints of a proprietary coding protocol, industry video coding standard, and/or any other video cording protocol). For example, the encoder control unit may be configured to attempt to minimize or reduce the bitrate of bitstream 204 such that the reconstructed video quality does not fall below a certain level/threshold, and/or to maximize or increase the reconstructed video quality such that the bit rate (or bitrate) of bitstream 204 does not exceed a certain level/threshold. The encoder control unit may determine/control one or more of: partitioning of the pictures of the video sequence 202 into blocks, whether a block is inter predicted by the inter prediction unit 206 or intra predicted by the intra prediction unit 208, a motion vector for inter prediction of a block, an intra prediction mode among a plurality of intra prediction modes for intra prediction of a block, filtering performed by the filter(s) 220, and/or one or more transform types and/or quantization parameters applied by the transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to the entropy coding unit 218 to be further compressed (e.g., to reduce the bit rate). For example, the entropy coding unit 218 may use/apply context adaptive variable length coding (CAVLC), context adaptive binary arithmetic coding (CABAC), syntax-based context-based binary arithmetic coding (SBAC), and/or symbol-to-symbol adaptive multi-symbol (non-binary) arithmetic coding to achieve further compression. The prediction type, prediction information, and/or transform and/or quantization parameters may be packed with the prediction error to form the bitstream 204.

The encoder 200 is merely an example and encoders different from the encoder 200 and/or modified versions of the encoder 200 may perform the methods and processes as described herein. For example, the encoder 200 may comprise other components and/or arrangements. One or more of the components shown in FIG. 2 may be optionally included in the encoder 200 (e.g., the entropy coding unit 218 and/or the filters(s) 220).

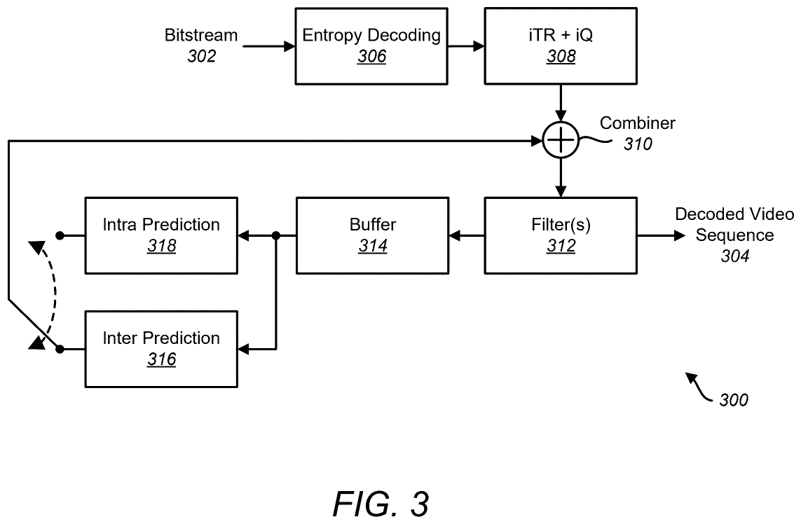

FIG. 3 shows an example decoder. A decoder 300 as shown in FIG. 3 may implement one or more processes described herein. The decoder 300 may decode a bitstream 302 into a decoded video sequence 304 for display and/or some other form of consumption. The decoder 300 may be implemented in the video encoding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). The decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318.

The decoder 300 may comprise a decoder control unit configured to control one or more units of decoder 300. The decoder control unit may control the one or more units of decoder 300 such that the bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by the inter prediction unit 316 or intra predicted by the intra prediction unit 318, a motion vector for inter prediction of a block, an intra prediction mode among a plurality of intra prediction modes for intra prediction of a block, filtering performed by the filter(s) 312, and/or one or more inverse transform types and/or inverse quantization parameters to be applied by the inverse transform and quantization unit 308. One or more of the control parameters used by the decoder control unit may be packed in bitstream 302.

The Entropy decoding unit 306 may entropy decode the bitstream 302. For example, the entropy decoding unit 306 may use/apply CAVLC, CABAC, and SBAC to decompress the prediction type used to encode a block (intra or inter prediction), prediction information of the block (intra prediction mode if intra predicted, motion vector, etc.), and transform and quantization parameters. The inverse transform and quantization unit 308 may inverse quantize and/or inverse transform the quantized transform coefficients to determine a decoded prediction error. The combiner 310 may combine the decoded prediction error with a prediction block to form a decoded block. The prediction block may be generated by the intra prediction unit 318 or the inter prediction unit 316 (e.g., as described above with respect to encoder 200 in FIG. 2). The filter(s) 312 may filter the decoded block, for example, using a deblocking filter, a sample-adaptive offset (SAO) filter, constrained directional enhancement filters (CDEFs), and/or loop restoration (LR) filters. The buffer 314 may store the decoded block for prediction of one or more other blocks in the same and/or different picture of the video sequence in the bitstream 302. The decoded video sequence 304 may be output from the filter(s) 312 as shown in FIG. 3.

The decoder 300 is merely an example and decoders different from the decoder 300 and/or modified versions of the decoder 300 may perform the methods and processes as described herein. For example, the decoder 300 may have other components and/or arrangements. One or more of the components shown in FIG. 3 may be optionally included in the decoder 300 (e.g., the entropy decoding unit 306 and/or the filters(s) 312).

Although not shown in FIGS. 2 and 3, each of the encoder 200 and the decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2n×2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. A CB may be further partitioned into intra sub-partitions (ISP) where the reconstructed samples of each sub-partition may be available to generate the prediction of the next sub-partition. For example, a CB may be split into 2 to 4 sub-partitions. For transformations, a CB may be partitioned into one or more transform blocks (TBs). A TB may be a rectangular block of samples that may determine/indicate an applied transform size.

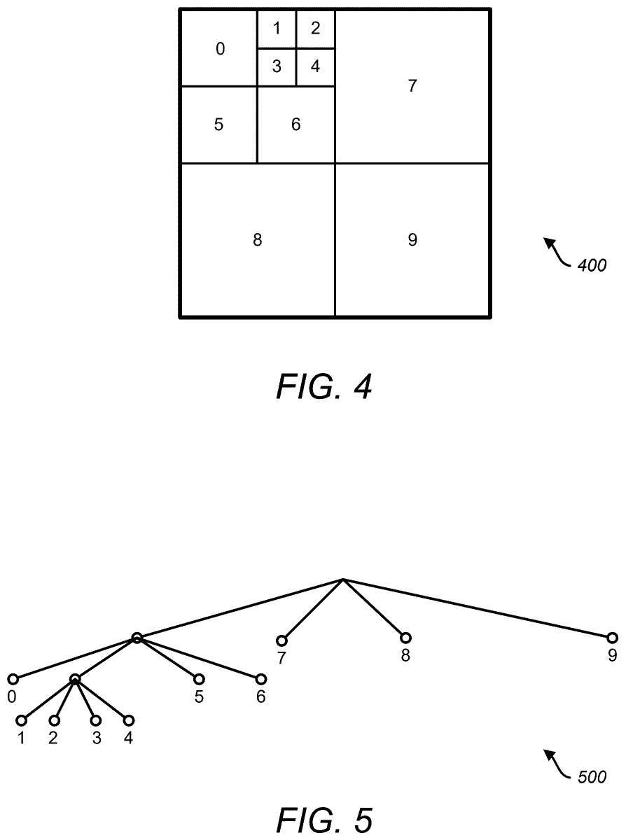

FIG. 4 shows an example quadtree partitioning of a CTB. FIG. 5 shows an example quadtree corresponding to the example quadtree partitioning of the CTB 400 in FIG. 4. As shown in the examples of FIGS. 4 and 5, the CTB 400 may first be partitioned into four CBs of half vertical and half horizontal size. Three of the resulting CBs of the first level partitioning of CTB 400 may be leaf CBs. The three leaf CBs of the first level partitioning of CTB 400 are respectively labeled 7, 8, and 9 in FIGS. 4 and 5. The non-leaf CB of the first level partitioning of CTB 400 may be partitioned into four sub-CBs of half vertical and half horizontal size. Three of the resulting sub-CBs of the second level partitioning of CTB 400 may be leaf CBs. The three leaf CBs of the second level partitioning of CTB 400 are respectively labeled 0, 5, and 6 in FIGS. 4 and 5. The non-leaf CB of the second level partitioning of CTB 400 may be partitioned into four leaf CBs of half vertical and half horizontal size. The four leaf CBs may be respectively labeled 1, 2, 3, and 4 in FIGS. 4 and 5.

The CTB 400 of FIG. 4 may be partitioned into 10 leaf CBs respectively labeled 0-9, and/or any other quantity of leaf CBs. The 10 leaf CBs may correspond to 10 CB leaf nodes (e.g., 10 CB leaf nodes of the quadtree 500 as shown in FIG. 5). In other examples, a CTB may be partitioned into a different number of leaf CBs. The resulting quadtree partitioning of the CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

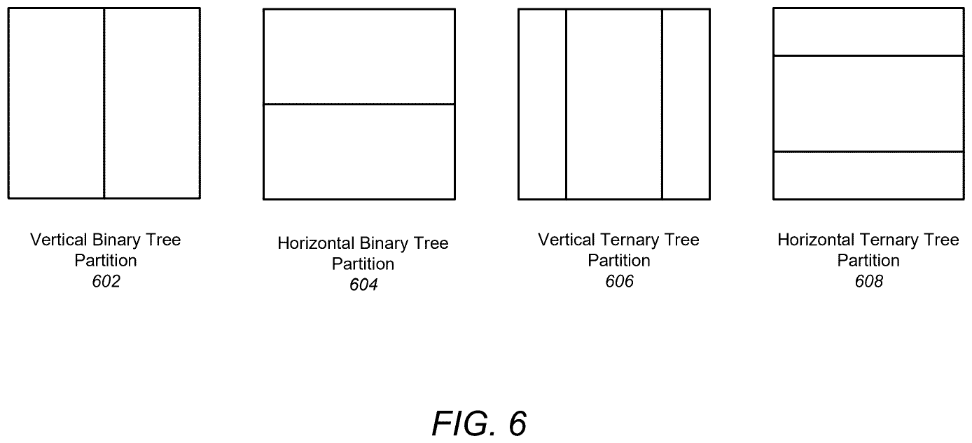

FIG. 6 shows example binary tree and ternary tree partitions. A binary tree partition may divide a parent block in half in either a vertical direction 602 or a horizontal direction 604. The resulting partitions may be half in size as compared to the parent block. The resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

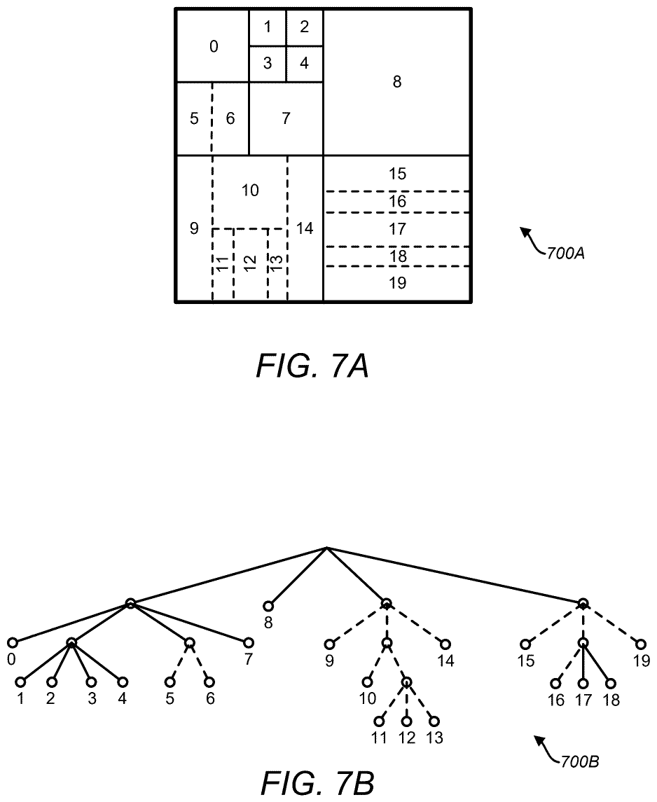

FIG. 7A shows an example of combined quadtree and multi-type tree partitioning of a CTB. FIG. 7B shows an example tree corresponding to the combined quadtree and multi-type tree partitioning of the CTB 700A shown in FIG. 7A. In both FIGS. 7A and 7B, quadtree splits are shown in solid lines and multi-type tree splits are shown in dashed lines. For ease of explanation, the CTB 700A is shown with the same quadtree partitioning as the CTB 400 described in FIG. 4, and a description of the quadtree partitioning of the CTB 700A (similar to that for CTB 400) is omitted. The quadtree partitioning of the CTB 700A is merely an example and a CTB may be quadtree partitioned in a manner different from the CTB 700A. Additional multi-type tree partitions of the CTB 700A may be made relative to three leaf CBs shown in FIG. 4. The three leaf CBs in FIG. 4 that are shown in FIG. 7A as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7A and 7B. The leaf CB 8 of FIG. 4 may be partitioned into three CBs based on a vertical ternary tree partition. Two of the three resulting CBs may be leaf CBs respectively labeled 9 and 14 in FIGS. 7A and 7B. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7A and 7B. The leaf CB 9 of FIG. 4 may be partitioned into three CBs based on a horizontal ternary tree partition. Two of the three CBs may be leaf CBs respectively labeled 15 and 19 in FIGS. 7A and 7B. The remaining, non-leaf CB may be partitioned into three CBs based on another horizontal ternary tree partition. The resulting three CBs may all be leaf CBs respectively labeled 16, 17, and 18 in FIGS. 7A and 7B.

Altogether, the CTB 700A may be partitioned into 20 leaf CBs respectively labeled 0-19. The 20 leaf CBs may correspond to 20 leaf nodes (e.g., 20 leaf nodes of the tree 700B shown in FIG. 7B). The resulting combination of quadtree and multi-type tree partitioning of the CTB 700A may be scanned using a z-scan (left-to-right, top-to-bottom) to form the sequence order for encoding/decoding the CB leaf nodes. A numeric label of each CB leaf node in FIGS. 7A and 7B may correspond to the sequence order for encoding/decoding, with CB leaf node 0 encoded/decoded first and CB leaf node 19 encoded/decoded last. Although not shown in FIGS. 7A and 7B, it should be noted that each CB leaf node may comprise one or more PBs and/or TBs.

A coding standard/format (e.g., HEVC, VVC, or any other coding standard/format) may define various units (e.g., in addition to specifying various blocks (e.g., CTBs, CBs, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bit stream (or bitstream). A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

A picture may be partitioned into multiple coding blocks. A picture may be partitioned into multiple coding blocks, for example, in some implementations of partitioning (e.g., AV1). The largest coding blocks are also referred to as superblocks. Superblocks may have sizes of either 128×128 or 64×64. Superblocks may be partitioned into smaller coding blocks. Partitioning superblocks into smaller coding blocks may be performed in a plurality of (e.g., nine) partitioning modes.

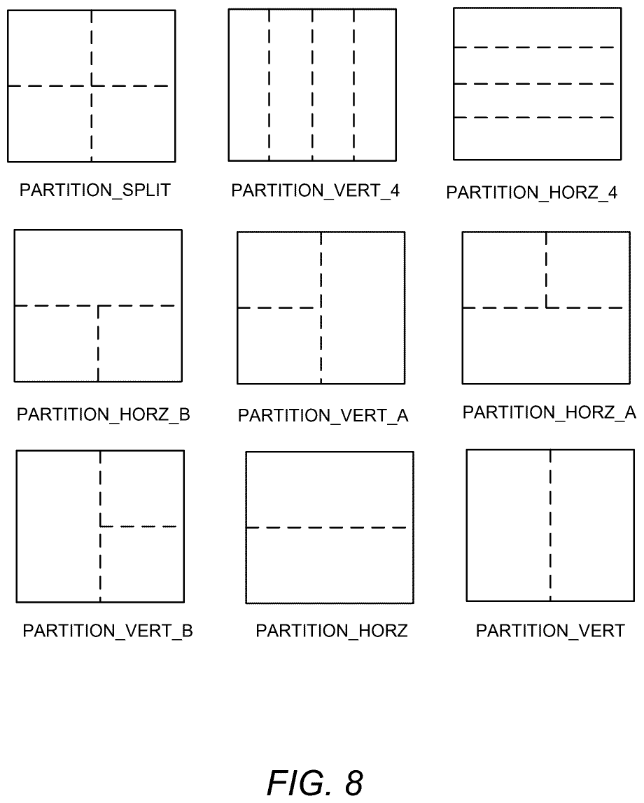

FIG. 8 shows example partitioning modes. More specifically, FIG. 8 shows nine partitioning modes in AV1. Among the nine partitioning modes, only PARTITION_SPLIT may allow recursive partitioning. In addition, PARTITION_VERT_4 and PARTITION_HORZ_4 modes may not be allowed for 8×8 or 128×128 coding blocks. T-shaped partitioning modes (e.g., PARTITION_HORZ_B mode, PARTITION_VERT_A mode, PARTITION_HORZ_A mode, PARTITION_VERT_B mode) may not be allowed for 8×8 coding blocks. The minimum coding block size may be 4×4. Intra and inter coding blocks may be further partitioned into transform blocks. The partitioning depth may be up to two levels.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block (coding block or transform block) in the AV1 coding format.

Samples of a block to be encoded (e.g., a current block) may be predicted from samples in a line of samples immediately adjacent to the current block, for example, in intra prediction. For example, the line of samples may include samples of the column immediately adjacent to the left-most column of the current block and samples of the row immediately adjacent to the top-most row of the current block. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

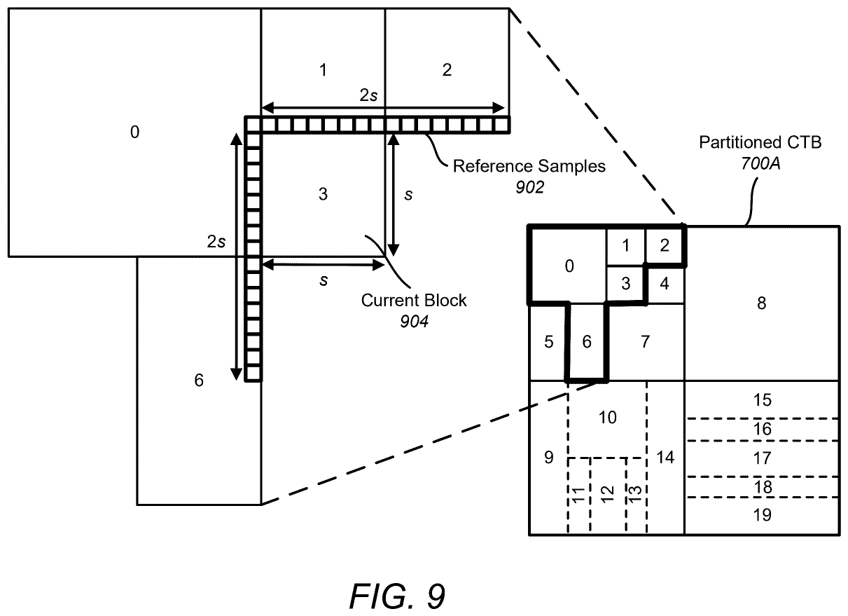

FIG. 9 shows an example set of reference samples determined for intra prediction of a current block. The current block 904 may correspond to a block being encoded and/or decoded. The current block 904 may correspond to block 3 of the partitioned CTB 700A as shown in FIG. 7A. As described herein, the numeric labels 0-19 of the blocks of partitioned CTB 700A may correspond to the sequence order for encoding/decoding the blocks and may be used as such in the example of FIG. 9.

Reference samples 902 may include a line of samples immediately adjacent to current block 904. The reference samples 902 may include samples from a column and a row immediately adjacent to current block 904. For example, the line of samples may include reference samples to the left and/or above the current block 904. Reference samples 902 may be obtained (or selected) from a reference line of multiple reference lines (MRL). The MRL may include a line of samples adjacent to current block 904 and a line of samples not adjacent to the current block 904. The MRL may include reference lines identified by corresponding reference line indices that may indicate an i-th line of samples adjacent to current block 904 such that the 0-th line indicates the reference line immediately adjacent (or closest) to the current block 904 and a higher numbered i-th line indicates a line of samples further away from the current block 904. An encoder may select a reference line from a set of MRL and/or may signal an MRL index in the bitstream to indicate the selected reference line. For example, the encoder may signal a codeword encoding the MRL index.

The decoder may decode the codeword to determine the MRL index that identifies a specific reference line used in intra prediction of the current block 904. The current block 904 may be w×h samples in size. The reference samples 902 may comprise: 2w samples (or any other quantity of samples) of an i-th row (e.g., indicated by an MRL index) adjacent to the top-most row of current block 904, 2 h samples (or any other quantity of samples) of the i-th column adjacent to the left-most column of current block 904, and the top left neighboring corner sample(s) extending from the i-th column and i-th row with respect to current block 904, for example, for the current block 904 that is w×h samples in size. The current block 904 may be square, such that w=h=s. In other examples, a current block need not be square, such that w h. Available samples from neighboring blocks of the current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. Samples from neighboring blocks 0, 1, 2, and 6 may be available to construct the reference samples 902 given that these blocks are encoded and reconstructed at an encoder and decoded at a decoder prior to coding of the current block 904. The samples from neighboring blocks 0, 1, and 2 may be available to construct reference samples 902, for example, if there are no other issues (e.g., as mentioned above) preventing the availability of the samples from the neighboring blocks 0, 1, and 2. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

Unavailable samples from the reference samples 902 may be filled with one or more of the available reference samples 902. For example, an unavailable reference sample may be filled with a nearest available reference sample. The nearest available reference sample may be determined by moving in a clock-wise direction through the reference samples 902 from the position of the unavailable reference. The reference samples 902 may be filled with the mid-value of the dynamic range of the picture being coded, for example, if no reference samples are available.

Samples of the current block 904 may be intra predicted based on reference samples 902, for example, based on (e.g., after) determination and (optionally) filtering of the reference samples 902. A filtering scheme (e.g., a filtering algorithm) may be used/applied for/to the reference samples 902, for example, to improve prediction accuracy. The filtering scheme may be one of a plurality of filter types including at least a smoothing filter (or reference sample smoothing filter) or an interpolation filter. Only one of the plurality of filter types may be selected (e.g., activated) to be used/applied for/to reference samples of a given block, for example, if the reference samples are to be filtered. For example, the interpolation filter may not be selected (e.g., may be disabled), for example, if the smoothing filter is selected (e.g., activated), or vice versa.

A plurality of (e.g., many) encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

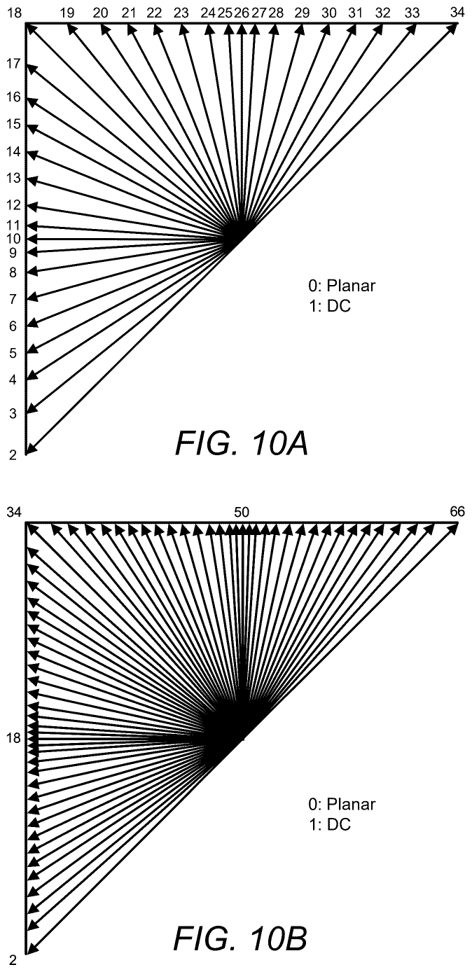

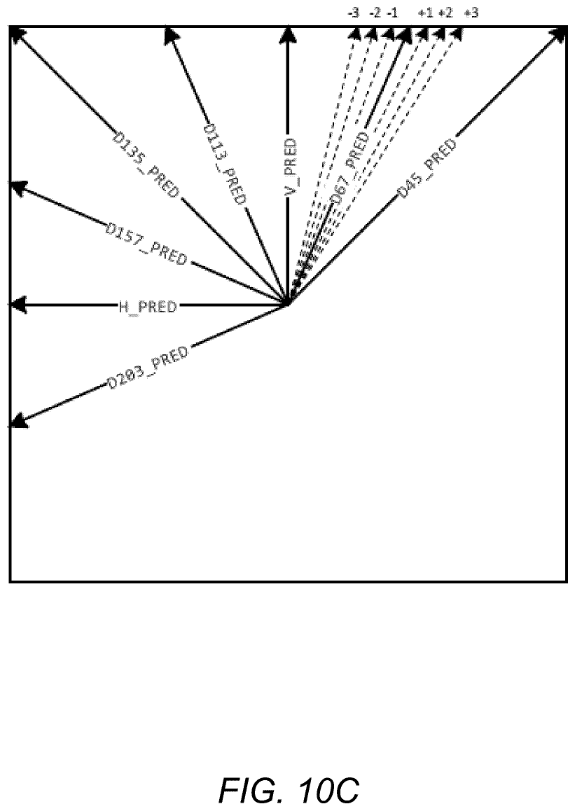

FIGS. 10A, 10B, and 10C show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

The angular modes may be defined. The angular modes may be defined, for example, in some implementations of intra prediction modes (e.g., as supported by AV1). The angular modes may be defined, for example, by specifying a set of nominal modes. A set of angle delta offsets may be defined. A set of angle delta offsets may be defined, for example, around each of the nominal modes. For example, there may be eight nominal angular prediction modes each having a set of angle delta offsets indexed between −3 and +3 with the nominal angle located at 0.

FIG. 10C shows the eight nominal modes (in solid arrows) and the set of angle delta offsets around the D67_PRED nominal angle (in dotted arrows). A prediction angle may be determined (e.g., derived). A prediction angle may be determined (e.g., derived), for example, by adding the offset to the associated nominal angle. There may be 56 angular modes in AV1. For small blocks (e.g., 4×4, 4×8, and 8×4), only nominal angular modes may be applied/used. In addition to the 56 angular modes, there may be five non-angular intra-prediction modes in AV1. The five non-angular intra-prediction modes may include, for example, DC_PRED mode, SMOOTH_V AND SMOOTH_H modes, SMOOTH mode, and Paeth mode. The DC_PRED mode may include averaging samples from reconstructed neighboring blocks. The SMOOTH_V AND SMOOTH_H modes may use quadratic interpolation along the vertical and horizontal directions, respectively. The SMOOTH mode may average the quadratic interpolation results along both directions. The Paeth mode may predict each sample from its top, left and top left reference samples. Recursive intra-prediction modes may (e.g., also) be used. Recursive intra-prediction modes may (e.g., also) be used, for example, if a coding block is divided into sub-blocks. Each intra-predicted sub-block may be used to intra-predict the next sub-block.

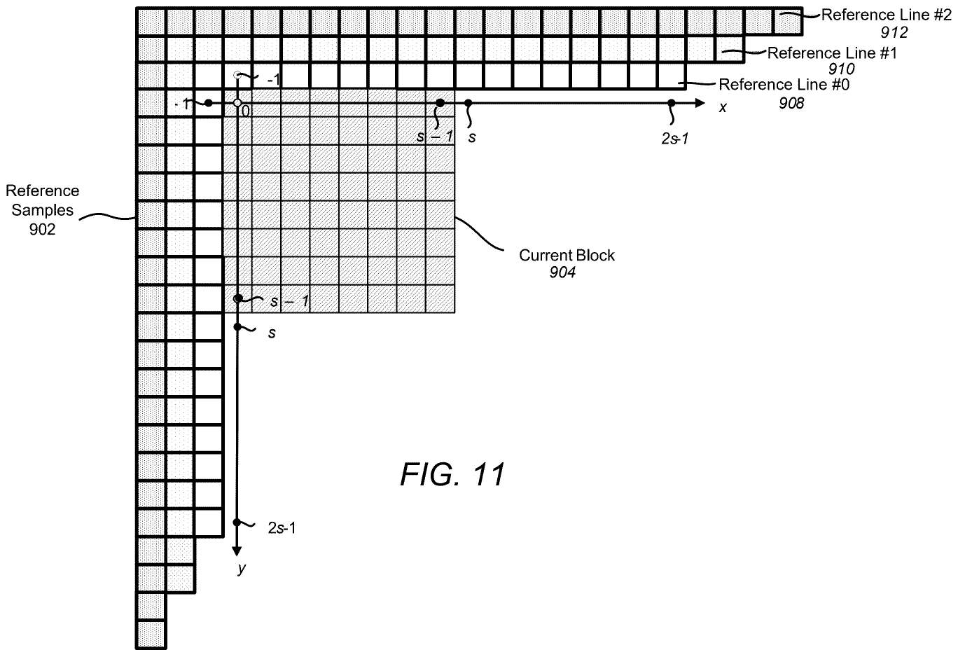

FIG. 11 shows an example current block 904 and corresponding reference samples 902 from FIG. 9. FIG. 11 shows current block 904 and reference samples 902 in a two-dimensional x, y plane, where a sample may be referenced as p[x][y], for example, to further describe how intra prediction modes are used/applied for/to determine a prediction (e.g., a prediction block) of current block 904. The reference samples 902 may be from a reference line among a set of multiple reference lines (MRL) 908-912. To simplify the prediction process, reference samples 902 may be placed in two, one-dimensional arrays. The reference samples 902 belonging to a reference line l from the set of MRL 908-912, above the current block 904, may be placed in the one-dimensional array ref₁[x]:

$$r e {f}_{1} [ x ] = p [ - l + x ] [ - l ] , ( x \geq 0 ) . \qquad ( 1 )$$

The reference samples 902 belonging to reference line 1, to the left of current block 904, may be placed in the one-dimensional array ref₂[y]:

$$r e {f}_{2} ⌈ y ] = p [ - l ] [ - l + y ] , ( y \geq 0 ) . \qquad ( 2 )$$

The variable/represents how many lines away the selected reference line is from current block. For example, if reference line #0 908 is selected, then/is set to 1 to indicate the reference line adjacent to current block 904. For example, if reference line #1 910 is selected, then/is set to 2. For example, if reference line #2 912 is selected, then/is set to 3.

Reference samples 902 may be from reference line 908 that is immediately adjacent to current block 904, for example, if MRL is not activated or selected. In this example, the variable 1 in Equations (1) and (2) is set to 1.

The prediction process may comprise determination of a predicted sample p[x][y](e.g., a predicted value) at a location [x][y] in current block 904. For planar mode, a sample at the location [x][y] in current block 904 may be predicted by determining/calculating the mean of two interpolated values. The first of the two interpolated values may be based on a horizontal linear interpolation at the location [x][y] in the current block 904. The second of the two interpolated values may be based on a vertical linear interpolation at the location [x][y] in the current block 904. The predicted sample p[x][y] in the current block 904 may be determined/calculated as:

$$p [ x ] [ y ] = \frac{1}{2 \cdot s} ( h [ x ] [ y ] + v [ x ] [ y ] + s ) , \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at the location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at the location [x][y] in current block 904. s may be equal to a length of a side (e.g., a number of samples on a side) of the current block 904.

A sample at a location [x][y] in current block 904 may be predicted by the mean of the reference samples 902, for example, for a DC mode. The predicted sample p[x][y] in current block 904 may be determined/calculated as:

$$p [ x ] [ y ] = \frac{1}{2 \cdot s} ( {\sum }_{x = 0}^{s - 1} r e {f}_{1} [ x ] + {\sum }_{y = 0}^{s - 1} r e {f}_{2} [ y ] ) . \qquad ( 6 )$$

A sample at a location [x][y] in current block 904 may be predicted by projecting the location [x][y] in a direction specified by a given angular mode to a point on the horizontal or vertical line of samples comprising reference samples 902, for example, for an angular mode. The sample at the location [x][y] may be predicted by interpolating between the two closest reference samples of the projection point, for example, if the projection does not fall directly on a reference sample. The direction specified by the angular mode may be given by an angle φ defined relative to the y-axis for vertical prediction modes (e.g., modes 19-34 in HEVC and modes 35-66 in VVC). The direction specified by the angular mode may be given by an angle φ defined relative to the x-axis for horizontal prediction modes (e.g., modes 2-18 in HEVC and modes 2-34 in VVC).

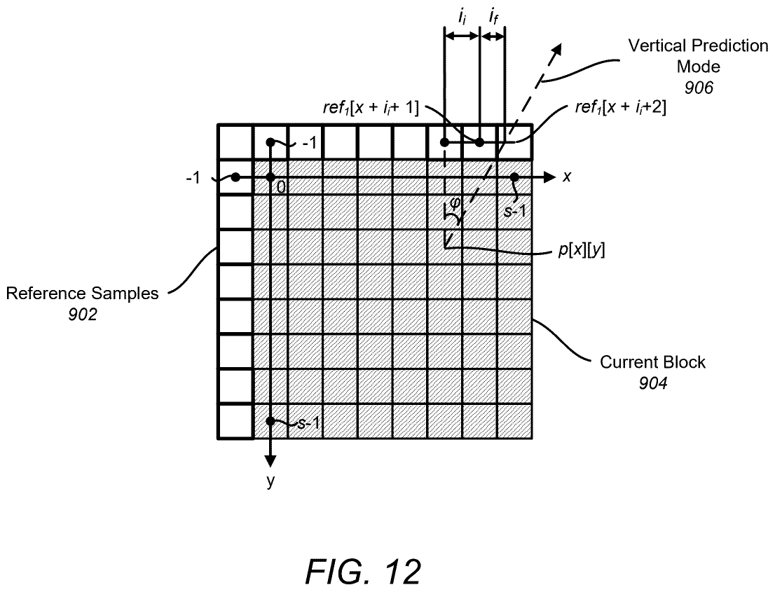

FIG. 12 shows an example application of an intra prediction mode (e.g., an angular mode such as vertical prediction mode 906) for prediction of a current block 904. FIG. 12 specifically shows prediction of a sample at a location [x][y] in current block 904 for a vertical prediction mode 906. Vertical prediction mode 906 may be given by an angle Y with respect to the vertical axis. The location [x][y] in current block 904, in vertical prediction modes, may be projected to a point (e.g., referred to as a projection point) on the horizontal line of reference samples ref₁[x]. The reference samples 902 are only partially shown in FIG. 12 and shown as being from a reference line with reference line index of 0 for ease of illustration. Reference samples 902 may be from another reference line of the set of MRL, as explained in FIG. 9. As shown in FIG. 12, the projection point on the horizontal line of reference samples ref₁[x] may not be exactly on a reference sample. A predicted sample p[x][y] in current block 904 may be determined/calculated by linearly interpolating between the two reference samples, for example, if the projection point falls at a fractional sample position between two reference samples. The predicted sample p[x][y] may be determined/calculated as:

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] . \qquad ( 7 )$$

iᵢ may be the integer part of the horizontal displacement of the projection point relative to the location [x][y]. iᵢ may be determined/calculated as a function of the tangent of the angle φ of the vertical prediction mode 906 as:

$${i}_{i} = ⌊ ( y + 1 ) \cdot tan φ ⌋ . \qquad ( 8 )$$

i_{f} may be the fractional part of the horizontal displacement of the projection point relative to the location [x][y] and may be determined/calculated as:

$${i}_{f} = ( ( y + 1 ) \cdot tan φ ) - ⌊ ( y + 1 ) \cdot tan φ ⌋ , \qquad ( 9 )$$

where └⋅┘ is the integer floor function.

A location [x][y] of a sample in current block 904 may be projected onto the vertical line of reference samples ref₂[y], for example, for horizontal prediction modes. A predicted sample p[x][y] for horizontal prediction modes may be determined/calculated as:

$$p [ x ] [ y ] = ( 1 - {i}_{f} ) \cdot {ref}_{2} [ y + {i}_{i} + 1 ] + {i}_{f} \cdot {ref}_{2} ⌈ y + {i}_{i} + 2 ] . \qquad ( 10 )$$

iᵢ may be the integer part of the vertical displacement of the projection point relative to the location [x][y]. iᵢ may be determined/calculated as a function of the tangent of the angle φ of the horizontal prediction mode as:

$${i}_{i} = ⌊ ( x + 1 ) \cdot tan φ ⌋ . \qquad ( 11 )$$

i_{f} may be the fractional part of the vertical displacement of the projection point relative to the location [x][y]. i_{f} may be determined/calculated as:

$${i}_{f} = ( ( x + 1 ) \cdot tan φ ) - ⌊ ( x + 1 ) \cdot tan φ ⌋ , \qquad ( 12 )$$

where └⋅┘ is the integer floor function.

The interpolation functions given by Equations (7) and (10) may be implemented by an encoder and/or a decoder (e.g., encoder 200 in FIG. 2 and/or decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1−i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters one for each of the 32 possible values of the fractional part of the projected displacement i_{f}. In other examples, different levels of sample accuracy may be used.

The FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on i_{f} (e.g., similar to the two-tap FIR filter). For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. A predicted sample p[x][y], for vertical prediction modes, may be determined based on the four-tap FIR filter as:

$$p [ x ] ⌈ y ] = {\sum }_{i = 0}^{3} f T [ i ] \cdot {ref}_{1} [ x + iIdx + i ] , \qquad ( 13 )$$

where fT[i], i=0 . . . 0.3, may be the filter coefficients, and Idx is integer displacement. A predicted sample p[x][y], for horizontal prediction modes, may be determined based on the four-tap FIR filter as:

$$p [ x ] [ y ] = {\sum }_{i = 0}^{3} f T [ i ] \cdot {ref}_{2} [ y + iIdx + i ] . \qquad ( 14 )$$

Supplementary reference samples may be determined/constructed if the location [x][y] of a sample in current block 904 to be predicted is projected to a negative x coordinate. The location [x][y] of a sample may be projected to a negative x coordinate, for example, if negative vertical prediction angles φ are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in ref₁[x] on the horizontal line of reference samples 902 to the vertical line of reference samples 902 using the negative horizontal prediction angle φ.

An encoder may determine/predict samples of a current block being encoded (e.g., current block 904) for a plurality of intra prediction modes (e.g., using one or more of the functions described herein). For example, an encoder may determine/predict samples of a current block for each of 35 intra prediction modes in HEVC and/or 67 intra prediction modes in VVC and/or including extended intra prediction modes from WAIP for rectangular blocks. The encoder may determine, for each intra prediction mode applied, a corresponding prediction error for the current block based on a difference (e.g., sum of squared differences (SSD), sum of absolute differences (SAD), or sum of absolute transformed differences (SATD)) between the prediction samples, generated from reference samples 902 of a reference line (e.g., from a set of MRL), determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. The encoder may determine/select the intra prediction mode and the associated reference line to encode the current block based on a rate-distortion measure (e.g., Lagrangian rate-distortion cost) determined using the prediction errors. The encoder may signal an indication of the determined/selected intra prediction mode and an indication of the associated MRL index (which may indicate a reference line index). The encoder may signal an indication of the determined/selected intra prediction mode and an indication of the associated MRL index (which may indicate a reference line index), for example, in the bitstream to a decoder for decoding of the current block. The encoder may also signal in the bitstream to the decoder a corresponding prediction error (e.g., residual) of the intra prediction mode.

A decoder may determine/predict samples of a current block being decoded (e.g., current block 904) for an intra prediction mode. For example, a decoder may receive an indication of a reference line (e.g., a reference line index or an MRL index associated with the reference line index) and an intra prediction mode (e.g., an angular intra prediction mode) from an encoder for a current block. The decoder may retrieve a set of reference samples and perform intra prediction, for example, based on the MRL index and the intra prediction mode indicated by the encoder for the current block in a similar manner (e.g., as described above for the encoder). The decoder may obtain the reference samples from a reference line indicated/identified by the decoded MRL index. The reference line may have reference line index 0 and may be immediately adjacent to the current block, for example, if/when MRL is not enabled/activated/selected. In these examples, no indication of MRL index is signaled.

The decoder may add predicted values of the samples (e.g., determined based on the intra prediction mode) of the current block to a residual of the current block to reconstruct the current block. A decoder need not receive an indication of an angular intra prediction mode from an encoder for a current block. A decoder may determine an intra prediction mode, for example, through other decoder-side means (e.g., by applying template-based intra mode derivation (TIMD) tool/technique). While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

An encoder may determine a difference between a current block and a prediction for a current block (e.g., similar to intra prediction). An encoder may determine a difference, for example, based on/after determining/generating a prediction for a current block (e.g., using inter prediction). The difference may be a prediction error (e.g., a residual). The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

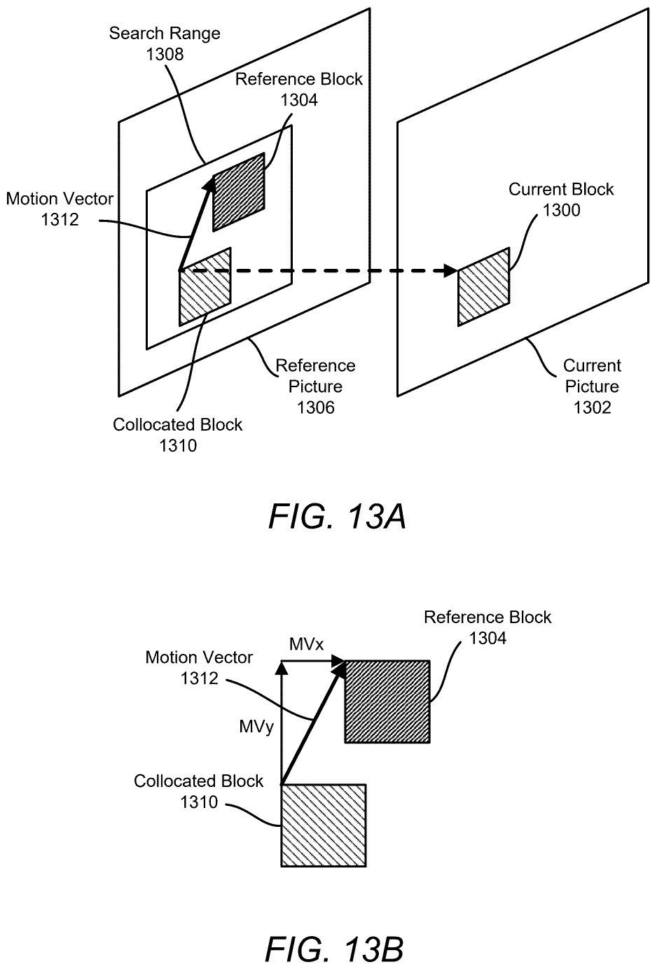

FIG. 13A shows an example of inter prediction. The inter prediction may be performed for a current block 1300 in a current picture 1302 being encoded. An encoder (e.g., encoder 200 as shown in FIG. 2) may perform inter prediction to determine and/or generate a reference block 1304 in a reference picture 1306. Reference block 1304 may be used to predict the current block 1300. Reference pictures (e.g., reference picture 1306) may be prior decoded pictures available at the encoder and/or a decoder. Availability of a prior decoded picture may depend/be based on whether the prior decoded picture is available in a decoded picture buffer, at the time, current block 1300 is being encoded and/or decoded. The encoder may search the one or more reference pictures 1306 for a block (e.g., a candidate reference block) that is similar (or substantially similar) to current block 1300. The encoder may determine the best matching block from the blocks (e.g., candidate reference blocks) tested during the searching process. The best matching block may be a reference block 1304. The encoder may determine that reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of reference block 1304 and original samples of current block 1300.

The encoder may search for reference block 1304 within a reference region (e.g., a search range 1308). The reference region (e.g., a search range 1308) may be positioned around a collocated block (or position) 1310, of current block 1300, in reference picture 1306. Collocated block 1310 may have a same position in the reference picture 1306 as the current block 1300 in the current picture 1302. The reference region (e.g., search range 1308) may at least partially extend outside of reference picture 1306. Constant boundary extension may be used, for example, if the reference region (e.g., search range 1308) extends outside of reference picture 1306. The constant boundary extension may be used such that values of the samples in a row or a column of reference picture 1306, immediately adjacent to a portion of the reference region (e.g., search range 1308) extending outside of reference picture 1306, may be used for sample locations outside of reference picture 1306. A subset of potential positions, or all potential positions, within the reference region (e.g., search range 1308) may be searched for reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of reference block 1304 may be indicated by a reference index pointing into a reference picture list comprising reference picture 1306. The reference frames may include different types of frames. Up to seven frames may be used as reference frames, for example, in some implementations (e.g., such as in AV1). There may be four types of frames, including LAST frame, BWD frame, GOLDEN frame, and ARF frame. The LAST frame may be a frame that was displayed in the near past. The BWD frame may be a frame that will be displayed in the future. The GOLDEN frame may be a frame that was displayed in the distant past. The ARF frame may be a frame from either the past or the future.

FIG. 13B shows an example motion vector. A displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. A motion vector (e.g., motion vector 1312) may have fractional or integer resolution. A motion vector with fractional resolution may point between two samples in a reference picture to provide a better estimation of the motion of current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between reference block 1304 and current block 1300. The encoder may determine the difference between reference block 1304 and current block 1300, for example, based on/after reference block 1304 is determined and/or generated, using inter prediction, for current block 1300. The difference may be a prediction error (e.g., a residual). The encoder may store and/or send (e.g., signal), in/via a bitstream, the prediction error and/or related motion information. The prediction error and/or the related motion information may be used for decoding (e.g., decoding current block 1300) and/or other forms of consumption. The motion information may comprise the motion vector 1312 and a reference indicator/index. The reference indicator may indicate the reference picture 1306 in a reference picture list. The motion information may comprise an indication of motion vector 1312 and/or an indication of the reference indicator/index. The reference indicator may indicate reference picture 1306 in the reference picture list comprising reference picture 1306. A decoder may decode current block 1300 by determining and/or generating the reference block 1304. The reference block 1304 may correspond to/form (e.g., be considered as) a prediction of the current block 1300. The decoder may determine and/or generate the reference block 1304, for example, based on the related motion information. The decoder may decode current block 1300 based on combining the prediction (e.g., a reference block) with the prediction error (e.g., a residual block).

Inter prediction, as shown in FIG. 13A, may be performed using one reference picture 1306 as a source of a prediction for current block 1300. Inter prediction based on a prediction of a current block using a single picture may be referred to as uni-prediction or single reference inter prediction.

Inter prediction of a current block, using bi-prediction or compound prediction, may be based on two pictures (e.g., the source of prediction may be from the two pictures). Bi-prediction may be useful, for example, if a video sequence comprises fast motion, camera panning, zooming, and/or scene changes. Bi-prediction may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction/single reference prediction and/or bi-prediction/compound prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

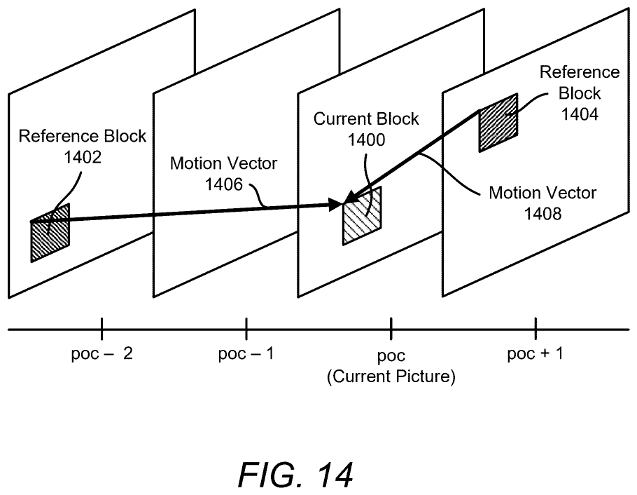

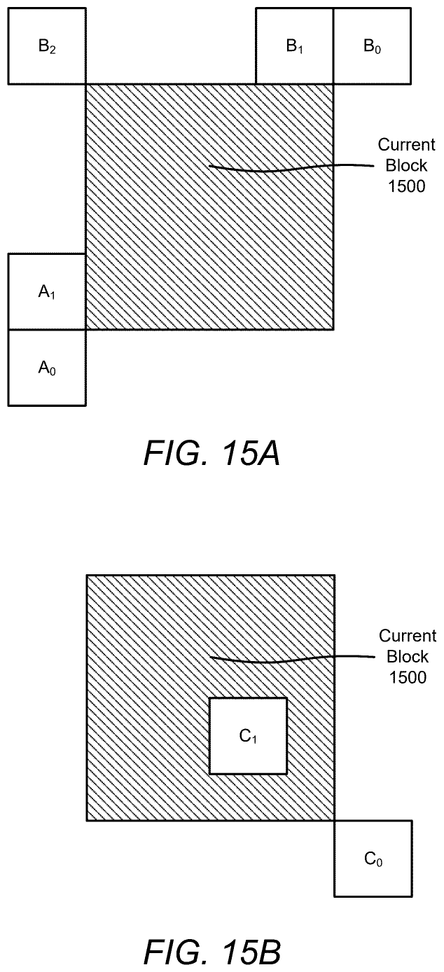

FIG. 14 shows an example of bi-prediction/compound prediction. More specifically, FIG. 14 shows an example of bi-prediction and/or compound prediction performed for a current block. Two reference blocks 1402 and 1404 may be used to predict a current block 1400. Reference block 1402 may be in a reference picture of one of reference picture list 0 or reference picture list 1. Reference block 1404 may be in a reference picture of another one of reference picture list 0 or reference picture list 1. As shown in FIG. 14, reference block 1402 may be in a first picture that precedes (e.g., in time) a current picture of current block 1400, and the reference block 1404 may be in a second picture that succeeds (e.g., in time) the current picture of current block 1400. The first picture may precede the current picture in terms of a picture order count (POC) or a display order. The second picture may succeed the current picture in terms of the POC or the display order. The reference pictures may both precede or both succeed the current picture in terms of POC or the display order. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS) or a set of parameters at a similar level. The encoder may send/signal the weight and/or offset parameters in a slice segment header for current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between current block 1400 and each of reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption.

The motion information for reference block 1402 may comprise a motion vector 1406 and/or a reference indicator/index. The reference indicator may indicate a reference picture, of the reference block 1402, in a reference picture list. The motion information for reference block 1402 may comprise an indication of motion vector 1406 and/or an indication of the reference index. The reference index may indicate the reference picture, of reference block 1402, in the reference picture list.

The motion information for reference block 1404 may comprise a motion vector 1408 and/or a reference index/indicator. The reference indicator may indicate a reference picture, of the reference block 1404, in a reference picture list. The motion information for reference block 1404 may comprise an indication of motion vector 1408 and/or an indication of the reference index. The reference index may indicate the reference picture, of the reference block 1404, in the reference picture list.

A decoder may decode current block 1400 by determining and/or generating the reference blocks 1402 and 1404. The decoder may determine and/or generate the reference blocks 1402 and 1404, for example, based on the respective related motion information for the reference blocks 1402 and 1404. The reference blocks 1402 and 1404 may correspond to/form (e.g., be considered as) the prediction (e.g., used to generate a prediction block) of the current block 1400. The decoder may decode the current block 1400 based on combining the prediction with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques (such as those in HEVC and VVC) may comprise advanced motion vector prediction (AMVP) and/or inter prediction block merging (e.g., merge mode).

An encoder (e.g., encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may reciprocally generate and/or determine the list of candidate MVPs.

The encoder may determine/select an MVP from the list of candidate MVPs. The encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector (e.g., comprising a horizontal component (MVx) and a vertical component (MVy)) that indicates a position relative to a position of the current block being coded, the MVD may be represented by two components MVDₓ and MVD_{y}. MVDₓ and MVD_{y} may be determined/calculated as:

$${MVD}_{x} = M {V}_{x} - {MVP}_{x} , \qquad ( 15 )$$

$${MVD}_{y} = M {V}_{y} - {MVP}_{y} . \qquad ( 16 )$$

MVDx and MVDy may respectively represent horizontal and vertical components of the MVD. MVPx and MVPy may respectively represent horizontal and vertical components of the MVP.

A decoder (e.g., decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block (e.g., a prediction block). The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

FIG. 15A shows example spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to current block 1500 being coded. The two temporal, co-located blocks may be C0 and C1. The two temporal, co-located blocks may be in one or more reference pictures that may be different from the current picture of current block 1500.

An encoder (e.g., encoder 200 as shown in FIG. 2) may code a motion vector using inter prediction block merging (e.g., a merge mode). For example, the encoder (e.g., using merge mode) may reuse the same motion information of a neighboring block (e.g., one of neighboring blocks A0, A1, B0, B1, and B2) for inter prediction of a current block. For example, the encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may reciprocally generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bitstream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. The spatial neighboring blocks and the temporal, co-located blocks used for merge mode may be the same as the spatial neighboring blocks and the temporal, co-located blocks used for AMVP.

A list of derived MV predictors may be generated. A list of derived MV predictors may be generated, for example, in some examples (e.g., AV1). A list of derived MV predictors may be generated, for example, by pooling the spatial and temporal MV candidates and ranking the spatial and temporal MV candidates based on weightings. The weightings may be determined, for example, by evaluating each of the candidates. Up to four candidates may be added to the list of MV predictors. The list of MV predictors may be referred to as the dynamic reference list (DRL). The DRL may be used in dynamic MV prediction modes.

Inter prediction may be performed in other ways and variants than those described herein. For example, motion information prediction techniques other than AMVP and merge mode may be used. While various examples herein correspond to inter prediction modes, such as used in HEVC and VVC or AV1, the methods, devices, and systems as described herein may be applied to/used for other inter prediction modes (e.g., as used for other video coding standards/formats such as VP8, VP9, etc.). History-based motion vector prediction (HMVP), combined intra/inter prediction mode (CIIP) or compound inter-intra prediction, warped motion compensation, overlapped block motion compensation (OBMC), and/or merge mode with motion vector difference (MMVD) (e.g., as described in VVC) may be performed/used and are within the scope of the present disclosure.

A block matching operation (or technique) may be applied/used (e.g., in inter prediction) to determine a reference block in a different picture than that of a current block being coded (e.g., encoded and/or decoded). A block matching operation also may be applied/used to determine a reference block in a same picture as that of a current block being coded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, AV1, and/or any other coding standards/formats/protocols) to exploit correlation between blocks of samples within a same picture (e.g., of screen content videos). The prediction technique may be intra block copy (IBC or IntraBC) or current picture referencing (CPR). An encoder may apply/use a block matching technique (e.g., similar to inter prediction) to determine a displacement vector (e.g., a block vector (BV)). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples (e.g., reconstructed samples) of the current picture. The reference block may comprise decoded blocks of samples of the current picture prior to being processed by in-loop filtering operations (e.g., deblocking, SAO filtering, CDEFs, and/or LR filters). The reference block may be restricted to a certain area. For example, in AV1, if the top-left pixel coordinate of a superblock is (x0, y0), IntraBC prediction is available at pixel position (x, y) only if the value of the vertical coordinate y is less than y0 and the value of the horizontal coordinate x is less x0+2(y0−y). The immediate reconstructed area may not be accessible by IntraBC prediction, for example, due to hardware write-back delays.

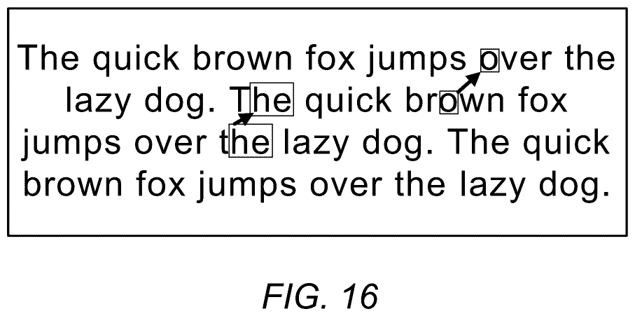

FIG. 16 shows an example of IBC (e.g., an IBC mode or an IntraBC mode). The example shown in FIG. 16 may correspond to screen content. The rectangular portions/sections with arrows beginning at their boundaries may be the current blocks being encoded. The rectangular portions/sections that the arrows point to may be the reference blocks for predicting the respective current blocks.

A reference block may be determined and/or generated, for a current block, using IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction (e.g., a prediction block) of the current block. The decoder may decode the current block by combining the prediction (e.g., a prediction block) with the prediction error (e.g., residual or residual block).

A BV may be predictively coded (e.g., in HEVC, VVC, and/or any other coding standards/formats/protocols) before being stored and/or sent/signaled in/via a bitstream. For example, the BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may reciprocally generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate (e.g., point to) the selected BVP in the list of candidate BVPs. The BVD may be determined/calculated based on a difference between a BV of the current block and the selected BVP. For example, for a BV (e.g., represented by a horizontal component (BVx) and a vertical component (BVy)) that indicates a position relative to a position of the current block being coded, the BVD may be represented by two components BVDx and BVDy. BVDX and BVD, may be determined/calculated as:

$${BVD}_{x} = B {V}_{x} - {BVP}_{x} , \qquad ( 17 )$$

$$BV {D}_{y} = B {V}_{y} - {BVP}_{y} . \qquad ( 18 )$$

BVDx and BVDy may respectively represent horizontal and vertical components of the BVD. BVPx and BVPy may respectively represent horizontal and vertical components of the BVP. A decoder (e.g., decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction (e.g., a prediction block) of the current block. The decoder may decode the current block by combining the prediction (e.g., the prediction block) with the prediction error (e.g., residual or residual block).

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks of a current block being coded using IBC may be respectively denoted A0, A1, B0, B1, and B2 as shown in FIG. 15A.

The most probable mode (MPM) may refer to a best mode for a current block being coded (e.g., encoded and/or decoded). For example, the MPM may refer to the intra prediction mode (IPM) that is (e.g., most likely to be) the best mode for the current block being encoded or decoded. The MPM may be determined by analyzing the intra prediction modes of the neighboring CUs (e.g., blocks) of a current block (or CU) to be coded (e.g., encoded or decoded), for example, in at least some intra prediction techniques. Video coding may use an MPM list for luma intra prediction. For example, an MPM list (e.g., a list of 6 MPMs) may be constructed for intra prediction. The MPM list may be derived from the intra prediction modes of the neighboring CUs, and/or may be updated as the encoder progresses through the video frame. When/If encoding a block, the encoder may determine if the current block is a candidate for any of the MPMs in the MPM list. The encoder may compare prediction errors of respective MPMs to determine which MPM from the MPM list is the best mode for the current block, for example, if the current block is a candidate for any of the MPMs in the MPM list. The encoder may evaluate remaining intra prediction modes (e.g., from a total of 67 intra prediction modes which may include a planar mode, a DC mode, and 65 angular directional modes) to determine the best mode for the current block, for example, if the current block is not a candidate for any of the MPMs in the MPM list.

The use of MPMs may improve (e.g., significantly improve) the coding efficiency. The use of MPMs may improve (e.g., significantly improve) the coding efficiency because the encoder does not need to explicitly signal the intra prediction mode for the current block if such mode is one of the MPMs (e.g., in the MPM list). The encoder does not need to signal the mode number which may require a significant number/quantity of bits. Instead, for example, the encoder may signal an index to the MPM list. The decoder may infer the intra prediction mode for the current block from the corresponding MPM list generated (e.g., identically generated) at the decoder. Advantages such as reduced signaling overhead in the bitstream and increased efficiency may be achieved.

Various types of intra modes may be considered to construct the MPM list. For example, three types of intra modes may be considered to construct the MPM list: default intra modes; neighboring intra modes; and derived intra modes. A unified MPM (e.g., 6-MPM) list may be used for intra blocks, for example, irrespective of whether Multiple Reference Lines (MRL) and Intra Sub-Partitions (ISP) coding tools are applied/used. The MPM list for the current block may be constructed, for example, based on intra modes of neighbor (or neighboring) blocks of the current block. The MPM list for the current block may be constructed, for example, based on intra modes of a left neighbor block (e.g., block corresponding to A1 in FIG. 15A) and an above neighbor block (e.g., block corresponding to B1 in FIG. 15A) of the current block. The intra mode of the left neighbor block may be denoted as Left. The intra mode of the above neighbor block may be denoted as Above.

The unified MPM list may be constructed as follows: when/if a neighboring block is not available, its intra mode may be set to planar mode by default; if both modes Left and Above are non-angular modes, then the MPM list may be set to include{planar, DC, V, H, V−4, V+4}, where “V” and “H” may refer to vertical mode and horizontal mode, respectively; if one of modes Left and Above is an angular mode, and the other is non-angular, set a mode Max as the larger mode of Left and Above, and set the MPM list to include {planar, Max, Max−1, Max+1, Max−2, Max+2}; if Left and Above are both angular and are different, set a mode Max as the larger mode in Left and Above and a mode Min as the smaller mode in Left and Above, and if Max−Min is equal to 1, then set the MPM list to include {planar, Left, Above, Min−1, Max+1, Min−2}, if Max−Min is greater than or equal to 62, then set the MPM list to include {planar, Left, Above, Min+1, Max−1, Min+2}, if Max−Min is equal to 2, set the MPM list to include {planar, Left, Above, Min+1, Min−1, Max+1}, or otherwise, set the MPM list to include {planar, Left, Above, Min−1, −Min+1, Max−1}; and if Left and Above are both angular and are the same, set the MPM list to include {planar, Left, Left−1, Left+1, Left−2, Left+2}.

An encoder may encode an MPM index in a bitstream to indicate the position of a selected intra prediction mode in a MPM list to a decoder. The encoder may represent the MPM index as a codeword and may encode (e.g., entropy encode) the codeword into the bitstream. The decoder may derive the MPM list (e.g., in a manner identical to the encoder), and use the MPM index obtained from the codeword decoded from bitstream to obtain the intra prediction mode from the MPM list derived at the decoder. The first bin of codeword, representing the MPM index, may be context coded using an arithmetic coder (e.g., CABAC) so as to achieve additional coding efficiencies. For example, three contexts may be used, corresponding to whether the current intra block is MRL enabled, ISP enabled, or a normal intra block.

Pruning may be used to remove duplicated intra modes. Pruning may be used to remove duplicated intra modes so that the MPM list includes only unique intra modes, for example, during the 6 MPM list generation process. For entropy coding of the 61 non-MPM modes (that is, the 67 modes in VVC minus the 6 MPM), a truncated binary code (TBC) may be used.

The MPM list may be extended to include additional candidates (e.g., 16 additional candidates), and may be divided into two parts: the primary MPM (PMPM) (e.g., including 6 entries) and the secondary MPM (SMPM) (e.g., including 16 entries). The first entry in a general MPM list may be a planar mode. The remaining entries may include the intra modes of the adjacent neighboring blocks corresponding to positions left (L), above (A), below-left (BL), above-right (AR), and above-left (AL) (e.g., shown in FIG. 15A as A1, B1, A0, B0, and B2), and decoder-side intra mode derivation (DIMD) modes which may be sorted in ascending order of a cost such as, for example, SAD, SSD, SATD, etc. Up to a preconfigured/predetermined number/quantity of modes (e.g., 5) with the smallest costs may be added to the MPM list. The cost for a respective MPM (e.g., an IPM corresponding to an entry in the MPM list) may be determined (e.g., computed) between the prediction of the reconstructed samples of the template of the current block and the reconstructed samples. For example, the prediction may be generated by applying/using the respective MPM for the template. Sorted directional modes may be added into the general MPM list, and then into the default modes, until a general MPM list with a predetermined quantity (e.g., 22) entries is constructed. The order of neighboring blocks may correspond to A, L, BL, AR, AL, for example, if a CU block is vertically oriented. The order of neighboring blocks may correspond to L, A, AL, AR, BL, for example, if a CU block is not vertically oriented.

Referring back to FIG. 16, a reference block (RB) may be determined as a “best matching” reference block to a current block. A reference block (RB) may be determined as a “best matching” reference block to a current block, for example, in IBC mode applied/used for screen content. The arrows may correspond to block vectors (BVs). For example, the arrows may correspond to block vectors (BVs) that may indicate respective displacements from respective current blocks (CBs) to respective reference blocks that best match the respective current blocks. In the examples shown in FIG. 16, the reference blocks may match the respective current blocks and the calculated residuals may be small, if not zero. Video content may (e.g., often) be more efficiently encoded by considering symmetry properties. For example, it has been observed that symmetry is often present in video content, especially in text character regions and computer generated graphics in screen content video.

A Reconstruction-Reordered intra block copy IBC (RRIBC) mode (e.g., also referred to as IBC-Mirror Mode) may be used for screen content video coding. A Reconstruction-Reordered intra block copy IBC (RRIBC) mode (e.g., also referred to as IBC-Mirror Mode) may be used for screen content video coding, for example, to take advantage of symmetry within video content to further improve the coding efficiency of IBC. The RRIBC mode may be signaled. The RRIBC mode may be signaled, for example, based on IBC mode with an indication (or flag) indicating whether flipping is applied/used. The RRIBC mode may be signaled, for example, by signaling an indication (or flag) indicating a direction of flipping, for example, if flipping is applied/used.

A residual for the current block may be calculated (or determined). A residual for the current block may be calculated, for example, when/if the RRIBC mode is indicated for encoding a current block. A residual for the current block may be calculated, for example, based on samples of a reference block being flipped relative to the current block (e.g., according to a flip direction indicated for the current block). The reference block may correspond to an original reference block being encoded and decoded to comprise reconstructed samples. The reference block plus a residual (e.g., residual block) may form a reconstructed block. In an example, at the encoder side, the current block (to be predicted) may be flipped before matching and residual calculation, while the reference block (used to predict the current block) may be derived without flipping. Similarly, at the decoder side, the current block (that was flipped at the encoder) may be determined based on the reference block and residual information, then flipped back to restore the original orientation of the current block before being flipped at the encoder side. In another example, instead of the current block being flipped, the reference block may be flipped instead such that the reference block is flipped to encode the current block (at the encoder) and flipped back (at the decoder) to restore the original orientation of the reference block at the encoder. As described herein, reference to flipping the current block may alternatively refer to flipping the reference block and not the current block such that the reference block and the current block may be flipped in the direction with respect to each other.

The flip direction may include one of a horizontal direction (e.g., along an x-axis) or a vertical direction (e.g., along a y-axis) for RRIBC coded blocks. The flip direction may include one of a horizontal direction (e.g., along an x-axis) or a vertical direction (e.g., along a y-axis) for RRIBC coded blocks, for example, in the RRIBC mode. A first indication (e.g., a first syntax flag) may indicate/signal whether to use flipping (e.g., also referred to as mirror flipping) to encode/decode the current block. A first indication (e.g., a first syntax flag) may indicate/signal whether to use flipping (e.g., also referred to as mirror flipping) to encode/decode the current block, for example, for a current block coded in the RRIBC mode (e.g., an IBC advanced motion vector prediction (AMVP) coded block). A second indication (e.g., a second syntax flag) may indicate/signal the direction for flipping (e.g., vertical or horizontal). A second indication (e.g., a second syntax flag) may indicate/signal the direction for flipping (e.g., vertical or horizontal), for example, for the current block. The flip direction may be inherited from neighboring blocks, without syntax signaling. The flip direction may be inherited from neighboring blocks, without syntax signaling, for example, for IBC merge. In an example, for RRIBC, flipping of a current block (or a reference block in an alternative example) in a horizontal and a vertical direction may be represented in equations (19) and (20), respectively:

$$Reference ( x , y ) = Sample ( w - 1 - x , y ) \qquad ( 19 )$$

$$Reference ( x , y ) = Sample ( x , h - 1 - y ) \qquad ( 20 )$$

where w and h are the width and height of a current block, respectively. Sample(x,y) may indicate a sample value located in (x,y). Reference(x,y) may indicate a corresponding reference sample value after flipping. For horizontal flipping, equation (19) may show that the current block is flipped in the horizontal direction by sampling from right to left. For vertical flipping, equation (20) may show that the current block is flipped in the vertical direction by sampling the current block from down to up.

The current block and the reference block may be aligned. The current block and the reference block may be (e.g., normally) aligned horizontally or vertically, respectively, for example, based on the horizontal or vertical symmetry. The reference block may be determined. The reference block may be determined from a reference region (including candidate reference blocks) aligned in the same flipping direction, for example, based on the RRIBC mode and a flipping direction. The vertical component (BVy) of the BV may not need to be signaled. The vertical component (BVy) of the BV may indicate a displacement from the current block to the reference block. The vertical component (BVy) of the BV may not need to be signaled, for example, when/if flipping in a horizontal direction is applied/indicated. The vertical component (BVy) of the BV may not need to be signaled, for example, because it may be inferred to be equal to 0. The horizontal component (BVx) of the BV may not need to be signaled. The horizontal component (BVx) of the BV may not need to be signaled, for example, when/if flipping in a vertical direction is applied/indicated. The horizontal component (BVx) of the BV may not need to be signaled, for example, because it may be inferred to be equal to 0. As an example, only one component, aligned with the direction for flipping, of the BV may be encoded and signaled for the current block.

A BV for the current block may be constrained to indicate a relative displacement from the current block to a reference block within an IBC reference region. A BV for the current block may be constrained to indicate a relative displacement from the current block to a reference block within an IBC reference region, for example, for a current block coded in IBC mode. A BVP used to predicatively code a BV may be similarly constrained. This is because a BVP may be derived from a BV of a spatially neighboring block of the current block or a prior coded BV as explained herein. A BVD may be determined as a difference between the BV and the BVP. A BVD may be determined as a difference between the BV and the BVP, for example, based on the BVP. This BVD may be encoded and transmitted along with an indication of the selected BVP in a bitstream to enable decoding of the current block, as described herein.

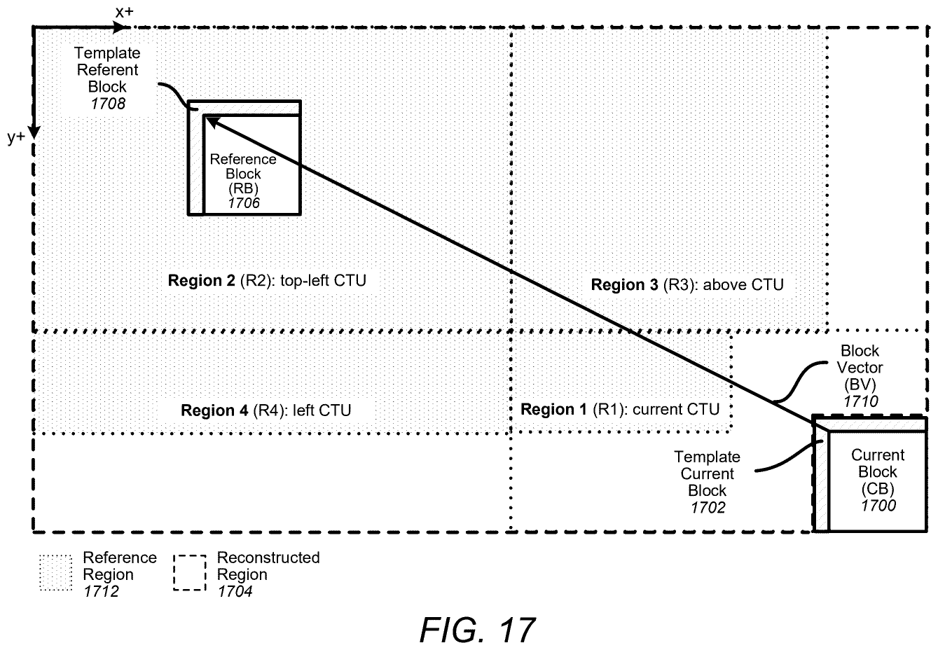

Intra-template matching prediction (IntraTMP) may be a special intra-prediction mode that may select a prediction block within a predetermined reference region (RR) or search area from the reconstructed samples within the current frame. IntraTMP may use a predefined template of the current block to search for a candidate reference block of which the template best matches the template of the current block. FIG. 17 shows an example of intra-template matching prediction (IntraTMP). More specifically, FIG. 17 shows, for an example current block 1700, a reference region 1712 or search area from the reconstructed samples (or reconstructed region) 1704 within which a search is performed for a candidate reference block 1706. The template 1708 (“candidate reference block template”) of the candidate reference block 1706 best matches the template 1702 (“current block template”) of the current block 1700. The reference region may be divided in four rectangular reference regions (e.g., R1, R2, R3, and R4).

A number/quantity of (e.g., N) candidates with lower template costs may be stored in an intraTMP list and ranked by lower cost value (e.g., ascending cost). A number/quantity of (e.g., N) candidates with lower template costs may be stored in an intraTMP list and ranked by lower cost value (e.g., ascending cost), for example, based on determining (e.g., computing) a cost function (e.g., SAD, SATD) between the template 1702 of the current block and the templates of several candidate reference blocks. Each of the candidates with lower template costs may be indicated by a corresponding block vector predictor (BVP) candidate 1710 (BVP candidate may also be referred to herein as block vector (BV) candidate). This process may be performed by both encoder and decoder.

The residual blocks obtained as the difference between the samples of the current block 1700 and the candidate reference blocks 1706 in the list may be determined (e.g., computed), and the reference block with the better rate-distortion performance may be selected as the best intraTMP reference block. An index indicating the position of the best BVP or BV candidate within the intraTMP list may be signaled to the decoder, for example, to facilitate the block decoding using the IntraTMP prediction mode.

Template matching in the reference region 1712 may be performed in a plurality of sub-regions. Template matching in the reference region 1712 may be performed in a plurality of sub-regions (e.g., a set of rectangular sub-regions, e.g., R1 to R4 in the example of FIG. 17), for example, due to the reference region having an irregular (e.g., non-rectangular) shape and to facilitate hardware implementation. The dimensions of the sub-regions may be determined, for example, based on the current block's size and relative position inside the current CTU.

The dimensions of the reference region 1712 comprising all sub-regions (e.g., global reference region) may be determined by the parameters such as SearchRange_w and SearchRange_h. These parameters may be set proportional to the dimensions of the current block 1700 (e.g., CbWidth, CbHeight), for example, by using a multifactor parameter denoted as ‘a’. The multifactor parameter ‘a’ may control the gain/complexity trade-off. The multifactor parameter ‘a’ may be uniform and equal to 5, or may be determined by the current block dimensions based on the following equations:

$$SearchRange\_w = a * CbWidth$$

$$SearchRange\_h = a * CbHeight$$

The global reference region for block dimensions 4 and 8 may be extended to 64 pixels, based on the following equations:

$$SearchRange\_w = max ( 64 , 5 * CbWidth )$$

$$SearchRange\_h = max ( 64 , 5 * CbHeight )$$

This may have the effect of using a variable multifactor parameter ‘a’ based on the block dimensions, as shown in the following table:

| Block size | 64 | 32 | 16 | 8 | 4 |
|---|---|---|---|---|---|
| Multifactor‘a’ | 5 | 5 | 5 | 8 | 16 |
| SearchRange_w | 320 | 160 | 80 | 64 | 64 |
| SearchRange_h | 320 | 160 | 80 | 64 | 64 |

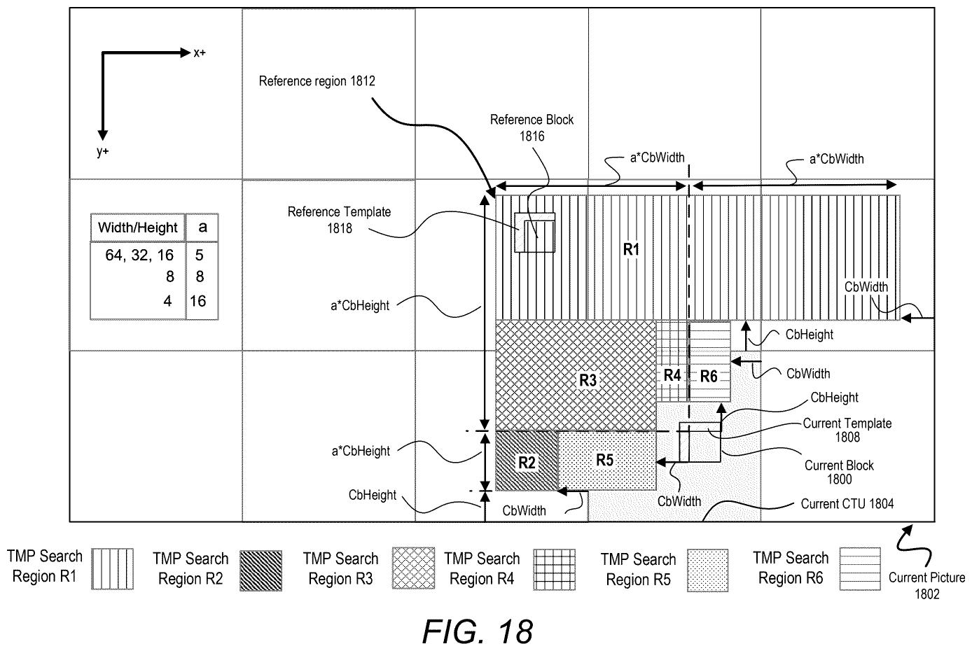

FIG. 18 shows an example of a current block and a reference region. More specifically, FIG. 18 shows a current block 1800 in a current CTU 1804 of a current picture 1802, and a reference region 1812 with examples of identified corresponding TMP search regions R1-R6. Additionally, examples of a reference block 1816, a reference block template 1818, and a current block template 1808 may be shown.

A search process may be performed in two steps: a sparse search step, and a refinement search step. A search process may be performed in two steps: a sparse search step, and a refinement search step, for example, to reduce the high computational burden of an exhaustive template matching search in the whole reference region.

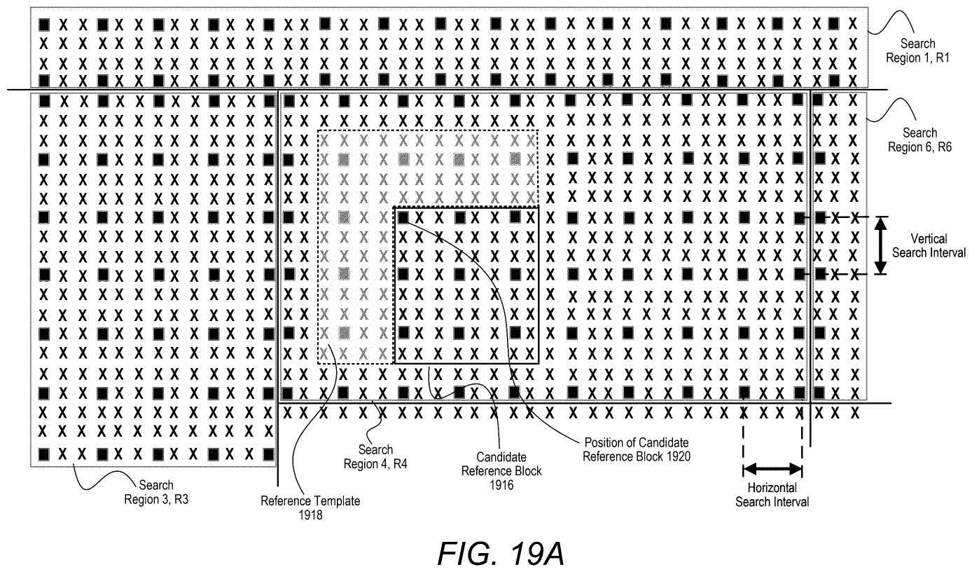

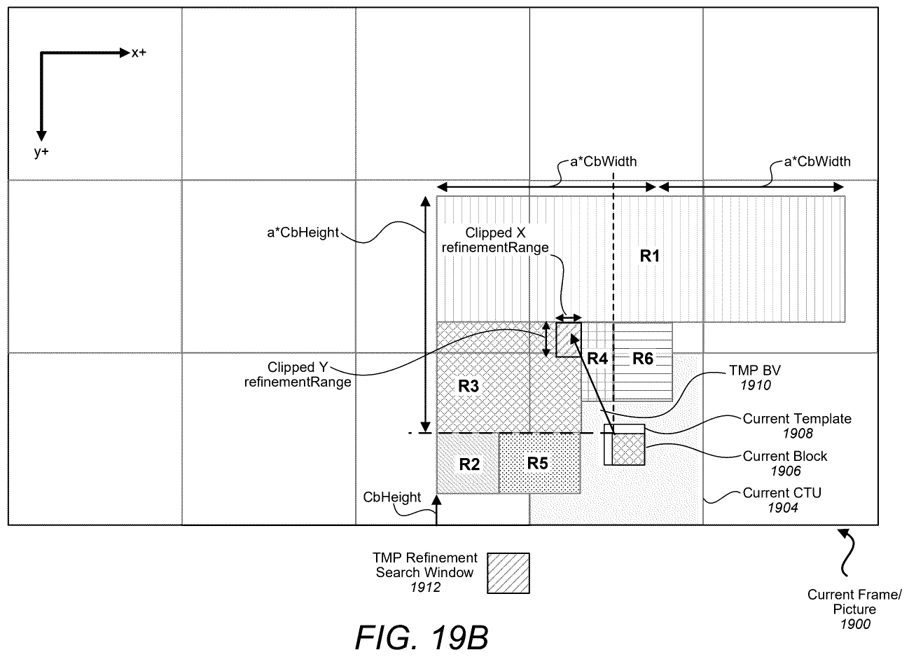

FIG. 19A shows an example of a sparse search (e.g., of IntraTMP). The sparse search may be performed in a regular grid using a subsampling interval (e.g., of 3) in the horizontal and vertical directions. In the example, the subsampling interval may be 3. In some other examples, the subsampling interval may be greater than 3 (e.g., 4). FIG. 19A shows an example candidate reference block 1916 in a search region 4 (R4) and a corresponding reference template 1918. The template cost may be determined (e.g., computed) for each reference block position (or position of candidate reference block) within a search region (e.g., reference block position 1920 of reference block 1916). BVP candidates associated with the best (e.g., least cost) reference blocks may be recorded in a list (e.g., Sparse List) and sorted in an (e.g., ascending) order of cost. Subsample positions may be shown in the form of dark squares in/within the reference region. Subsample positions may be separately determined for each search region. The size of the list (e.g., Sparse List) may be set/determined, for example, to 30.

The refinement search (which is the second step of the search) may be a refinement of the reference block candidates (e.g., BVP candidates) in the list (e.g., Sparse List). Refinement may be made in a refinement window (or refinement search window, search window, refine window) around the reference block candidates from the sparse search, using a sampling interval. For example, refinement may be made in a window of 3×3 pixels around the sparse BVP candidates using a sampling interval of 1. If the refinement window (or refine window) crosses into another search region, the refinement window may be clipped to the region boundary to which the candidate(s) may belong. FIG. 19B shows an example block vector. More specifically, FIG. 19B shows a block vector according to IntraTMP where the block vector's refinement window is clipped at the boundary of a search region. FIG. 19B shows a current block 1906 and a current template 1908 located in a current CTU 1904 of a current frame 1900 (or current picture), a corresponding reference region with respective search regions R1-R6, and an example BVP 1910. A refinement search window 1912 of the example BVP 1910 may be clipped where R4 (a search region in which the BVP 1910 is located) borders R1 and R3. Refined candidates (e.g., 19 refined candidates) with the lowest template cost (e.g., SAD cost) may be selected, for example, for a Refined IntraTMP list.

The encoder/decoder may select among different intraTMP sub-modes by checking the rate-distortion performance of each sub-mode. The encoder/decoder may select among different intraTMP sub-modes by checking the rate-distortion performance of each sub-mode, for example, based on that the encoder/decoder has constructed the Refined IntraTMP List. An IntraTMP sub-mode may be signaled to the decoder in combination with an index to the best candidate in the Refined IntraTMP List or a cluster of candidates (e.g. the Fusion mode). The IntraTMP sub-mode may be a single predictor sub-mode, a fusion sub-mode, a sub-pel precision sub-mode, and/or a linear filter model sub-mode. In the single predictor sub-mode, a single BVP candidate may be selected from the Refined IntraTMP List and signaled to the decoder. In the fusion sub-mode, multiple BVP candidates may be blended to derive the final BV prediction block. The blending weights may be determined (e.g., computed) either from the template matching cost of each predictor or with a Wiener-filter-based weight derivation method. In the sub-pel precision sub-mode, when a single predictor is used, sub-pel precision may be used with ½-pel precision, ¼-pel precision, and ¾-pel precision, each with 8 possible directions. In the linear filter model sub-mode, a linear filter may be learned between the reference and current templates and applied to (e.g., used for) the reference block. This mode may be used for a single predictor, for example, if/when sub-pel precision is not used and a single predictor may be used.

Several types of template shapes may be used. Several types of template shapes may be used, for example, for at least some examples of IntraTMP. Five types of templates have been proposed according to the current block location in the frame: a top template type, a left template type, an L-shaped template type, an only-top template type, and an only-left template type.

The top template type may be used, for example, if/when only the top samples of a current block are available (e.g., if/when the current block is located at/on the left boundary of a picture). TMP cost may be determined (e.g., computed) using the top samples of both the current block and a reference block. A top template may be, for example, four samples in height.

The left template type may be used, for example, if/when only the left samples of a current block are available (e.g., if/when the current block is located at/on the top boundary of a picture). TMP cost may be determined (e.g., computed) using the left samples of both the current block and a reference block. A left template may be, for example, four samples in width.

The L-shaped template type may be used in the other cases (e.g., a current block is not located at the top or left boundary of a picture) where samples surrounding the current block included in an L-Shape are available. TMP cost may be determined (e.g., computed) using an L-shaped template of both the current block and a reference block. The L-shaped template may be, for example, four samples in width and height.

The L-shaped template may introduce two more template types: the Only-Top (Only-T) and Only-Left (Only-L) templates. In addition to the TMP cost of the L-shaped template, the TMP cost for the Only-T and Only-L templates may be determined (e.g., computed), and the best BV candidates (e.g., N candidates, N referring to number or quantity) may be stored in different Only-T and Only-L lists.

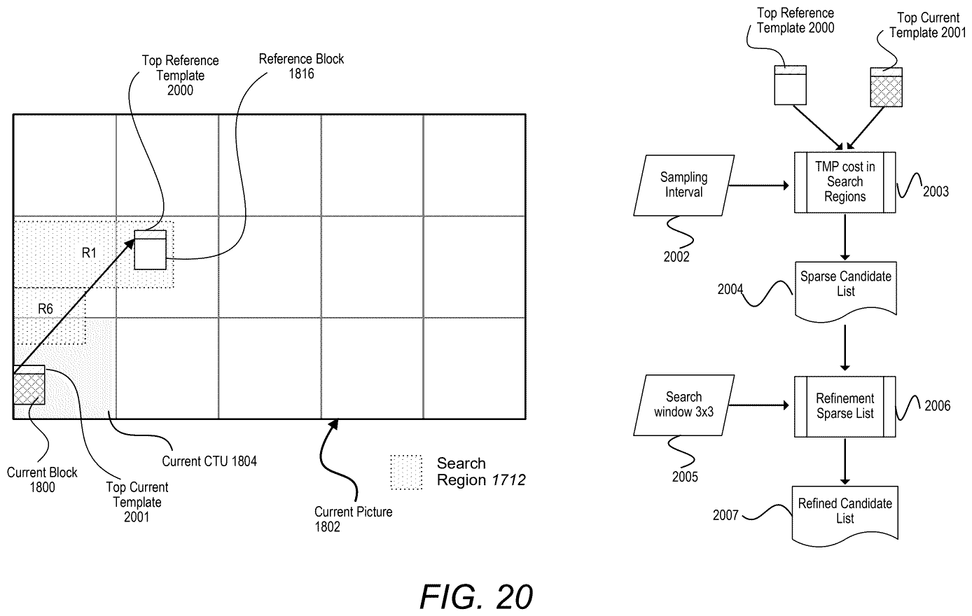

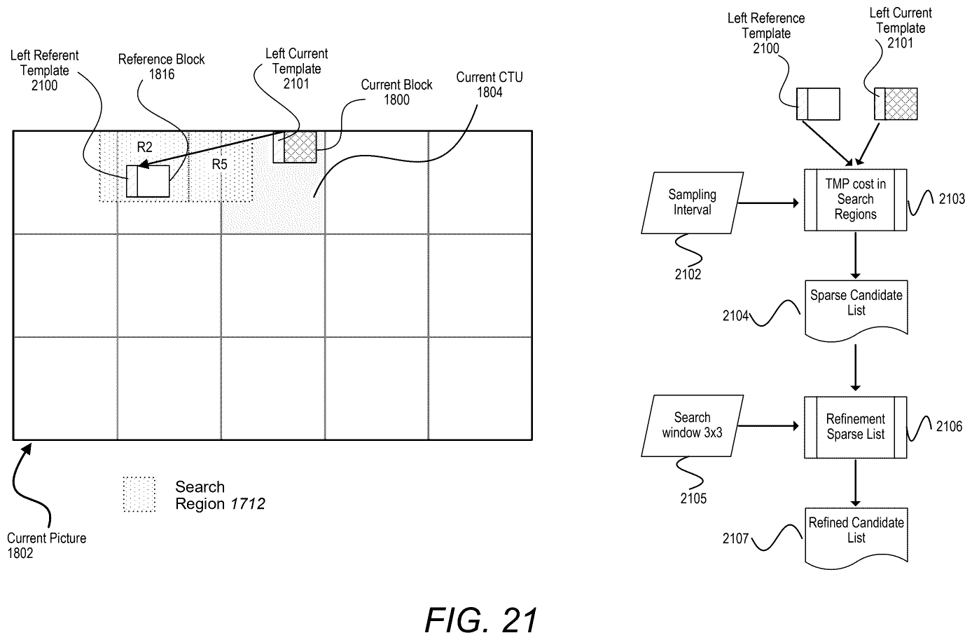

FIG. 20 shows an example of the top template type (e.g., as used in IntraTMP). Only the top templates (e.g., a template 2001 of a current block 1800 and a template 2000 of a reference block 1816) may be used for the TMP cost determination (e.g., computation) in a sparse search 2003. The sparse search 2003 may be determined (e.g., computed) using a sampling interval (SI) 2002 (e.g., of three), and a sparse candidate list (e.g., Sparse List) 2004 may be generated (e.g., built) using the best (lowest cost) BV candidates (e.g., 30 BV candidates). Those candidates may be refined in a refinement search 2006 using a window (e.g., 3×3 window) 2005 with an SI (e.g., of 1), and a refined candidate list 2007 may be generated (e.g., built).

FIG. 21 shows an example of the left template type (e.g., as used in IntraTMP). The same top template type logic may be applied/used for the left template type. A left template 2100 of a reference block 1816 and a left template 2101 of a current block 1800 may be used, for example, instead of top templates (e.g., as shown in FIG. 20). The TMP cost determination (e.g., calculation) in a sparse search 2103, a sampling interval 2102 for the sparse search, sparse candidate list 2104, a refinement search 2106 (e.g., refinement of the sparse list), a refinement search window 2105, and a refined candidate list 2107 of the left template process shown in FIG. 21 may be identical (except for the use of a left template instead of a top template) to those described with respect to FIG. 20 (e.g., 2003, 2002, 2004, 2006, 2005, and 2007 in FIG. 20).

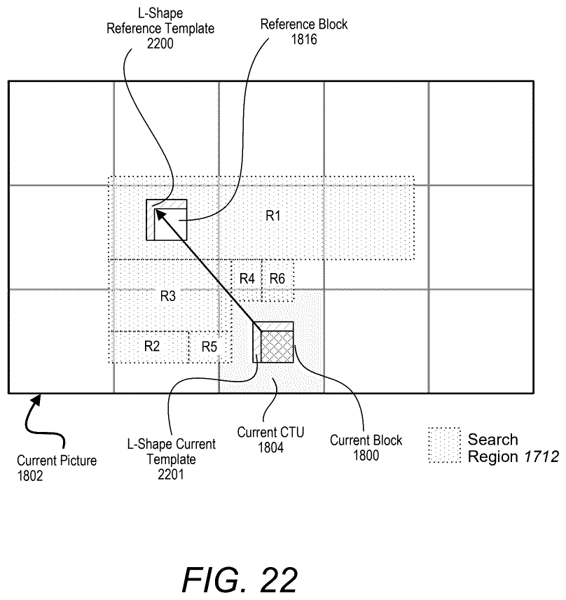

FIG. 22 shows an example of the L-shaped template type (e.g., as used in IntraTMP). A current block 1800 may have an L-shaped template 2201. For example, reconstructed samples may be available for the L-shaped template 2201. An L-shaped template 2200 of a reference block 1816 may be used to determine (e.g., compute) the L-shape TMP cost in all search regions, as described herein for the top template type and the left template type.

In addition to the L-shape TMP cost, the Only-Top TMP cost and Only-Left TMP cost may be determined (e.g., computed). A sparse search may generate (e.g., build) three sparse candidate lists (e.g., Sparse Lists). The three sparse candidate lists may comprise one Sparse L-Shape List (e.g., with a size of 30 BV candidates), and two additional lists: a Sparse Only-T List and a Sparse Only-L List (e.g., both with a length of 6 BV candidates).

These three sparse candidate lists may be refined by determining (e.g., computing) the cost of respective template type using a refinement search window (e.g., of 3×3). The best BV candidates (e.g., N candidates) may be candidates that have obtained the lower (e.g., lowest) TMP costs. The best BV candidates may be stored in three refined lists: a Refined L-Shape List (e.g., with a size of 19 BV candidates), a Refined Only-T List (e.g., with a length of 3 BV candidates), and a Refined Only-L List (e.g., with a length of 3 BV candidates). The final IntraTMP list may have 19 candidates as the L-Shape List. The final IntraTMP list may be a combination of the BV candidates in the Refined L-Shape List, the Refined Only-T List, and the Refined Only-L List.

IntraTMP is generally described in: F. Wang et al, “EE2-1.20i/j: Combination of IntraTMP tests”, JVET-AD0086, April 2023; L. Zhang et al, “EE2-1.11: Intra template matching prediction fusion”, JVET-AD0072, April 2023; J.-Y. Huo et al, “EE2-1.16: A Fusion method of Intra Template Matching Prediction (Intra TMP)”, JVET-AD0116, April 2023; and P. Lin et al, “EE2-1.19: IntraTMP with multiple modes”, JVET-AD0194, April 2023, etc. The content of the listed references are herein incorporated by reference.

In addition to the sparse BVP candidates obtained by TMP searching within the reference region in IntraTMP, a set of Merge BVP candidates may be proposed in another technique “IntraTMP with Merge Candidates”. Merge BVP candidates may be a subset of IBC merge candidates, comprising only the spatial candidates of the current block.

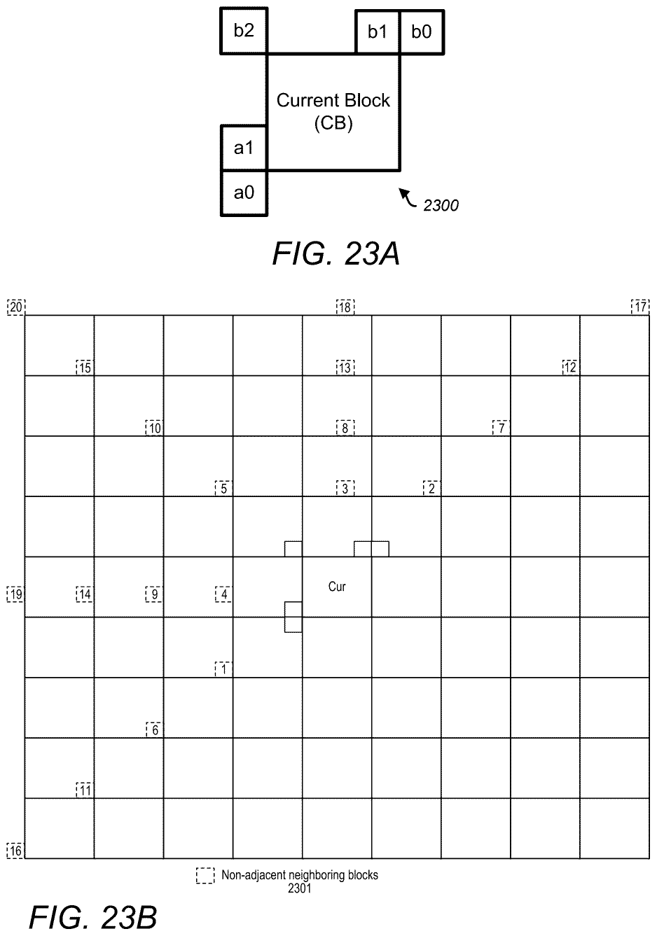

FIG. 23A and FIG. 23B show examples of adjacent blocks and non-adjacent blocks for determining block vector candidates (e.g., according to IntraTMP with Merge Candidates). The TMP Merge BVP candidates may use adjacent BV candidates from the adjacent blocks and non-adjacent BV candidates from the non-adjacent neighboring blocks encoded using an IBC or TMP mode. For example, the TMP Merge BVP candidates may use the 5 adjacent BV from the adjacent blocks (e.g., 2300 in FIG. 23A) and the 20 non-adjacent BV candidates (e.g., 2301 in FIG. 23B) from the non-adjacent neighboring blocks encoded using an IBC or TMP mode.

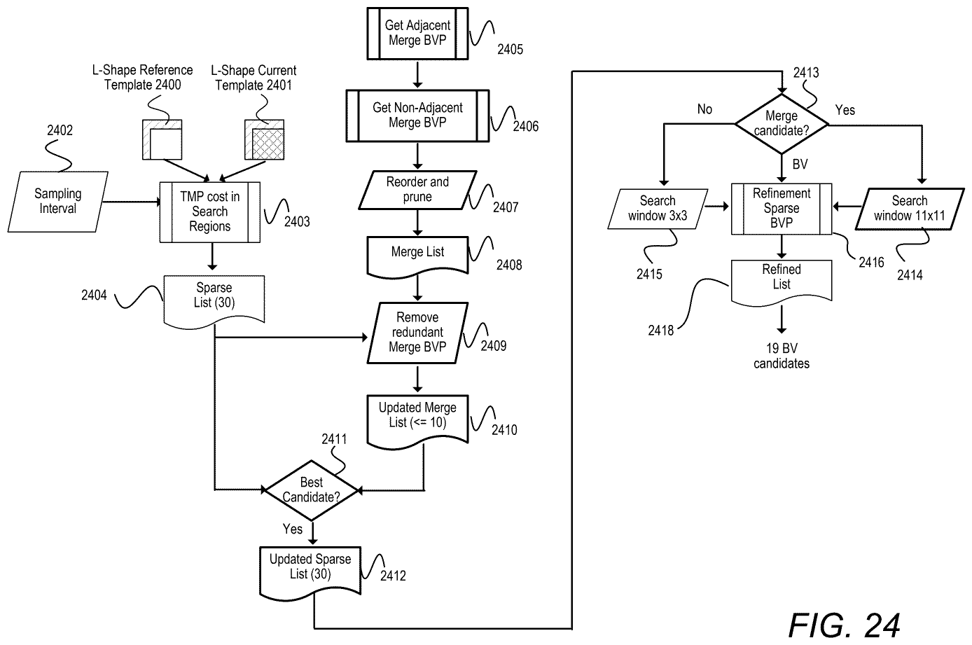

FIG. 24 shows an example method of IntraTMP with merge candidates. Adjacent Merge BVP candidates (e.g., a maximum of 50 BVP candidates) 2405 from adjacent blocks may be obtained. Non-adjacent Merge BVP candidates 2406 from non-adjacent blocks may be obtained. At step 2407, the BVP candidates 2405 and 2406 may be reordered (e.g., ranked in an ascending order of TMP cost). The best candidates (e.g., candidates with lower TMP costs, e.g., 10 best candidates) may be selected and may form a merge list (e.g., TMP Merge List) 2408. The best candidates in the merge list may be ordered in an ascending order of TMP cost. A sparse candidate list or sparse list (e.g., Sparse List) 2404 may be generated at/after step 2403 for the current block, as described herein in relation to IntraTMP. The sparse list 2404 may be generated, for example, by determining (e.g., calculating) TMP costs for reference templates (e.g., L-shaped reference templates) 2400 and the current block's template (e.g., L-shaped current template) 2401 in search regions using a predetermined sampling interval 2402. At step 2409, BVP candidates in the merge list (e.g., up to 10 Merge BVP candidates) may be checked in the sparse list 2404 for duplicates, and the redundant BVPs in the merge list (e.g., TMP Merge List) may be removed to generate an updated merge list 2410. At step 2411, the BVP candidates (e.g., Merge BVPs) from the updated merge list (e.g., updated TMP Merge List) 2410 may compete (e.g., be compared) with the BVP candidates in the sparse list 2404. The best candidates (e.g., 30 candidates) from the sparse list 2404 and the updated merge list 2410, determined based on the TMP cost, may be selected for a final or updated sparse list (e.g., updated Sparse List) 2412.

The updated sparse list 2412 may comprise a set of BVs that may be sparse candidates from 2404 or merge candidates from 2410. At step 2413, these candidates (e.g., sparse candidates from 2404 or merge candidates from 2410) may be checked. The BVs may proceed to (e.g., always go to) a refinement sparse process 2416. A (e.g., different) refinement window size may be determined based on (e.g., according to) the BV type (Sparse or Merge). At step 2416, BVP candidates in the updated sparse list 2412 may be refined using a refinement search window. The size of the refinement search window may depend on the BVP type for generating a refined candidate list 2418. BVPs from sparse searching in a regular TMP reference region may use a 3×3 window 2415 (sampling interval of 1 sample). BVPs included in the updated sparse list 2412 from the updated merge list 2410, whether inside or outside the regular reference region, may use a window 2414 with a size of 11×11 samples (sampling interval of 1 sample).

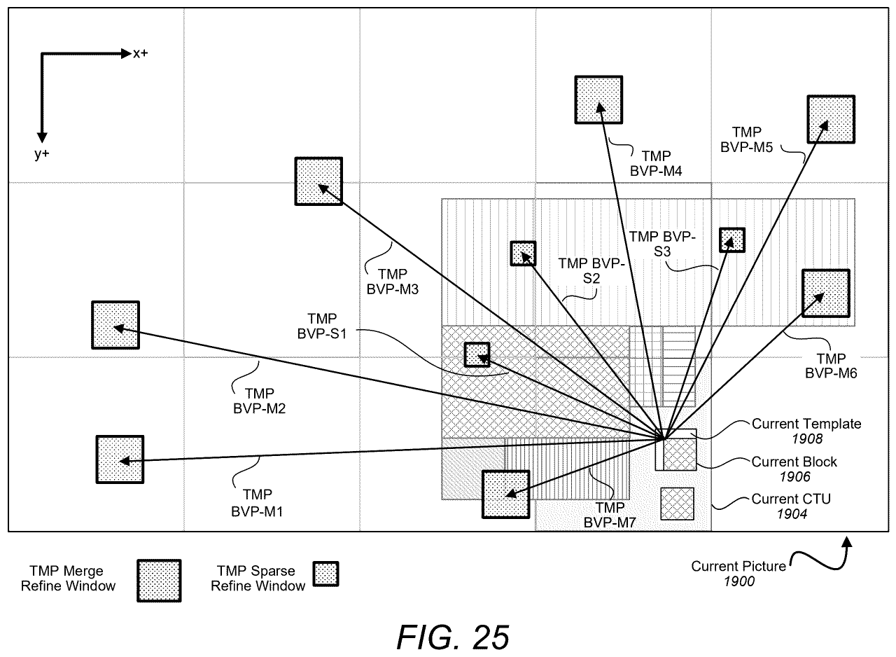

FIG. 25 shows example refinement windows. More specifically, FIG. 25 shows example refinement windows (or refine windows) for sparse block vector candidates (TMP BVP-S1 through TMP BVP-S3), and merge block vector candidates (TMP BVP-M1 through TMP BVP-M7). A Sparse block vector candidate may be obtained from a portion of a TMP search region (e.g., as shown in FIG. 25, a sparse block vector candidate pointing to a portion of a TMP search region). Merge block vector candidates may be obtained from neighboring blocks. Merge block vector candidates may be restricted to an IBC region larger than the TMP search region. The refinement window sizes for the sparse block vector candidates may be smaller than the refinement window sizes of the merge block vector candidates (e.g., as shown in FIG. 25).

IntraTMP is described herein. IntraTMP with Merge Candidates is also described in K. Naser et al, “EE2-1.2: IntraTMP with Merge Candidates,” JVET-AG0151, January 2024, the content of which is herein incorporated by reference.

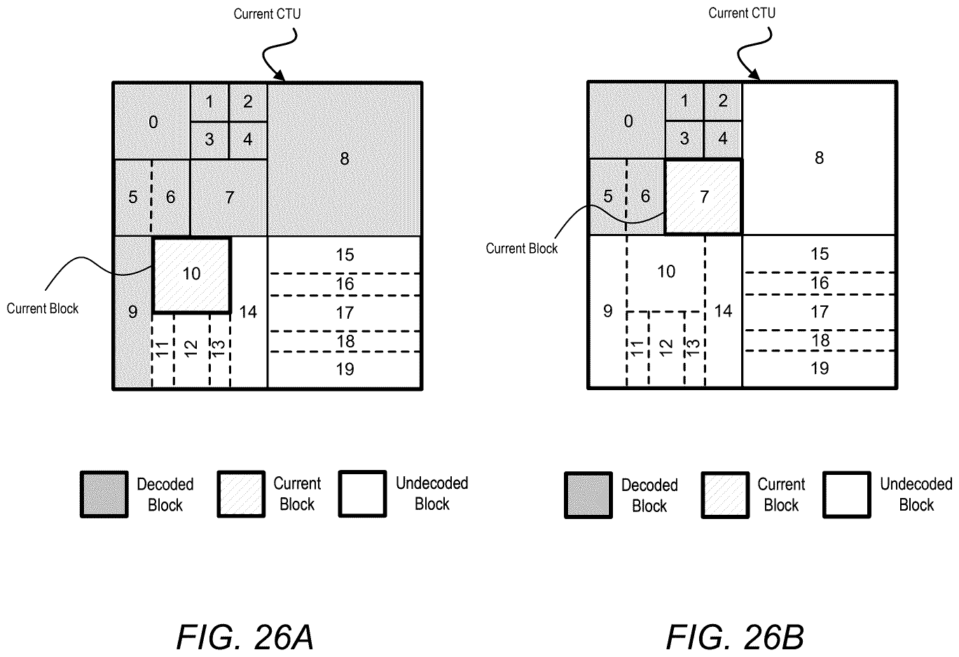

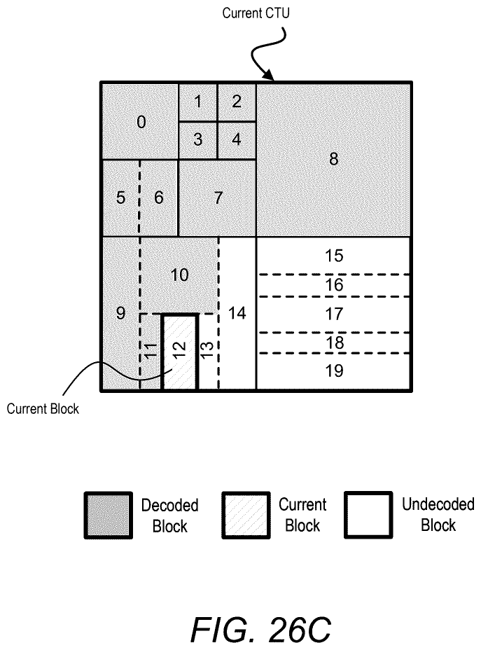

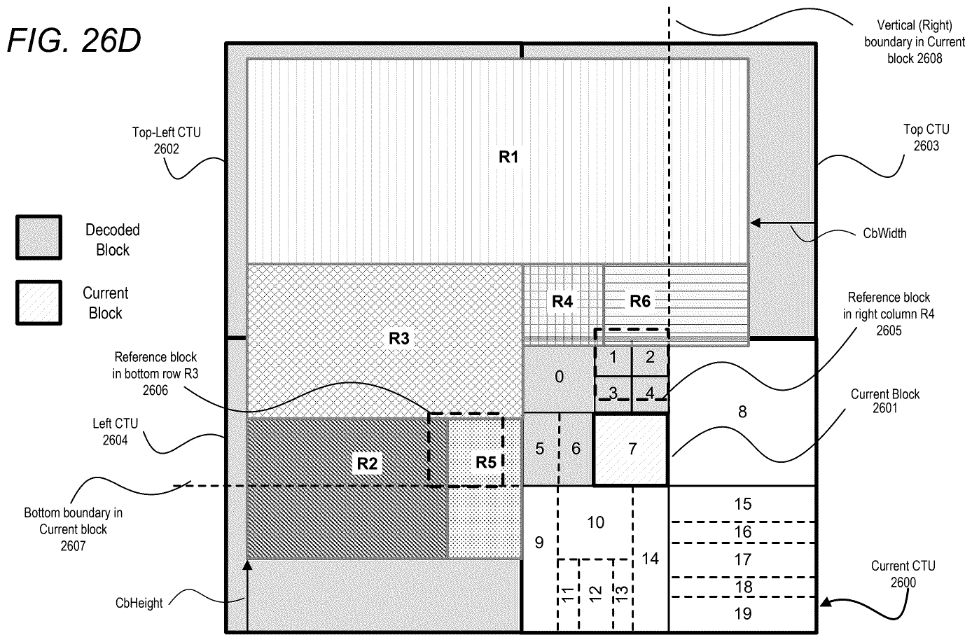

IntraTMP may select a prediction block within the RR from already reconstructed samples (e.g., in the decoding process) within the current frame. The irregular shape of the RR and other factors may result in some search regions of the RR being invalid for purposes of TMP search for some current blocks (e.g., some locations and dimensions of the current block). The irregular shape of the RR and other factors may result in some search regions of the RR being invalid for purposes of TMP search for some current blocks (e.g., some locations and dimensions of the current block), for example, because they may (e.g., partially or fully) comprise samples that have not already reconstructed, as described herein with respect to and/or as shown in FIGS. 26A-26C. The selection of the prediction block within the RR may be based on already encoded samples. The selection of the prediction block within the RR may be based on already encoded samples, for example, in an encoding process.

There may be regions whose validation may depend on the reconstruction blocks in the current CTU. There may be regions whose validation may depend on the reconstruction blocks in the current CTU, even though the search regions are designed to guarantee that the search position is always valid. For example, there may be two regions, R5 and R6, whose validation depends on the reconstruction blocks in the current CTU. The reconstruction blocks in the current CTU may depend on the current block location within the current CTU and the specific CTU partitioning. The raster-scanning order may be from left to right and top to bottom. VVC partitioning is well described in Huang et al, “Block Partitioning Structure in the VVC Standard,” IEEE Trans. on Circuits and Systems for Video Technology, Vol. 31, No. 10, October 2021, the content of which is herein incorporated by reference.

FIG. 26A shows an example CTU partitioning. More specifically, FIG. 26A shows the example CTU partitioning as shown in FIG. 7A, with an example current block located in the bottom-left quadtree and decoded blocks indicated. The block index shown inside each block in the CTU may indicate the left to right and top to bottom reconstruction order (in the decoding process) and the encoding order (in the encoding process) for the internal blocks in that CTU. In FIG. 26A, block 10 located in the bottom-left quadtree in the current CTU is shown as the current block. Since the block indexes are indicative of the encoding/reconstructing order, blocks 0-9 in the current CTU are already reconstructed, and are shown as shaded blocks. As can be seen in FIG. 26A, all blocks in the top-left and top-right quadtrees that are above the bottom-left quadtree are already reconstructed, as is block 9, which is the only block to the left of the current block within the bottom-left quadtree. Thus, within the current CTU shown in FIG. 26A, all blocks above the current block and all blocks to the left of the current block have already been reconstructed. It can be observed that all the samples on top and left of the current block are encoded/decoded so that samples may be used for the TMP search regions.

FIG. 26B shows an example CTU partitioning. More specifically, FIG. 26B shows the example CTU partitioning shown in FIG. 26A, with an example current block located in the top-left quadtree and decoded blocks indicated. The current block (block 7) is located in the top-left quadtree. Since the current block is in the top-left quadtree, the other three quadtrees (top-right, bottom-left and bottom-right quadtrees) are still not decoded. Within the top-left quadtree, all the other blocks (blocks 0-6) are already decoded.

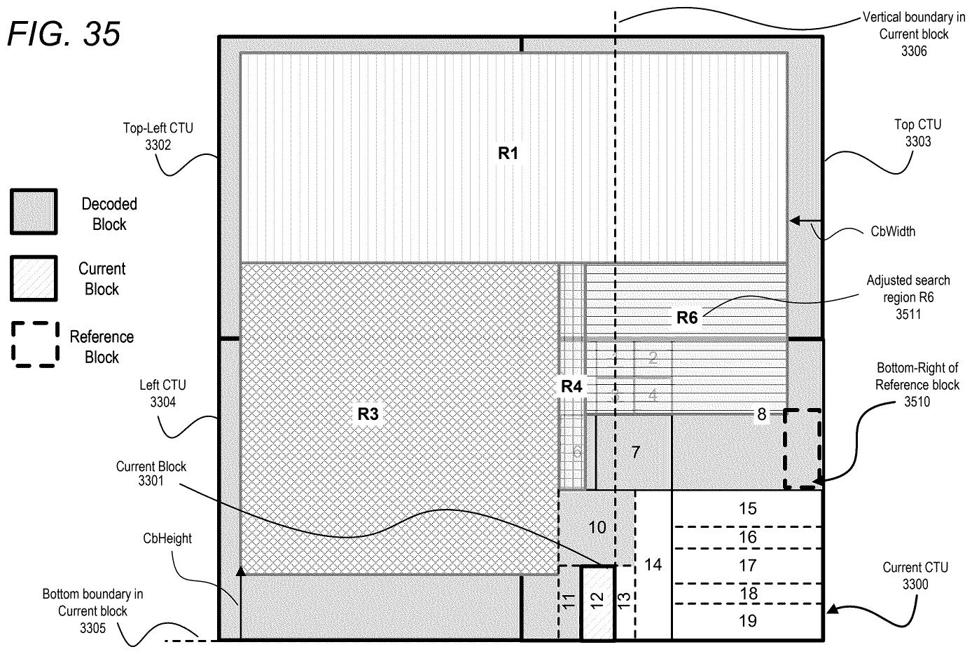

FIG. 26C shows an example CTU partitioning. More specifically, FIG. 26C shows an example current block located in the bottom-left quadrant of a current CTU. As shown in FIG. 26C, the current block (block 12) is located in the bottom-left quadrant of the current CTU. As shown by the shading and block numbering, the quadtrees above the bottom-left quadtree are already decoded, and the blocks 9, 11 and 10 which are left and above the current block are also already decoded. Some samples above the current block (e.g., samples belonging to block 14, 15, 16, or 17) may still need to be decoded, for example, due to the particular CTU partitioning that uses a ternary tree. Samples above the current block may refer to samples with a Y coordinate less than that of the samples in the first/top row in the current block (e.g., the origin of coordinates may be located at the top-left of the picture). TMP reference regions may extend (e.g., significantly) above-right to the current block (e.g., see FIG. 35).

A validation process may be applied to (e.g., used for) each location in the search regions. A validation process may be applied to (e.g., used for) each location in the search regions, for example, to handle a diversity of scenarios in the current CTU. A validation process may be applied to (e.g., used for) each location in search regions that may contain invalid positions (e.g., the search regions R5 and R6), for example, in some implementations of VVC and other video coding techniques. The search regions R1-R4 may be (e.g., always) sufficiently above and/or left of the current block that the search regions R1-R4 (e.g., all samples in the search regions R1-R4) are valid for all current block positions and dimensions. The validation process for validating search regions that may contain invalid positions (e.g., search regions R5 and R6) may require determining whether the entire reference region belongs to the already encoded and decoded samples. This may be time-consuming and may increase the encoder and decoder complexity.

Examples described herein may perform a search region checking of search regions that may contain invalid positions (e.g., search regions R5 and R6). Examples described herein may perform a search region checking of search regions that may contain invalid positions (e.g., search regions R5 and R6), for example, before starting the sparse searching process. This may achieve advantages such as avoiding the substantially resource-intensive validity checking of all positions in the search regions (e.g., search regions R5 and R6). Note that the examples described herein may also be used for the refinement stage. In the refinement stage, the searching may be constrained to one of the search regions. The refinement window size may be smaller than that for the sparse searching process. Similar advantages may be achieved.

A first validation may be performed. A first validation may be performed, for example, as a first step of a search region checking process. An entire search region may be skipped, and the sparse searching and/or refinement searching may not be computed for this region. An entire search region may be skipped, and the sparse searching and/or refinement searching may not be computed for this region, for example, if the bottom-right corner of a reference block located in the top-left corner of the R5 or R6 search regions is invalid (e.g., that sample does not belong to a block already encoded/decoded).

A second validation may be performed. A second validation may be performed, for example, as a second step of the search region checking process. The search region checking process for the bottom-right corner of a reference block located in the bottom-right corner of the search region may be computed. The search region checking process for the bottom-right corner of a reference block located in the bottom-right corner of the search region may be computed, for example, if the search region (e.g., R5 or R6 search regions) is not skipped in the first step described herein. The sparse searching and/or refinement searching may be processed regularly, skipping the reference block validation for each location in the search region. The sparse searching and/or refinement searching may be processed regularly, skipping the reference block validation for each location in the search region, for example, if such a position (e.g., the bottom-right corner of the reference block positioned at such a position) is valid. The terms “valid” and “invalid” are used in relation to a sample in this disclosure to mean that the sample is a reconstructed sample or the sample is not reconstructed, or, in the context of an encoder, an encoded sample or an unencoded sample. The term “valid” is used in relation to a position in a search region in this disclosure to mean that all the samples of a reference block positioned in that position are valid samples.

The validation process of the second step may be applied (e.g., used) iteratively. The validation process of the second step may be applied (e.g., used) iteratively, for example, if the second step of the search region checking process fails. The validation process of the second step may be applied iteratively to the rows above (e.g., scanned from bottom to top) until a validation for the bottom-right corner of the search region is achieved. The height of the search region may be reduced by one row by moving up the bottom row of the search region by one row, and the second step may be applied (e.g., again), for example, based on (e.g., in response to) a determination that the second step fails. The second step may fail, for example, if the bottom-right sample of the reference block located at the bottom-right corner of the search region is not reconstructed. The height of the search region may be reduced by one row by moving up the bottom row of the search region by one row, and the second step may be applied again, for example, to determine whether the bottom-right corner of a reference block located in the bottom-right corner of the adjusted search region (i.e., height-reduced search region) is valid. The bottom boundary of that search region may be adjusted to such a row, for example, when/if the validation is met. This may (e.g., significantly) reduce the complexity of the validation process in the sparse search and/or refinement search.

FIG. 26D shows an example of a current block and neighboring CTUs. FIG. 26D shows an example of a current block in the top-left quadrant in a current CTU and the three neighbor CTUs. More specifically, FIG. 26D shows an example of a current block 2601 in a current CTU 2600 and the three neighbor CTUs (i.e., top CTU 2603, top-left CTU 2602, left CTU 2604) at the top and left side of the current CTU. The bottom boundary 2607 and the right boundary 2608 of the current block 2601 are also shown. The reconstructed (encoded) samples, valid as a reference block, are shaded in grey. The search regions R1-R6 of the current block 2601 are shown. It is also shown that the left column of the current block is aligned with the right column of search region R4. Any reference block located at/in the right column of the R4 (e.g., reference block 2605) may be vertically aligned with the current block 2601. All samples of a reference block may be (e.g., always) located at the already reconstructed (encoded) samples, valid to be used for the reference block, and are shaded in grey.

FIG. 26D also shows that the top row of the current block (top boundary of current block 2601) may be aligned with the bottom row of search region R3. Any reference block located at/in the bottom row of the R3 (e.g., reference block 2606) may be horizontally aligned with the current block 2601. All samples of a reference block may be (e.g., always) located at the already reconstructed (encoded) samples, valid to be used for the reference block, and are shaded in grey.

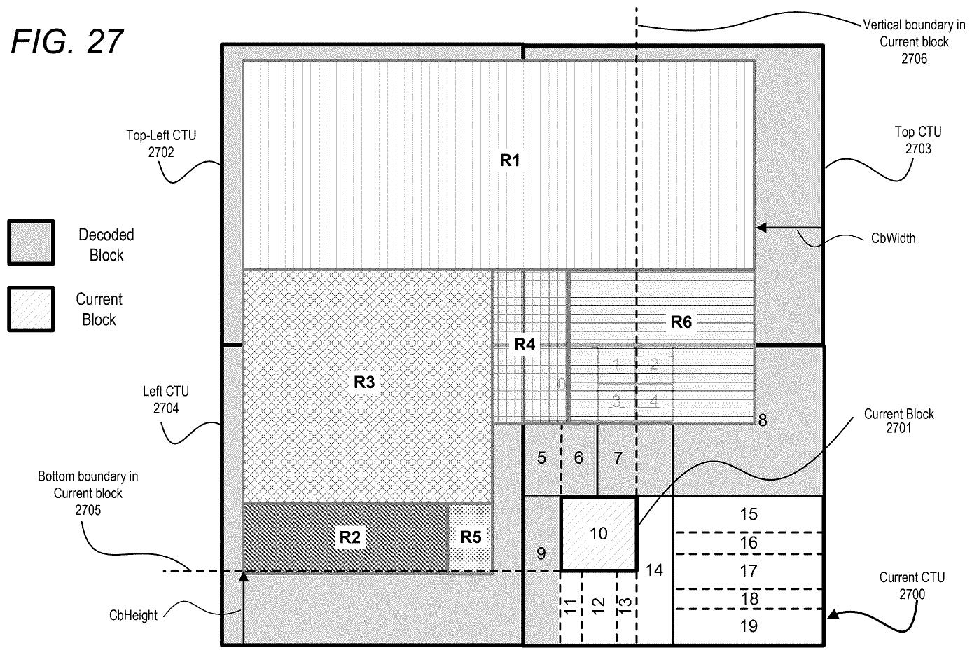

FIG. 27 shows an example of a current block and neighboring CTUs. FIG. 27 shows an example of a current block in a current CTU and the three neighbor CTUs at the top and left side of the current CTU. More specifically, FIG. 27 shows an example of a current block 2701 in a current CTU 2700 and the three neighbor CTUs (i.e., top CTU 2703, top-left CTU 2702, left CTU 2704) at the top and left side of the current CTU. The bottom boundary 2705 and the vertical boundary 2706 of the current block 3301 are also shown.

The reconstructed (encoded) samples, valid to be used for the reference block, are shaded in grey. The search regions R1-R6 of the current block 2701 are shown. The reference region (RR) may comprise the areas of the search regions R1-R6. The three neighbor CTUs may have been reconstructed (encoded) and blocks 0-9 that are to the left and above the current block 2701 (block index 10) in the current CTU 2700 have been decoded.

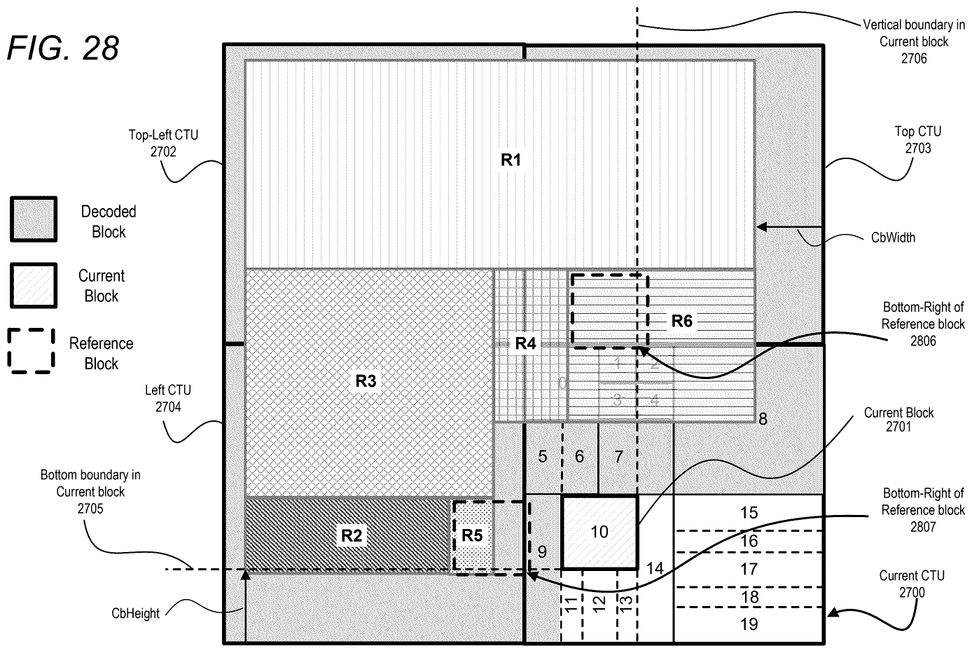

FIG. 28 shows an example of a first validation process. FIG. 28 shows an example of a portion of the validation process of the bottom-right corner of the reference block located at the top-left corner of the search regions R5 and R6. More specifically, FIG. 28 shows, for the same current block 2701 as shown in FIG. 27, an example of the first step of the validation process. The bottom-right corner of the reference block located at the top-left corner of each of the search regions R5 and R6 may be checked for validity. It can be observed that reference block 2806 has shifted a column to the right with respect to the current block 2701, and reference block 2807 has shifted one row to the bottom with respect to the current block 2701. The reference block 2806 may be located with its top-left sample overlapping the top-left sample of search region R6. The reference block 2807 may be located with its top-left sample overlapping the top-left sample of search region R5. In both cases, the bottom-right samples of the reference blocks 2806 and 2807 are valid. The second step of the validation process may be performed for the reference block located at the bottom-right corner of the search regions R5 and R6. The second step of the validation process may be performed for the reference block located at the bottom-right corner of the search regions R5 and R6, for example, when/if the first step of the validation step is successful. The first step of the validation step may be successful, for example, if it is determined that the bottom-right sample of the reference block located at the top-left sample of the search region is valid.

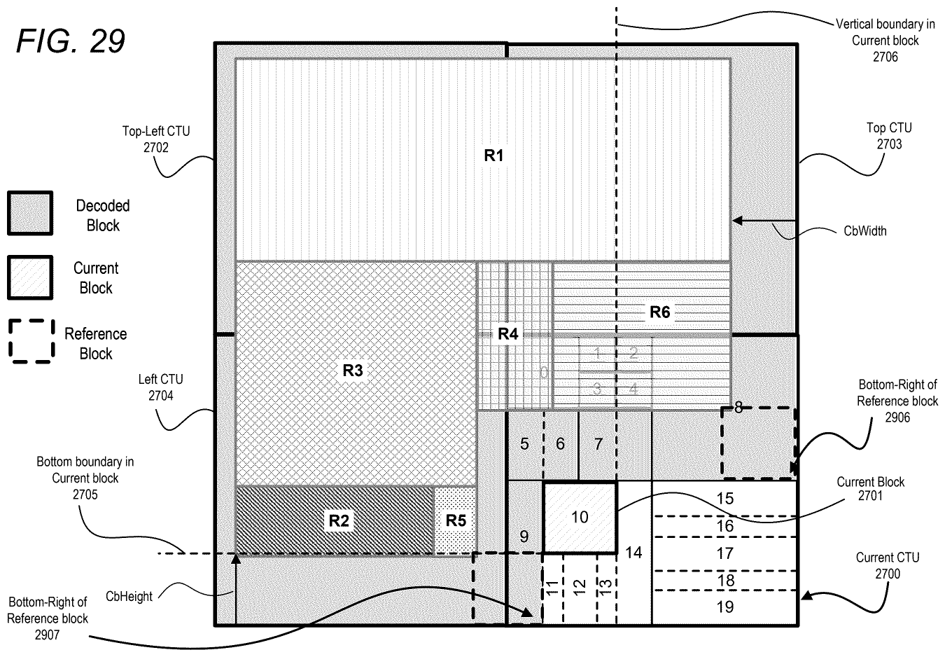

FIG. 29 shows an example of a second validation process. FIG. 29 shows an example of another portion of the validation process. More specifically, FIG. 29 shows, for the same current block 2701 as shown in FIG. 27, an example of the second step of the validation process. The bottom-right sample of the reference blocks 2906 and 2907 in search regions R6 and R5, respectively, may be in already reconstructed (encoded) areas. The bottom-right sample of the reference blocks (and consequently the entire reference block) may be in an already encoded area. Both search regions R5 and R6 may be determined as valid regions. The sparse searching and/or refinement searching may be carried out regularly, without needing to test the reference block validity for each position.

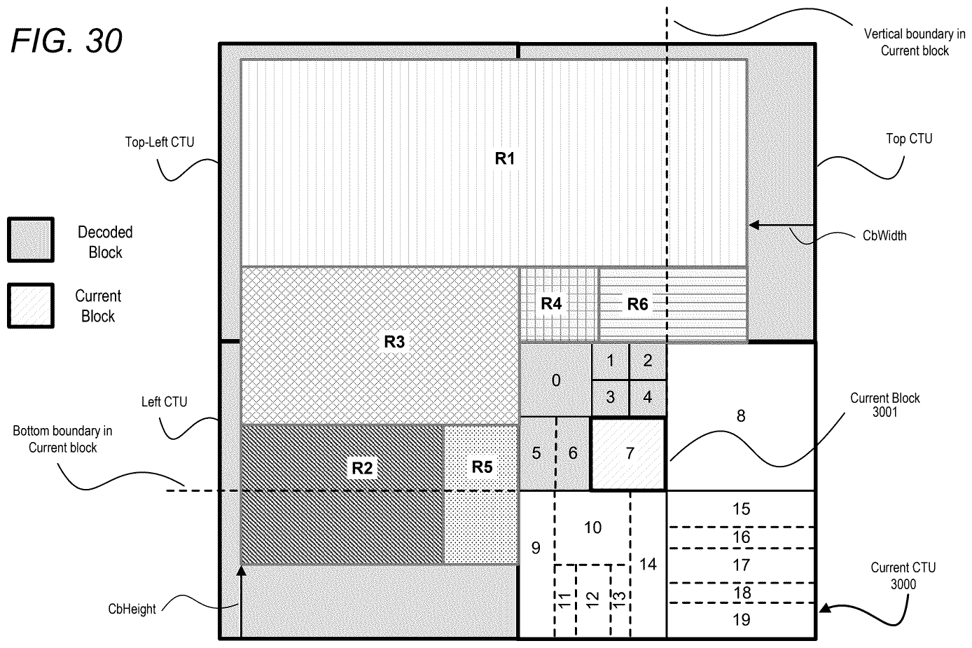

FIG. 30 shows an example of a current block in a CTU partition and the associated search regions (e.g., TMP search regions). More specifically, FIG. 30 shows an example of the current block (e.g., current block 3001) being located in the top-left quadtree of a current CTU (e.g., CTU 3000). In the example as shown in FIG. 30, the current block 3001 (block index 7 in the bottom right CTU) is located in the top-left quadtree of the current CTU 3000. The encoded samples in the current CTU 3000 are constrained to the blocks inside belonging to the same quadtree (blocks 0, 1, 2, 3, 4, 5, and 6).

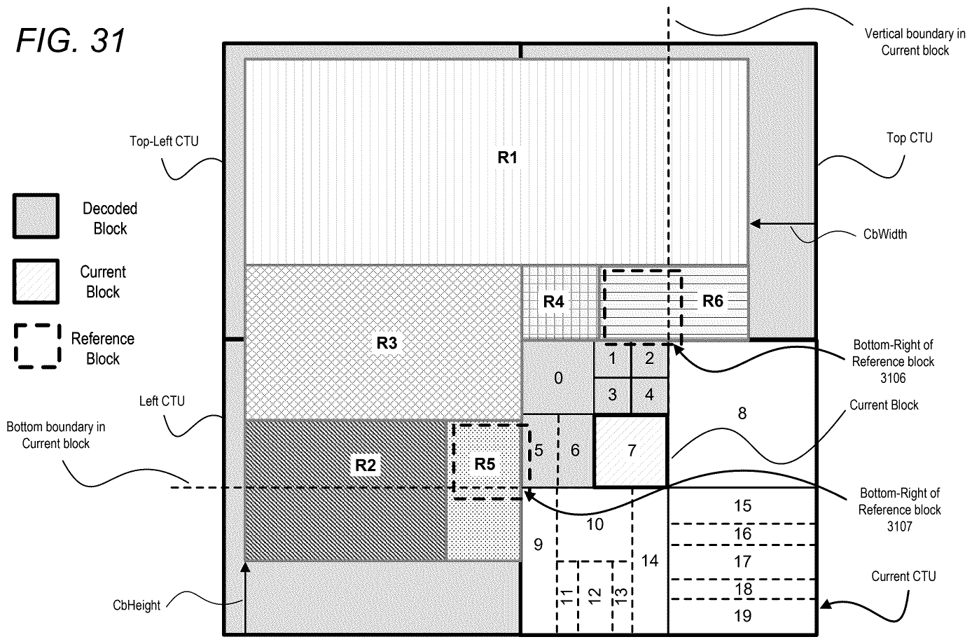

FIG. 31 shows an example of a first validation process. More specifically, FIG. 31 shows, for the same current block as shown in FIG. 30, an example of the validation process being applied to (e.g., used for) search regions R5 and R6 based on testing the top-left position in each of those search regions. In both search regions, the bottom-right pixel of the reference blocks may be in an invalid position (i.e., position that still needs to be reconstructed). FIG. 31 shows the validation of the search regions R5 and R6 based on the first validation step (i.e., that of checking the validity of the top-left position of the search region). In both search regions, the bottom-right pixel of the reference blocks 3106 and 3107 may be in an invalid position corresponding to blocks 8 and 9, which may still need to be reconstructed (encoded). The search regions R5 and R6 may be excluded from sparse searching and/or refinement searching, reducing the computational burden.

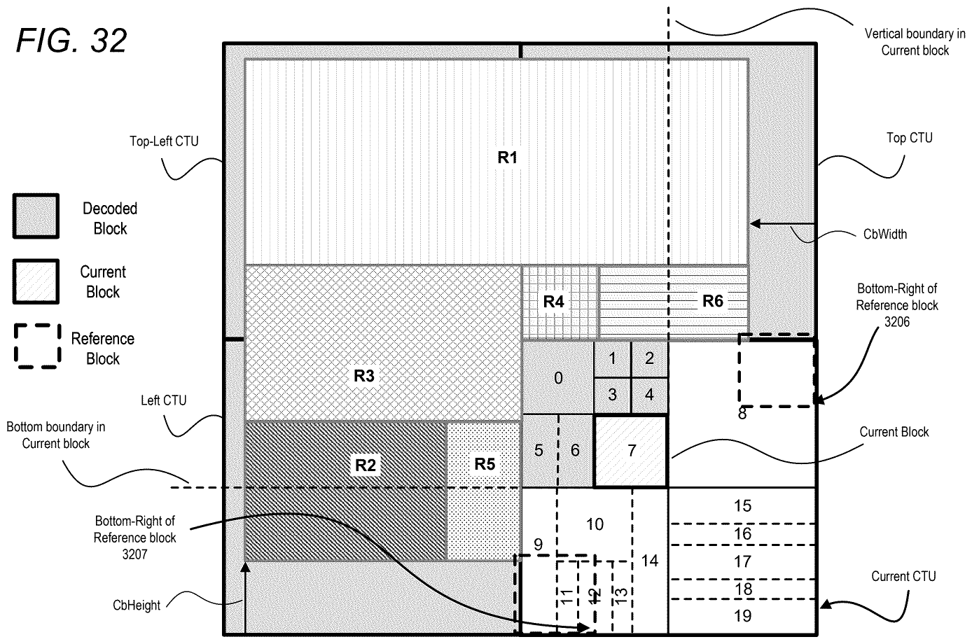

FIG. 32 shows an example of a second validation process. More specifically, FIG. 32 shows, for the same current block as in FIG. 30, an example of the second validation step of the validation process. The second validation step may be applied to (e.g., used for) search regions R5 and R6 based on testing of the position at the bottom-right corner in both search regions. The bottom-right sample positions of both reference blocks 3206 and 3207 may be invalid. This example may show that the testing of the bottom-right position of the search region may be unnecessary, for instance, when/if the testing of the top-left position results in the reference block's bottom-right position being invalid. FIG. 32 depicts the second validation for the position at the bottom-right corner in both areas, confirming that both are invalid (i.e., that they are both in areas not yet reconstructed (encoded)) and confirming that the second validation is not required because all locations in the R5 and R6 regions are invalid.

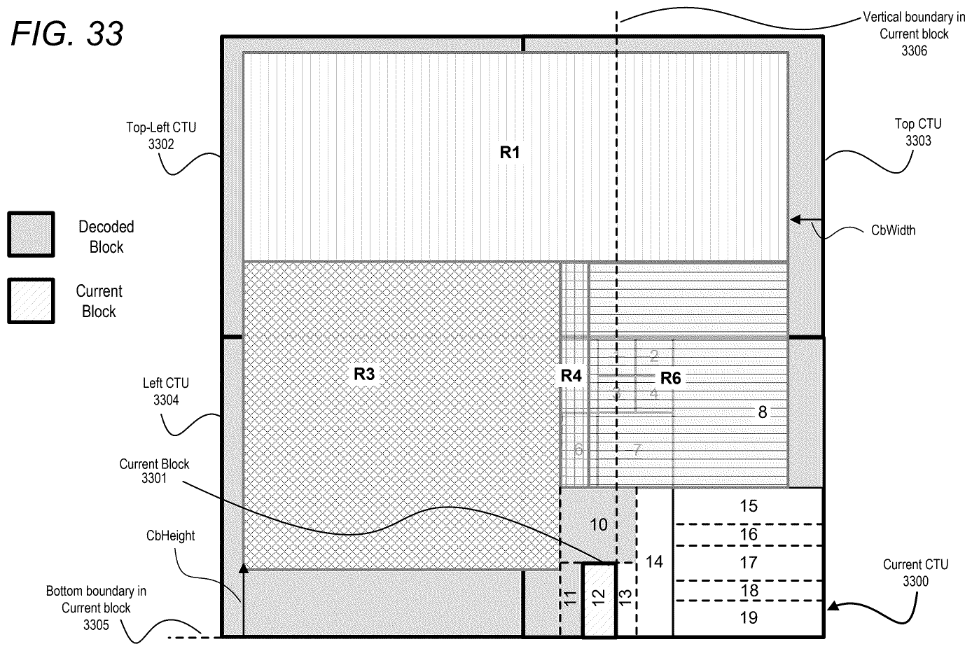

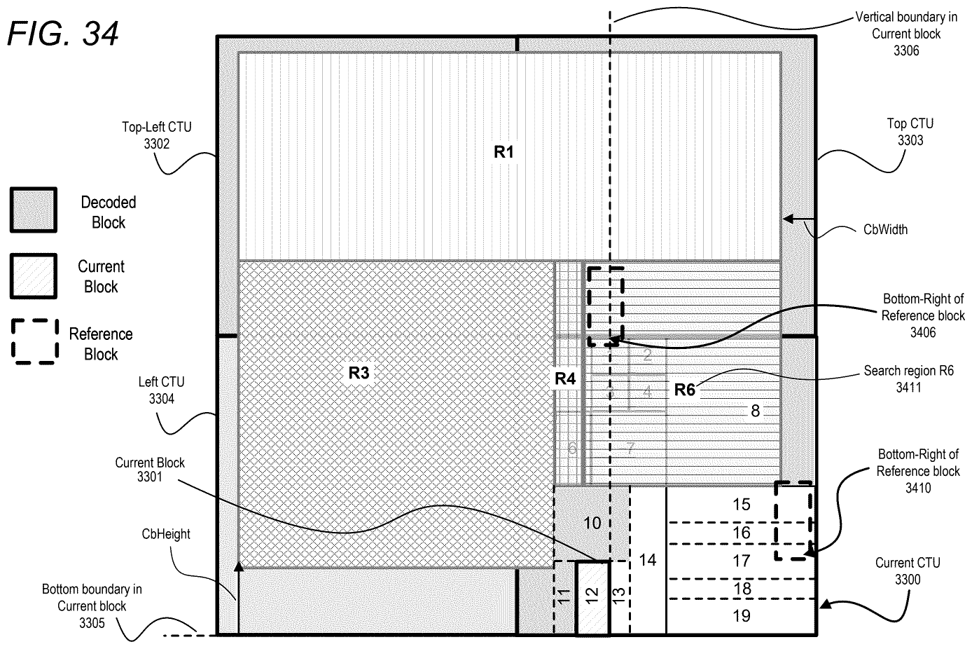

FIG. 33 shows an example of a current block in a CTU partition and the associated search regions (e.g., TMP search regions). More specifically, FIG. 33 shows an example of the current block 3301 (block index 12) located in the current CTU 3300, similar to that as described with respect to FIG. 26C. Neighboring top CTU 3303, top-left CTU 3302 and left CTU 3304 are shown. The bottom boundary 3305 and the vertical boundary 3306 of the current block 3301 are also shown. The first and second validation steps of the example validation process as applied to (e.g., used for) the current block 3301 are depicted in FIG. 34.

FIG. 34 shows an example of testing a search region using the validation process. More specifically, FIG. 34 shows, for the same current block as shown in FIG. 33, an example of testing the top-left position (e.g., the first step of the validation process) and the bottom-right position (e.g., the second step of the validation process) of search region R6 using the validation process of the search regions for the current block of FIG. 33. The testing of the top-left position (see reference block 3406) may indicate that the search region R6 (3411) is valid. The testing of the bottom-right position (see reference block 3410) may indicate that the search region R6 (e.g., some positions of the search region) is invalid. The first validation step may confirm that the search region R6 is valid at the top-left position. The second validation step may confirm that the search region R6 is invalid at the bottom-right position. In this case, the second validation step may be applied/used iteratively to/for the previous rows (e.g., rows above the current row) until a validation for the bottom-right corner (e.g., corresponding to 3410) of the search region is achieved. This may ensure that the entire search region is valid, allowing for skipping an exhaustive region validation.

FIG. 35 shows an example of a search region dimension adjustment. More specifically, FIG. 35, for the same current block as shown in FIG. 33, shows an example of the search region dimension adjustment of search region R6. The adjustment may be applied/used based on (e.g., subsequent to, after) the testing as shown in FIG. 34. FIG. 35 may represent the first location (e.g., a new bottom boundary of the region) in the search region R6 where the reference block 3510 is entirely valid for all the positions within the search region R6. The bottom boundary of the search region R6 may be adjusted to such a row to convert it into an entirely valid region (i.e., an adjusted search region R6 3511) and skip the validation for each location in the sparse search and/or refinement search.

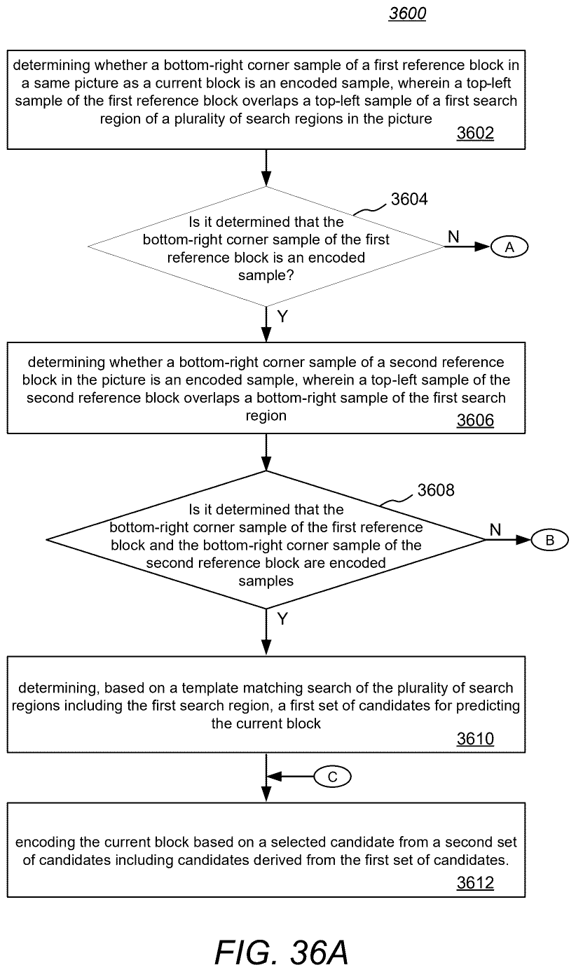

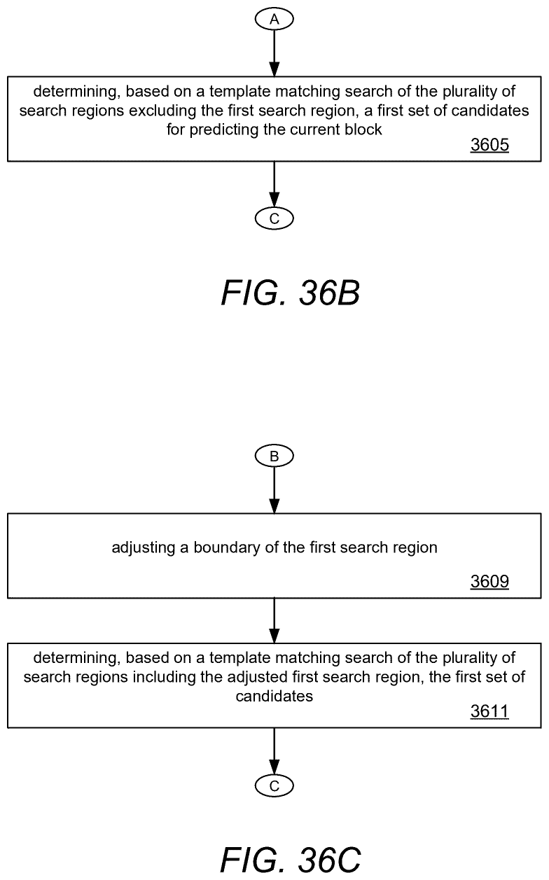

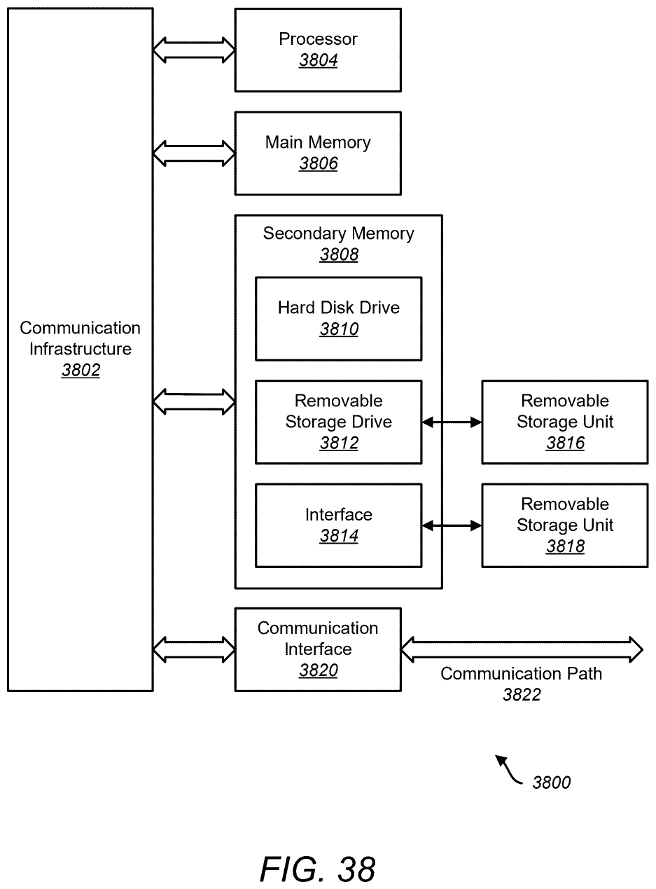

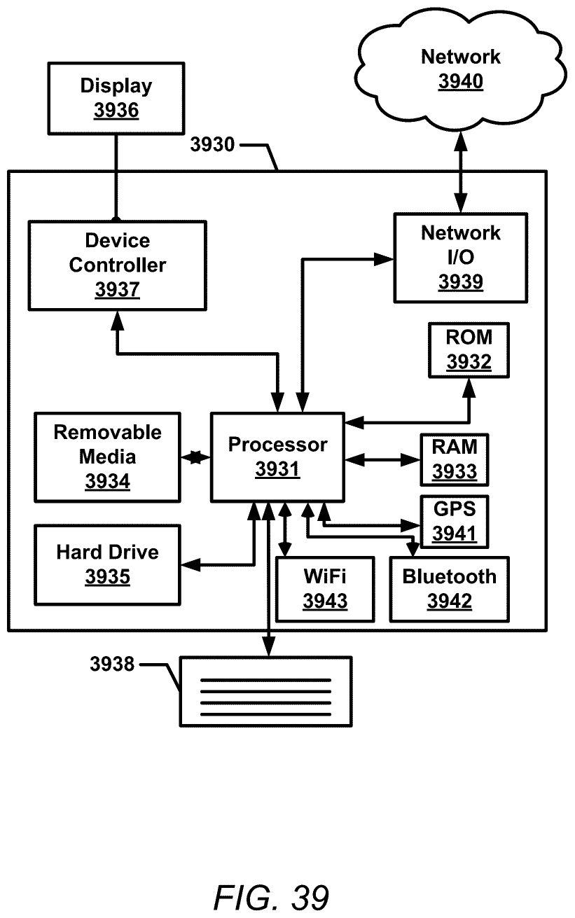

FIG. 36A, FIG. 36B, and FIG. 36C show an example method for encoding a bitstream. More specifically, FIG. 36A, FIG. 36B, and FIG. 36C show flowcharts of an example method 3600 for encoding a bitstream. The example method 3600 may reduce the overhead incurred for validating search regions in IntraTMP by early termination of search of some search regions and optional search region dimension adjustment. One or more steps of the example method 3600 may be performed and/or implemented by an encoder (e.g., encoder 200 of FIG. 2), an example computer system 3800 as described herein with respect to FIG. 38, and/or an example computing device 3930 as described herein with respect to FIG. 39.

FIG. 36A shows a flowchart of an example method 3600 for encoding a current block using IntraTMP. The example method may reduce the computational cost for search region validation for the sparse search and/or refinement search. At least some IntraTMP technology may require some search regions (e.g., R5 and R6) of the reference region to have samples validated for availability for use in reference blocks. Examples described herein may provide for early termination of such validating of search regions, for example, if search regions comprise invalid samples. Examples described herein may (e.g., optionally) provide for adjusting the dimensions of search regions so that validation of entire search regions may be avoided.

The example method (e.g., flowchart) 3600 may start at step 3602. The method may start at step 3602, for example, when/if the encoder is encoding a current block. The example method (e.g., flowchart) 3600 may be performed, for example, in the process described in relation to FIG. 24, prior to the determining of template matching costs on search regions at step 2403. The example method (e.g., flowchart) 3600 may be performed, for example, to determine whether search regions R5 and R6 are to be included in the search for sparse candidates in Sparse List 2404 and/or in the refinement search.

The example method (e.g., flowchart) 3600 may provide a two-step validation process for validating the search regions in the reference region of a current block. At step 3602, the encoder may perform the first validation step to validate the top-left sample position of a search region (e.g., search regions R5 or R6). The validation may be based on a reference block located at the top-left of the search region. At step 3602, the encoder may determine whether a bottom-right corner sample of a first reference block in a same picture as a current block is an encoded sample. The bottom-right corner sample may be at an intersection of the rightmost column of samples of the first search region and the bottommost row of samples of the first search region. The top-left sample may be at an intersection of the leftmost column of samples of the first reference block and the topmost row of samples of the first reference block. The first reference block may be positioned so that the top-left sample of the first reference block overlaps the top-left sample of the first search region of the plurality of search regions in the picture. The determination of whether the bottom-right corner sample of the first reference block is an encoded sample may comprise determining whether the sample in the bottom-right corner in the first reference block is located outside the picture, overlaps the current block, is in a non-decoded CTU, or in a non-decoded block.

The dimensions and the locations of search regions R5 and R6 may be determined. The dimensions and the locations of search regions R5 and R6 may be determined, for example, based on (e.g., according to) the location and size of the current block. The first reference block may fully or partially overlap the current block, for example, when/if it is determined that the bottom-right corner sample of the first reference block is not an already encoded sample. The first reference block may be fully or partially located in a non-decoded CTU or in a non-decoded block, for example, when/if it is determined that the bottom-right corner sample of the first reference block is not an already encoded sample. The first reference block may extend outside the picture, for example, when/if it is determined that the bottom-right corner sample of the first reference block is not an already encoded sample. The first search region may partially overlap the current CTU. A right edge of the first search region may extend further than the right edge of the current block. A bottom edge of the first search region may extend further than the bottom edge of the current block. The right edge of the first search region may extend further than the right edge of the current block, and a distance between the bottom edge of the first search region and the top edge of the current block may correspond to the height of the current block. The bottom edge of the first search region may extend further than the bottom edge of the current block, and a distance between the right edge of the first search region and the left edge of the current block may correspond to the width of the current block.

The plurality of search regions may comprise search regions R1-R6. The first search region may be one of search regions R5 or R6. The plurality of search regions may subdivide a reference region determined based on (e.g., in accordance with) at least the location of the current block. Each of the plurality of search regions may be determined based on (e.g., according to) the location of the current block and a size of the current block.

At step 3604, the encoder may determine if the bottom-right corner sample of the first reference block is an encoded sample. If the encoder determines that the bottom-right corner sample of the first reference block is an encoded sample, the example method 3600 may proceed to step 3606. If the encoder determines that the bottom-right corner sample of the first reference block is not an encoded sample, the example method 3600 may proceed to step 3605 (as shown in FIG. 36B).

At step 3606, the encoder may perform the second validation step of the two-step validation process. The encoder may determine whether a bottom-right corner sample of a second reference block in the picture is an encoded sample. The second reference block may be positioned such that a top-left sample of the second reference block overlaps a bottom-right sample of the first search region. The encoder may determine whether the sample in the bottom-right corner in the second reference block is located outside the picture, overlaps the current block, or is in a non-decoded CTU. In some examples, the encoder may not check the validity of any more samples other than the top-left sample and the bottom-right sample in/between the first and second validation steps of the validations process. In some examples, one or more other samples may be checked for validity in/between the first and second validation steps of the validations process.

At step 3608, the encoder may determine if the bottom-right corner sample of the second reference block is an encoded sample. If the encoder determines that the bottom-right corner sample of the second reference block is an encoded sample, the example method 3600 may proceed to step 3610. If the encoder determines that the bottom-right corner sample of the second reference block is not an encoded sample, the example method 3600 may proceed to step 3609 (as shown in FIG. 36C).

At step 3610, the encoder may determine a first set of candidates for predicting the current block. The encoder may determine a first set of candidates for predicting the current block, for example, based on a template matching search of the plurality of search regions including the first search region. For example, the first set of candidates may comprise BVP candidates obtained from the sparse searching process. In the example process described herein with respect to FIG. 24, the first set of candidates according to step 3610 may be determined during the TMP cost determinations at step 2403 for BVP candidates in the reference region.

At step 3612, the encoder may encode the current block. The encoder may encode the current block, for example, based on a selected candidate from a second set of candidates.

The second set of candidates may include candidates derived from the first set of candidates. The second set of candidates may be the candidates in the refined list 2414, for example, as described herein with respect to FIG. 24. The candidates in the refined list 2414 may include candidates selected based on candidates in the first set of candidates and merge BVP candidates. The candidates selected based on candidates in the first set of candidates may include candidates from the first set of candidates and candidates obtained by a refinement search based on candidates in the first set of candidates.

The encoding of the current block based on the selected candidate from the second set of candidates may comprise calculating rate-distortion optimization costs of respective candidates in the second set of candidates. The encoding of the current block based on the selected candidate from the second set of candidates may comprise selecting, based on template matching costs and rate-distortion optimization costs of the second set of candidates, the selected candidate.

FIG. 36B shows a flowchart for a portion of the example method 3600 of FIG. 36A. The example method 3600 may proceed to step 3605, for example, when/if the encoder determines (at step 3604) that the bottom-right corner sample of the first reference block is not a reconstructed sample.

At step 3605, the encoder may determine a first set of candidates for predicting the current block. The encoder may determine a first set of candidates for predicting the current block, for example, based on a template matching search of the plurality of search regions excluding the first search region. After step 3605, the example method 3600 may proceed to step 3612 as described herein.

FIG. 36C shows a flowchart for another portion of the example process 3600 of FIG. 36A.

The example process 3600 may proceed to step 3609, for example, when/if the encoder determines (at step 3608) that the bottom-right corner sample of the second reference block is not a reconstructed sample.

At step 3609, the encoder may adjust a boundary of the first search region. At step 3611, the encoder may determine the first set of candidates. The encoder may determine the first set of candidates, for example, based on a template matching search of the plurality of search regions including the adjusted first search region.

The adjusting of the boundary of the first search region may be performed. The adjusting of the boundary of the first search region may be performed, for example, by decreasing a height of the first search region. The height of the first search region may be decreased, for example, by moving a bottom edge of the first search region. The adjusting of the boundary of the first search region may be performed, for example, based on determining whether a bottom-right corner sample of a third reference block is a reconstructed sample. A top-left sample of the third reference block may overlap a bottom-right sample of the adjusted first search region. The adjusting of the boundary of the first search region may be performed, for example, by repeatedly decreasing a height of the first search region. The height of the first search region may be repeatedly decreased, for example by moving the bottom edge of the first search region up one row at a time until the bottom-right corner sample of a respective third reference block is determined to be a reconstructed sample. A top-left sample of the respective third reference block may overlap a bottom-right sample of the adjusted first search region. After the first set of candidates is determined (e.g., selected) at step 3611, the example process 3600 may proceed to step 3612 as described herein.

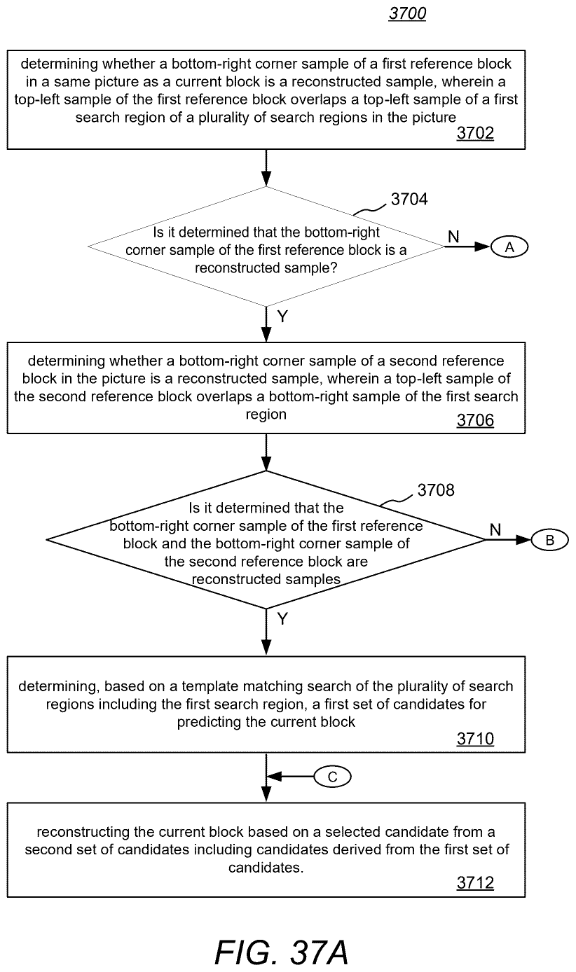

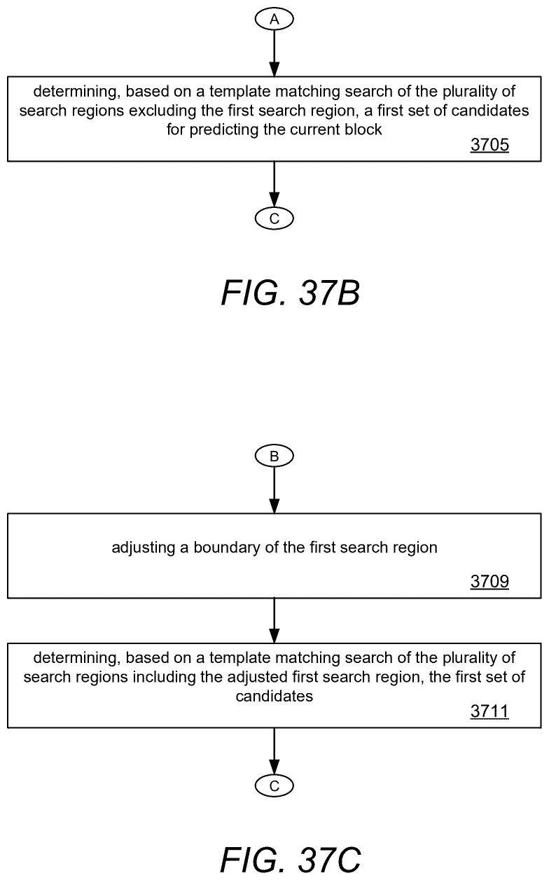

FIG. 37A, FIG. 37B, and FIG. 37C show an example method for decoding a bitstream.

More specifically, FIG. 37A, FIG. 37B, and FIG. 37C show flowcharts of an example method 3700 for decoding a bitstream. The example method 3700 may reduce the overhead incurred for validating search regions in IntraTMP by early termination of search of some search regions and optional search region dimension adjustment. One or more steps of the example method 3700 may be performed and/or implemented by a decoder (e.g., decoder 300 of FIG. 3), an example computer system 3800 as described herein with respect to FIG. 38, and/or an example computing device 3930 as described herein with respect to FIG. 39.

FIG. 37A shows a flowchart of an example method 3700 for reconstructing a current block using IntraTMP. The example method may reduce the computational cost for search region validation for the sparse search and/or refinement search. At least some IntraTMP technology may require some search regions (e.g., R5 and R6) of the reference region to have samples validated for availability for use in reference blocks. Examples described herein may provide for early termination of such validating of search regions, for example, if search regions comprise invalid samples. Examples described herein may (e.g., optionally) provide for adjusting the dimensions of search regions so that compute-intensive validation of entire search regions may be avoided.

The example method (e.g., flowchart) 3700 may start at step 3702 when the decoder is decoding a current block. The example method (e.g., flowchart) 3700 may be performed, for example, in the process described in relation to FIG. 24, prior to the determining of template matching costs on search regions at step 2403. The example method (e.g., flowchart) 3700 may be performed, for example, to determine whether search regions R5 and R6 are to be included in the search for sparse candidates of Spare List 2404.

The example method (e.g., flowchart) 3700 may provide a two-step validation process for validating the search regions in the reference region of a current block. At step 3702, the decoder may perform the first validation step to validate the top-left sample position of a search region (e.g., search regions R5 or R6). The validation may be based on a reference block located at the top-left of the search region. At step 3702, the decoder may determine whether a bottom-right corner sample of a first reference block in a same picture as a current block is a reconstructed sample. The bottom-right corner sample may be at an intersection of the rightmost column of samples of the first search region and the bottommost row of samples of the first search region. The top-left sample may be at an intersection of the leftmost column of samples of the first reference block and the topmost row of samples of the first reference block. The first reference block may be positioned so that the top-left sample of the first reference block overlaps the top-left sample of the first search region of the plurality of search regions in the picture. The determination of whether the bottom-right corner sample of the first reference block is a reconstructed sample may comprise determining whether the sample in the bottom-right corner in the first reference block is located outside the picture, overlaps the current block, or is in a non-decoded CTU.

The dimensions and the location of search regions R5 and R6 may be determined. The dimensions and the location of search regions R5 and R6 may be determined, for example, based on (e.g., according to) the location and size of the current block. The first reference block may fully or partially overlap the current block, for example, when/if it is determined that the bottom-right corner sample of the first reference block is not an already reconstructed sample. The first reference block may be fully or partially located in a non-decoded CTU or in a non-reconstructed block, for example, when/if it is determined that the bottom-right corner sample of the first reference block is not an already reconstructed sample. The first reference block may extend outside the picture, for example, when/if it is determined that the bottom-right corner sample of the first reference block is not an already reconstructed sample. The first search region may partially overlap the current CTU. A right edge of the first search region may extend further than the right edge of the current block. A bottom edge of the first search region may extend further than the bottom edge of the current block. The right edge of the first search region may extend further than the right edge of the current block, and a distance between the bottom edge of the first search region and the top edge of the current block may correspond to the height of the current block.

The bottom edge of the first search region may extend further than the bottom edge of the current block, and a distance between the right edge of the first search region and the left edge of the current block may correspond to the width of the current block.

The plurality of search regions may comprise search regions R1-R6. The first search region may be one of search regions R5 or R6. The plurality of search regions may subdivide a reference region determined based on (e.g., in accordance with) at least the location of the current block. Each of the plurality of search regions may be determined based on (e.g., according to) the location of the current block and a size of the current block.

At step 3704, the decoder may determine if the bottom-right corner sample of the first reference block is a reconstructed sample. If the decoder determines that the bottom-right corner sample of the first reference block is a reconstructed sample, the example method 3700 may proceed to step 3706. If the decoder determine that the bottom-right corner sample of the first reference block is not a reconstructed sample, the example method 3700 may proceed to step 3705 (as shown in FIG. 37B).

At step 3706, the decoder may perform the second validation step of the two-step validation process. The decoder may determine whether a bottom-right corner sample of a second reference block in the picture is a reconstructed sample. The second reference block may be positioned such that a top-left sample of the second reference block overlaps a bottom-right sample of the first search region. The decoder may determine whether the sample in the bottom-right corner in the second reference block is located outside the picture, overlaps the current block, or is in a non-decoded CTU. In some examples, the decoder does not check the validity of any more samples other than the top-left sample and the bottom-right sample in/between the first and second validation steps of the validations process. In some examples, one or more other samples may be checked for validity in/between the first and second validation steps of the validations process.

At step 3708, the decoder may determine if the bottom-right corner sample of the second reference block is a reconstructed sample. If the decoder determines that the bottom-right corner sample of the second reference block is a reconstructed sample, the example method 3700 may proceed to step 3710. If the decoder determines that the bottom-right corner sample of the second reference block is not a reconstructed sample, the example method 3700 may proceed to step 3709 (as shown in FIG. 37C).

At step 3710, the decoder may determine a first set of candidates for predicting the current block. The decoder may determine a first set of candidates for predicting the current block, for example, based on a template matching search of the plurality of search regions including the first search region. The first set of candidates may comprise BVP candidates obtained from the sparse searching process. In the example process described herein with respect to FIG. 24, the first set of candidates according to step 3710 may be determined during the TMP cost determinations at step 2403 for BVP candidates in the reference region.

Referring back to FIG. 37A, at step 3712, the decoder may reconstruct the current block.

The decoder may reconstruct the current block, for example, based on a selected candidate from a second set of candidates. The second set of candidates may include candidates derived from the first set of candidates. The second set of candidates may be the candidates in the refined list 2414, for example, as described herein with respect to FIG. 24. The candidates in the refined list 2414 may include candidates selected based on candidates in the first set of candidates and merge BVP candidates. The candidates selected based on candidates in the first set of candidates may include candidates from the first set of candidates and candidates obtained by a refinement search based on candidates in the first set of candidates.

The decoding of the current block based on the selected candidate from the second set of candidates may comprise calculating rate-distortion optimization costs of respective candidates in the second set of candidates. The decoding of the current block based on the selected candidate from the second set of candidates may comprise determining (e.g., selecting), based on template matching costs and rate-distortion optimization costs of the second set of candidates, the selected candidates. The reconstructing of the current block based on the selected candidate may comprise performing the reconstructing based on a residual from a bitstream and a reference block corresponding to the selected candidate.

FIG. 37B shows a flowchart for a portion of the example method 3700 of FIG. 37A. The example method 3700 may proceed to step 3705, for example, when/if the decoder determines (at step 3704) that the bottom-right corner sample of the first reference block is not a reconstructed sample.

At step 3705, the decoder may determine a first set of candidates for predicting the current block. The decoder may determine a first set of candidates, for example, based on a template matching search of the plurality of search regions excluding the first search region. The entirety of the first search region may be excluded from the sparse search. After step 3705, the example method 3700 may proceed to step 3712 as described herein.

FIG. 37C shows a flowchart for a portion of the example method 3700 of FIG. 37A. The example method 3700 may proceed to step 3709, for example, when/if the decoder determines (at step 3708) that the bottom-right corner sample of the second reference block is not a reconstructed sample.

At step 3709, the decoder may adjust a boundary of the first search region. At step 3711, the decoder may determine the first set of candidates. The decoder may determine the first set of candidates, for example, based on a template matching search of the plurality of search regions including the adjusted first search region. After the first set of candidates is selected at step 3711, the example method 3700 may proceed to step 3712 as described herein.

The adjusting of the boundary of the first search region may be performed. The adjusting of the boundary of the first search region may be performed, for example, by decreasing a height of the first search region. The height of the first search region may be decreased, for example, by moving a bottom edge of the first search region. The adjusting of the boundary of the first search region may be performed, for example, by repeatedly decreasing a height of the first search region. The height of the first search region may be repeatedly decreased, for example by moving the bottom edge of the first search region up one row at a time. The adjusting of the boundary of the first search region may be performed, for example, based on determining whether a bottom-right corner sample of a third reference block is a reconstructed sample. A top-left sample of the third reference block may overlap a bottom-right sample of the adjusted first search region.

Examples of the present disclosure may be implemented in hardware using analog and/or digital circuits, in software, through the execution of instructions by one or more general purpose or special-purpose processors, or as a combination of hardware and software.

Consequently, examples of the disclosure may be implemented in the environment of a computer system or other processing system. An example of such a computer system 3800 is shown in FIG. 38. FIG. 38 shows an example computer system in which examples of the present disclosure may be implemented. For example, various devices and/or systems described herein (e.g., in FIGS. 1, 2, and 3) may be implemented in the form of one or more computer systems 3800. Furthermore, each of the steps of the flowcharts depicted in this disclosure may be implemented on one or more computer systems 3800.

Computer system 3800 includes one or more processors, such as processor 3804. Processor 3804 may be, for example, a special purpose processor, a general purpose processor, a microprocessor, and/or a digital signal processor. Processor 3804 may be connected to a communication infrastructure 3802 (e.g., a bus or network). Computer system 3800 may also include a main memory 3806 (e.g., a random access memory (RAM)) and/or a secondary memory 3808.

Secondary memory 3808 may include a hard disk drive 3810 and/or a removable storage drive 3812 (e.g., a magnetic tape drive, an optical disk drive, and/or the like). Removable storage drive 3812 may read from and/or write to a removable storage unit 3816.

Removable storage unit 3816 may comprise a magnetic tape, optical disk, and/or the like.

The removable storage unit 3816 may be read by and/or may be written to by removable storage drive 3812. The removable storage unit 3816 may comprise a computer usable storage medium having stored therein computer software and/or data.

The secondary memory 3808 may include other similar means for allowing computer programs or other instructions to be loaded into computer system 3800. Such means may include a removable storage unit 3818 and/or an interface 3814. Examples of such means may include a program cartridge and/or cartridge interface (such as in video game devices), a removable memory chip (such as an erasable programmable read-only memory (EPROM) or a programmable read-only memory (PROM)) and associated socket, a thumb drive and USB port, and/or other removable storage units 3818 and interfaces 3814 which may allow software and/or data to be transferred from removable storage unit 3818 to computer system 3800.

Computer system 3800 may also include a communications interface 3820.

Communications interface 3820 may allow software and data to be transferred between computer system 3800 and external devices. Examples of communications interface 3820 may include a modem, a network interface (e.g., an Ethernet card), a communications port, etc. Software and/or data transferred via communications interface 3820 may be in the form of signals which may be electronic, electromagnetic, optical, and/or other signals capable of being received by communications interface 3820. The signals may be provided to communications interface 3820 via a communications path 3822. Communications path 3822 may carry signals and may be implemented using wire or cable, fiber optics, a phone line, a cellular phone link, an RF link, and/or any other communications channel(s).

The computer system 3800 may also comprise one or more sensor(s) 3824. The sensor(s) 3824 may measure or detect one or more physical quantities and convert the measured or detected physical quantities into an electrical signal in digital and/or analog form. For example, the sensor(s) 3824 may include an eye tracking sensor to track the eye movement of a user. A display of a point cloud may be updated, for example, based on the eye movement of a user. The sensor(s) 3824 may include a head tracking sensor to track the head movement of a user. A display of a point cloud may be updated, for example, based on the head movement of a user. The sensor(s) 3824 may include a camera sensor for taking photographs and/or a 3D scanning device (e.g., a laser scanning device, a structured light scanning device, and/or a modulated light scanning device). The 3D scanning devices may determine geometry information by moving one or more laser heads, structured light, and/or modulated light cameras relative to the object or scene being scanned. The geometry information may be used to construct a point cloud.

A computer program medium and/or a computer readable medium may be used to refer to tangible storage media, such as removable storage units 3816 and 3818 or a hard disk installed in hard disk drive 3810. The computer program products may be means for providing software to computer system 3800. Computer programs (which may also be called computer control logic) may be stored in main memory 3806 and/or secondary memory 3808. Computer programs may be received via communications interface 3820.

Such computer programs, when executed, may enable the computer system 3800 to implement the present disclosure as discussed herein. In particular, the computer programs, when executed, may enable processor 3804 to implement the processes of the present disclosure, such as any of the methods described herein. Accordingly, such computer programs may represent controllers of the computer system 3800.

Features of the disclosure may be implemented in hardware using, for example, hardware components such as application-specific integrated circuits (ASICs) and gate arrays.

Implementation of a hardware state machine to perform the functions described herein will also be apparent to persons skilled in the relevant art(s).

FIG. 39 shows example elements of a computing device that may be used to implement any of the various devices described herein, including, for example, a source device (e.g., 102), an encoder (e.g., 114), a destination device (e.g., 106), a decoder (e.g., 120), and/or any computing device described herein. The computing device 3930 may include one or more processors 3931, which may execute instructions stored in the random-access memory (RAM) 3933, the removable media 3934 (such as a Universal Serial Bus (USB) drive, compact disk (CD) or digital versatile disk (DVD), or floppy disk drive), or any other desired storage medium. Instructions may also be stored in an attached (or internal) hard drive 3935. The computing device 3930 may also include a security processor (not shown), which may execute instructions of one or more computer programs to monitor the processes executing on the processor 3931 and any process that requests access to any hardware and/or software components of the computing device 3930 (e.g., ROM 3932, RAM 3933, the removable media 3934, the hard drive 3935, the device controller 3937, a network interface 3939, a GPS 3941, a Bluetooth interface 3942, a WiFi interface 3943, etc.). The computing device 3930 may include one or more output devices, such as the display 3936 (e.g., a screen, a display device, a monitor, a television, etc.), and may include one or more output device controllers 3937, such as a video processor. There may also be one or more user input devices 3938, such as a remote control, keyboard, mouse, touch screen, microphone, etc. The computing device 3930 may also include one or more network interfaces, such as a network interface 3939, which may be a wired interface, a wireless interface, or a combination of the two. The network interface 3939 may provide an interface for the computing device 3930 to communicate with a network 3940 (e.g., a RAN, or any other network). The network interface 3939 may include a modem (e.g., a cable modem), and the external network 3940 may include communication links, an external network, an in-home network, a provider's wireless, coaxial, fiber, or hybrid fiber/coaxial distribution system (e.g., a DOCSIS network), or any other desired network. Additionally, the computing device 3930 may include a location-detecting device, such as a global positioning system (GPS) microprocessor 3941, which may be configured to receive and process global positioning signals and determine, with possible assistance from an external server and antenna, a geographic position of the computing device 3930.

The example in FIG. 39 may be a hardware configuration, although the components shown may be implemented as software as well. Modifications may be made to add, remove, combine, divide, etc. components of the computing device 3930 as desired. Additionally, the components may be implemented using basic computing devices and components, and the same components (e.g., processor 3931, ROM storage 3932, display 3936, etc.) may be used to implement any of the other computing devices and components described herein.

For example, the various components described herein may be implemented using computing devices having components such as a processor executing computer-executable instructions stored on a computer-readable medium, as shown in FIG. 39. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. The computing device may determine whether a bottom-right corner sample of a first reference block in a same picture as a current block is a reconstructed sample. A top-left sample of the first reference block may overlap a top-left sample of a first search region of a plurality of search regions in the picture. The computing device may determine whether a bottom-right corner sample of a second reference block in the picture is a reconstructed sample. A top-left sample of the second reference block may overlap a bottom-right sample of the first search region. The computing device may determine, based on the plurality of search regions, a first set of candidates for predicting the current block. The computing device may decode the current block based on a selected candidate from a second set of candidates that includes the first set of candidates. The bottom-right corner sample of the first reference block and the bottom-right corner sample of the second reference block may be reconstructed samples. The determining the first set of candidates may be based on the plurality of search regions including the first search region. The bottom-right corner sample of the first reference block may not be a reconstructed sample. The determining the first set of candidates may be based on the plurality of search regions excluding the first search region. The bottom-right corner sample of the first reference block may be a reconstructed sample. The computing device may adjust a boundary of the first search region based on determining that the bottom-right corner sample of the second reference block is not a reconstructed sample. The computing device may determine the first set of candidates, based on a template matching search of the plurality of search regions including the adjusted first search region. Locations of the plurality of search regions may be determined based on the current block. The determining whether the bottom-right corner sample of the first reference block or the second reference block is a reconstructed sample may comprise determining whether the bottom-right corner sample is: located outside the picture; overlapping the current block; in a non-decoded coding tree unit (CTU); or in a non-decoded block. The computing device may determine that the bottom-right corner sample of the first reference block is not a reconstructed sample based on at least one of: the first reference block extending outside the picture; the first reference block fully or partially overlapping the current block; the first reference block is fully or partially in a non-decoded coding tree unit (CTU); or the first reference block is fully or partially in a non-decoded block. The computing device may decode the current block based on: a residual from a bitstream; and a reference block corresponding to the selected candidate. No samples of the first search region other than the top-left sample and the bottom-right sample may be validated using a reference block. The bottom-right corner sample of the first reference block may be a reconstructed sample. The computing device may decrease a height of the first search region by moving a bottom edge of the first search region, based on determining that the bottom-right corner sample of the second reference block is not a reconstructed sample. The computing device may determine whether a bottom-right corner sample of a third reference block is a reconstructed sample. A top-left sample of the third reference block may overlap a bottom-right sample of the first search region with a decreased height. The bottom-right corner sample of the first reference block may be a reconstructed sample. The computing device may, based on determining that the bottom-right corner sample of the second reference block is not a reconstructed sample, repeatedly decreasing a height of the first search region by moving a bottom edge of the first search region up one row until a bottom-right corner sample of a third reference block is a reconstructed sample. A top-left sample of the third reference block may overlap a bottom-right sample of the first search region with a decreased height. The first search region may be at least one of: partially overlapping a current coding tree unit (CTU); having a right edge extending further than a right edge of the current block; having a bottom edge extending further than a bottom edge of the current block; having a bottom edge with a distance from a top edge of the current block corresponding to a height of the current block; or having a right edge with a distance from a left edge of the current block corresponding to a width of the current block. The computing device may comprise one or more processors and memory, storing instructions that, when executed by the one or more processors, perform the method described herein. A system may comprise the computing device configured to perform the described method, additional operations, and/or include additional elements; and a second computing device configured to encode the current block. A computer-readable medium may store instructions that, when executed, cause performance of the described method, additional operations, and/or include additional elements.

A computing device may perform a method comprising multiple operations. The computing device may validate a top-left sample of a first search region of a plurality of search regions in a same picture as a current block. The computing device may validate a bottom-right sample of the first search region. The computing device may determine, based on a template matching search of the plurality of search regions, a first set of candidates for predicting the current block. The computing device may decode the current block based on a selected candidate from a second set of candidates including the first set of candidates. The validating the top-left sample of the first search region may comprise determining whether a bottom-right corner sample of a first reference block is a reconstructed sample. A top-left sample of the first reference block may overlap the top-left sample of the first search region. The validating the bottom-right sample of the first search region may comprise determining whether a bottom-right corner sample of a second reference block is a reconstructed sample. A top-left sample of the second reference block may overlap the bottom-right sample of the first search region. The top-left sample of the first search region and the bottom-right sample of the first search region may be valid. The determining the first set of candidates may be based on the plurality of search regions including the first search region. The top-left sample of the first search region may be invalid. The determining the first set of candidates may be based on the plurality of search regions excluding the first search region. The top-left sample of the first search region may be valid.

The computing device may adjust a boundary of the first search region based on determining that the bottom-right sample of the first search region is invalid. The computing device may determine the first set of candidates, based on the template matching search of the plurality of search regions including the adjusted first search region. One or more of the plurality of search regions may be determined based on at least one of: a location of the current block; or a size of the current block. No samples of the first search region other than the top-left sample and the bottom-right sample may be validated. The top-left sample of the first search region may be valid. The computing device may decrease a height of the first search region by moving a bottom edge of the first search region, based on determining that the bottom-right sample of the first search region is invalid. The top-left sample of the first search region may be valid. The computing device may, based on determining that the bottom-right sample of the first search region is invalid, repeatedly decrease a height of the first search region by moving a bottom edge of the first search region up one row until the bottom-right sample of the first search region is valid. The computing device may comprise one or more processors and memory, storing instructions that, when executed by the one or more processors, perform the method described herein.

A system may comprise the computing device configured to perform the described method, additional operations, and/or include additional elements; and a second computing device configured to encode the current block. A computer-readable medium may store instructions that, when executed, cause performance of the described method, additional operations, and/or include additional elements.

A computing device may perform a method comprising multiple operations. The computing device may determine whether a bottom-right corner sample of a first reference block in a same picture as a current block is an encoded sample. A top-left sample of the first reference block may overlap a top-left sample of a first search region of a plurality of search regions in the picture. The computing device may determine whether a bottom-right corner sample of a second reference block in the picture is an encoded sample. A top-left sample of the second reference block may overlap a bottom-right sample of the first search region. The computing device may determine, based on the plurality of search regions, a first set of candidates for predicting the current block. The computing device may encode the current block based on a selected candidate from a second set of candidates that includes the first set of candidates. The bottom-right corner sample of the first reference block and the bottom-right corner sample of the second reference block may be encoded samples. The determining the first set of candidates may be based on the plurality of search regions including the first search region. The bottom-right corner sample of the first reference block may not be an encoded sample. The determining the first set of candidates may be based on the plurality of search regions excluding the first search region. The bottom-right corner sample of the first reference block may be an encoded sample. The computing device may adjust a boundary of the first search region, based on determining that the bottom-right corner sample of the second reference block is not an encoded sample. The computing device may determine the first set of candidates, based on a template matching search of the plurality of search regions including the adjusted first search region. The computing device may comprise one or more processors and memory, storing instructions that, when executed by the one or more processors, perform the method described herein. A system may comprise the computing device configured to perform the described method, additional operations, and/or include additional elements; and a second computing device configured to decode the current block. A computer-readable medium may store instructions that, when executed, cause performance of the described method, additional operations, and/or include additional elements.

A computing device may perform a method comprising multiple operations. The computing device may determine whether a bottom-right corner sample of a first reference block in a same picture as a current block is a reconstructed sample. A top-left sample of the first reference block may overlap a top-left sample of a first search region of a plurality of search regions in the picture, and locations of the plurality of search regions may be calculated based at least on the current block. The computing device may determine whether a bottom-right corner sample of a second reference block in the picture is a reconstructed sample. A top-left sample of the second reference block may overlap a bottom-right sample of the first search region. The computing device may determine, based on a template matching search of the plurality of search regions including the first search region, a first set of candidates for predicting the current block, if it is determined that the bottom-right corner sample of the first reference block and the bottom-right corner sample of the second reference block may be reconstructed samples. The computing device may reconstruct the current block based on a selected candidate from a second set of candidates including the first set of candidates. The computing device may determine, based on a template matching search of the plurality of search regions excluding the first search region, the first set of candidates, if it is determined that the bottom-right corner sample of the first reference block in the same picture as the current block is not a reconstructed sample. The determining, based on the template matching search of the plurality of search regions including the first search region, the first set of candidates for predicting the current block is performed without validating of samples other than the top-left sample and the bottom-right sample of the first search region. If it is determined that the bottom-right corner sample of the second reference block in the picture is not a reconstructed sample: the computing device may adjust a boundary of the first search region; and the computing device may determine, based on a template matching search of the plurality of search regions including the adjusted first search region, the first set of candidates. The adjusting the boundary of the first search region may comprise: decreasing a height of the first search region by moving a bottom edge of the first search region; and determining whether a bottom-right corner sample of a third reference block is a reconstructed sample. A top-left sample of the third reference block may overlap a bottom-right sample of the adjusted first search region.

The adjusting the boundary of the first search region may comprise: repeatedly decreasing a height of the first search region by moving a bottom edge of the first search region up one row until it is determined that the bottom-right corner sample of the respective third reference block is a reconstructed sample. A top-left sample of the respective third reference block may overlap a bottom-right sample of the adjusted first search region. The bottom-right corner sample may be at an intersection of the rightmost column of samples of the first search region and the bottommost row of samples of the first search region. The top-left sample may be at an intersection of the leftmost column of samples of the first reference block and the topmost row of samples of the first reference block. The determining whether the bottom-right corner sample of the first reference block is a reconstructed sample may comprise determining whether the sample in the bottom-right corner in the first reference block is located outside the picture, overlaps the current block, or is in a non-decoded CTU. The determining whether the bottom-right corner sample of the second reference block is a reconstructed sample may comprise determining whether the sample in the bottom-right corner in the second reference block is located outside the picture, overlaps the current block, or is in a non-decoded CTU. The first reference block may fully or partially overlap the current block, may be fully or partially in a non-decoded CTU, or may extend outside the picture, for example, when/if it is determined that the bottom-right corner sample of the first reference block is not a reconstructed sample. The first search region may partially overlap the current CTU. A right edge of the first search region may extend further than the right-edge of the current block. A bottom edge of the first search region may extend further than the bottom-edge of the current block. The right edge of the first search region may extend further than the right edge of the current block and a distance between the bottom edge of the first search region and the top edge of the current block may correspond to the height of the current block. The bottom edge of the first search region may extend further than the bottom edge of the current block and a distance between the right edge of the first search region and the left edge of the current block may correspond to the width of the current block. The plurality of search regions may comprise search regions R1-R6. The first search region may be one of R5 or R6. The plurality of search regions may subdivide a reference region determined in accordance with at least the location of the current block. Each of the plurality of search regions may be determined according to the location of the current block and a size of the current block.

The determining, based on a template matching search of the plurality of search regions excluding the first search region, the set of candidates for predicting the current block, may comprise: determining parameters of each search region of the plurality of search regions, the plurality of search regions subdividing a reference region; determining, using a first template matching search of sparse samples in the reference region in search regions other than the first search region, a set of sparse candidates for predicting the current block; and for each sparse candidate in a selected subset of the set of sparse candidates, determining a search window encompassing the each sparse candidate. The search window may be based on a first predetermined window size. The determining, using the first template matching search of sparse samples in the reference region in search regions other than the first search region, the set of sparse candidates for predicting the current block, may comprise: performing the first template matching search on respective search regions of the plurality of search regions in accordance with an ordered list of the search regions. The template matching search may comprise Intra-template matching prediction (IntraTMP) and the set of candidates may comprise candidates determined according to IntraTMP and/or candidates determined according to IntraTMP with Merge Candidates. The set of candidates may comprise block vectors of adjacent neighboring blocks and/or block vectors of non-adjacent neighboring blocks. Candidates of the first set of candidates may be located in a reference region, and at least one candidate of the second set of candidates may be located outside of the reference region. The reconstructing the current block based on the selected candidate from the second set of candidates including the first set of candidates, may comprise: calculating rate-distortion optimization costs of respective candidates in the first set of candidates and the second set of candidates; and selecting, based on template matching costs and rate-distortion optimization costs of the first set of candidates and the second set of candidates, the selected candidates. The reconstructing the current block based on the selected candidate may comprise performing the reconstructing based on a residual from a bitstream and a reference block corresponding to the selected candidate.

The computing device may comprise one or more processors and memory, storing instructions that, when executed by the one or more processors, perform the method described herein. A system may comprise the computing device configured to perform the described method, additional operations, and/or include additional elements; and a second computing device configured to encode the current block. A computer-readable medium may store instructions that, when executed, cause performance of the described method, additional operations, and/or include additional elements.

A computing device may perform a method comprising multiple operations. The computing device may determine whether a bottom-right corner sample of a first reference block in a same picture as a current block is an encoded sample. A top-left sample of the first reference block may overlap a top-left sample of a first search region of a plurality of search regions in the picture, and locations of the plurality of search regions may be calculated based at least on the current block. The computing device may determine whether a bottom-right corner sample of a second reference block in the picture is an encoded sample. A top-left sample of the second reference block may overlap a bottom-right sample of the first search region. The computing device may determine, based on a template matching search of the plurality of search regions including the first search region, a first set of candidates for predicting the current block, for example, if it is determined that the bottom-right corner sample of the first reference block and the bottom-right corner sample of the second reference block are encoded samples. The computing device may encode the current block based on a selected candidate from a second set of candidates including the first set of candidates. The computing device may determine, based on a template matching search of the plurality of search regions excluding the first search region, the first set of candidates, for example, if the bottom-right corner sample of the first reference block in the same picture as the current block is not an encoded sample. The determining, based on the template matching search of the plurality of search regions including the first search region, the first set of candidates for predicting the current block may be performed without validating of samples other than the top-left sample and the bottom-right sample of the first search region. If it is determined that the bottom-right corner sample of the second reference block in the picture is not an encoded sample: the computing device may adjust a boundary of the first search region; and the computing device may determine, based on a template matching search of the plurality of search regions including the adjusted first search region, the first set of candidates. The adjusting the boundary of the first search region may comprise: decreasing a height of the first search region by moving a bottom edge of the first search region; and determining whether a bottom-right corner sample of a third reference block is an encoded sample. A top-left sample of the third reference block may overlap a bottom-right sample of the adjusted first search region. The adjusting the boundary of the first search region may comprise: repeatedly decreasing a height of the first search region by moving a bottom edge of the first search region up one row until it is determined that the bottom-right corner sample of the respective third reference block is an encoded sample. A top-left sample of the respective third reference block may overlap a bottom-right sample of the adjusted first search region. The bottom-right corner sample may be at an intersection of the rightmost column of samples of the first search region and the bottommost row of samples of the first search region. The top-left sample may be at an intersection of the leftmost column of samples of the first reference block and the topmost row of samples of the first reference block. The determining whether the bottom-right corner sample of the first reference block is an encoded sample may comprise determining whether the sample in the bottom-right corner in the first reference block is located outside the picture, overlaps the current block, or is in a non-decoded CTU. The determining whether the bottom-right corner sample of the second reference block is an encoded sample may comprise determining whether the sample in the bottom-right corner in the second reference block is located outside the picture, overlaps the current block, or is in a non-decoded CTU. The first reference block may fully or partially overlap the current block, may be fully or partially in a non-decoded CTU, or may extend outside the picture, for example, when/if it is determined that the bottom-right corner sample of the first reference block is not an encoded sample. The first search region may partially overlap the current CTU. A right edge of the first search region may extend further than the right-edge of the current block. A bottom edge of the first search region may extend further than the bottom-edge of the current block. The right edge of the first search region may extend further than the right edge of the current block and a distance between the bottom edge of the first search region and the top edge of the current block may correspond to the height of the current block. The bottom edge of the first search region may extend further than the bottom edge of the current block and a distance between the right edge of the first search region and the left edge of the current block may correspond to the width of the current block. The plurality of search regions may comprise search regions R1-R6. The first search region may be one of R5 or R6. The plurality of search regions may subdivide a reference region determined in accordance with at least the location of the current block. Each of the plurality of search regions may be determined according to the location of the current block and a size of the current block. The determining, based on a template matching search of the plurality of search regions excluding the first search region, the set of candidates for predicting the current block, may comprise: determining parameters of each search region of the plurality of search regions, the plurality of search regions subdividing a reference region; determining, using a first template matching search of sparse samples in the reference region in search regions other than the first search region, a set of sparse candidates for predicting the current block; and for each sparse candidate in a selected subset of the set of sparse candidates, determining a search window encompassing the each sparse candidate. The search window may be based on a first predetermined window size. The determining, using the first template matching search of sparse samples in the reference region in search regions other than the first search region, the set of sparse candidates for predicting the current block, may comprise: performing the first template matching search on respective search regions of the plurality of search regions in accordance with an ordered list of the search regions. The template matching search may comprise Intra-template matching prediction (IntraTMP) and the set of candidates may comprise candidates determined according to IntraTMP and/or candidates determined according to IntraTMP with Merge Candidates. The set of candidates may comprise block vectors of adjacent neighboring blocks and/or block vectors of non-adjacent neighboring blocks. Candidates of the first set of candidates may be located in a reference region. At least one candidate of the second set of candidates may be located outside of the reference region. The encoding the current block based on the selected candidate from the second set of candidates including the first set of candidates, may comprise: calculating rate-distortion optimization costs of respective candidates in the first set of candidates and the second set of candidates; and selecting, based on template matching costs and rate-distortion optimization costs of the first set of candidates and the second set of candidates, the selected candidates. The encoding the current block based on the selected candidate may comprise performing the encoding based on a residual and a reference block corresponding to the selected candidate. The computing device may comprise one or more processors and memory, storing instructions that, when executed by the one or more processors, perform the method described herein. A system may comprise the computing device configured to perform the described method, additional operations, and/or include additional elements; and a second computing device configured to decode the current block. A computer-readable medium may store instructions that, when executed, cause performance of the described method, additional operations, and/or include additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof.

When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

1. A method comprising:
determining, by a computing device, whether a bottom-right corner sample of a first reference block in a same picture as a current block is a reconstructed sample, wherein a top-left sample of the first reference block overlaps a top-left sample of a first search region of a plurality of search regions in the picture;
determining whether a bottom-right corner sample of a second reference block in the picture is a reconstructed sample, wherein a top-left sample of the second reference block overlaps a bottom-right sample of the first search region;
determining, based on the plurality of search regions, a first set of candidates for predicting the current block; and
decoding the current block based on a selected candidate from a second set of candidates that includes the first set of candidates.

2. The method of claim 1, wherein the bottom-right corner sample of the first reference block and the bottom-right corner sample of the second reference block are reconstructed samples, and wherein the determining the first set of candidates is based on the plurality of search regions including the first search region.

3. The method of claim 1, wherein the bottom-right corner sample of the first reference block is not a reconstructed sample, and wherein the determining the first set of candidates is based on the plurality of search regions excluding the first search region.

4. The method of claim 1, wherein the bottom-right corner sample of the first reference block is a reconstructed sample, the method further comprising:
adjusting a boundary of the first search region based on determining that the bottom-right corner sample of the second reference block is not a reconstructed sample, and
wherein the determining the first set of candidates further comprises:
determining the first set of candidates, based on a template matching search of the plurality of search regions including the adjusted first search region.

5. The method of claim 1, wherein locations of the plurality of search regions are determined based on the current block.

6. The method of claim 1, wherein the determining whether the bottom-right corner sample of the first reference block or the second reference block is a reconstructed sample comprises determining whether the bottom-right corner sample is:
located outside the picture;
overlapping the current block;
in a non-decoded coding tree unit (CTU); or
in a non-decoded block.

7. The method of claim 1, wherein the determining whether the bottom-right corner sample of the first reference block is a reconstructed sample further comprises:
determining that the bottom-right corner sample of the first reference block is not a reconstructed sample based on at least one of:
the first reference block extending outside the picture;
the first reference block fully or partially overlapping the current block;
the first reference block is fully or partially in a non-decoded coding tree unit (CTU); or
the first reference block is fully or partially in a non-decoded block.

8. The method of claim 1, wherein decoding the current block further comprises:
decoding the current block based on:
a residual from a bitstream; and
a reference block corresponding to the selected candidate.

9. A method comprising:
validating, by a computing device, a top-left sample of a first search region of a plurality of search regions in a same picture as a current block;
validating a bottom-right sample of the first search region;
determining, based on a template matching search of the plurality of search regions, a first set of candidates for predicting the current block; and
decoding the current block based on a selected candidate from a second set of candidates including the first set of candidates.

10. The method of claim 9, wherein the validating the top-left sample of the first search region comprises:
determining whether a bottom-right corner sample of a first reference block is a reconstructed sample, wherein a top-left sample of the first reference block overlaps the top-left sample of the first search region.

11. The method of claim 9, wherein the validating the bottom-right sample of the first search region comprises:
determining whether a bottom-right corner sample of a second reference block is a reconstructed sample, wherein a top-left sample of the second reference block overlaps the bottom-right sample of the first search region.

12. The method of claim 9, wherein the top-left sample of the first search region and the bottom-right sample of the first search region are valid, and wherein the determining the first set of candidates is based on the plurality of search regions including the first search region.

13. The method of claim 9, wherein the top-left sample of the first search region is invalid, and wherein the determining the first set of candidates is based on the plurality of search regions excluding the first search region.

14. The method of claim 9, wherein the top-left sample of the first search region is valid, the method further comprising:
adjusting a boundary of the first search region based on determining that the bottom-right sample of the first search region is invalid, and
wherein the determining the first set of candidates further comprises:
determining the first set of candidates, based on the template matching search of the plurality of search regions including the adjusted first search region.

15. The method of claim 9, wherein one or more of the plurality of search regions is determined based on at least one of:
a location of the current block; or
a size of the current block.

16. The method of claim 9, wherein no samples of the first search region other than the top-left sample and the bottom-right sample are validated.

17. A method comprising:
determining, by a computing device, whether a bottom-right corner sample of a first reference block in a same picture as a current block is an encoded sample, wherein a top-left sample of the first reference block overlaps a top-left sample of a first search region of a plurality of search regions in the picture;
determining whether a bottom-right corner sample of a second reference block in the picture is an encoded sample, wherein a top-left sample of the second reference block overlaps a bottom-right sample of the first search region;
determining, based on the plurality of search regions, a first set of candidates for predicting the current block; and
encoding the current block based on a selected candidate from a second set of candidates that includes the first set of candidates.

18. The method of claim 17, wherein the bottom-right corner sample of the first reference block and the bottom-right corner sample of the second reference block are encoded samples, and wherein the determining the first set of candidates is based on the plurality of search regions including the first search region.

19. The method of claim 17, wherein the bottom-right corner sample of the first reference block is not an encoded sample, and wherein the determining the first set of candidates is based on the plurality of search regions excluding the first search region.

20. The method of claim 17, wherein the bottom-right corner sample of the first reference block is an encoded sample, the method further comprising:
adjusting a boundary of the first search region, based on determining that the bottom-right corner sample of the second reference block is not an encoded sample, and
wherein the determining the first set of candidates further comprises:
determining the first set of candidates, based on a template matching search of the plurality of search regions including the adjusted first search region.
